(19) United States
(12) Patent Application Publication
(10) Pub. No.: US 2026/0356256 A1
(43) Pub. Date: Nov. 12, 2026

(54) CARRIER AND BASE

(71) Applicant: Wonderland Switzerland AG, Steinhausen (CH)

(72) Inventors: Zhengwen GUO, Dongguan, Guangdong (CN); Guanghui ZHAO, Dongguan, Guangdong (CN); Xiaojian ZHANG, Dongguan, Guangdong (CN); Yubin CHEN, Dongguan, Guangdong (CN); Ruyi LI, Dongguan, Guangdong (CN); Kun ZHANG, Dongguan, Guangdong (CN); Xiaolong MO, Dongguan, Guangdong (CN)

(21) Appl. No.: 19/130,792

(22) PCT Filed: Nov. 17, 2023
(86) PCT No.: PCT/EP2023/082223

§ 371 Date: May 16, 2025

(30) Foreign Application Priority Data
Nov. 18, 2022 (CN) 202211448788.3
Dec. 23, 2022 (CN) 202211669458.7
Feb. 10, 2023 (CN) 202310113694.9
Feb. 23, 2023 (CN) 202310163348.1
Mar. 27, 2023 (CN) 202310311655.X
Apr. 20, 2023 (CN) 202310434047.8
May 10, 2023 (CN) 202310528822.6
May 16, 2023 (CN) 202310556488.5
Nov. 14, 2023 (CN) 202311519879.6

(51) Int. Cl. B60N 2/28

(52) U.S. Cl. CPC B60N 2/2848; B60N 2/2821; B60N 2/2887

(57) ABSTRACT

The disclosure provides a carrier and a base, wherein the carrier includes a carrying body and a pivoting part pivotally connected to the carrying body, the pivoting part having a locking hook for connecting a vehicle seat, wherein the carrier further comprises a gear adjustment structure arranged in linkage with the pivoting part, the gear adjustment structure is able to be operated to lock the pivoting part to one of a plurality of pivoted positions in respect with the carrying body. The carrier according to the disclosure can fix an anchor assembly in a plurality of pivoted positions, thereby facilitating storage and locking the anchor angle conveniently.

### CROSS-REFERENCE TO RELATED APPLICATIONS

This application is a National Stage application of PCT/EP2023/082223, entitled “CARRIER AND BASE” and filed on Nov. 17, 2023, which claims the benefits of Chinese Applications No. 202211448788.3, filed on Nov. 18, 2022, No. 202211669458.7, filed on Dec. 23, 2022, No. 202310113694.9, filed on Feb. 10, 2023, No. 202310163348.1, filed on Feb. 23, 2023, No. 202310311655.X, filed on Mar. 27, 2023, No. 202310434047.8, filed on Apr. 20, 2023, No. 202310528822.6, filed on May 10, 2023, No. 202310556488.5, filed on May 16, 2023, No. 202311519879.6, filed on Nov. 14, 2023, both of which are incorporated herein by reference in their entirety.

### TECHNICAL FIELD

The present disclosure relates to a carrier and a base.

### BACKGROUND

The existing baby safety basket has an anchor assembly such as ISOFIX. Some ISOFIX anchor assemblies cannot be folded by rotation. Thus, if an ISOFIX anchor assembly is not required, the ISOFIX anchor assembly cannot be folded to reduce the storage volume. This will make the appearance of the ISOFIX anchor assembly look abrupt, which will not only affect the appearance, but also affect the operation. Although some ISOFIX anchor assemblies of the baby safety baskets can rotate, their rotation is completely free and there is no gear limit. Thus, when an ISOFIX anchor assembly needs to be adjusted to a specific angle, the ISOFIX anchor assembly cannot be locked to the specific angle, which brings inconvenience in use.

It should be noted, the above description of prior art only provides background technology, and does not admit that the above prior art constitutes the prior art of the present disclosure, and any description of the above prior art should not be taken as any part of this disclosure.

### SUMMARY

The disclosure provides a carrier comprising a carrying body and a pivoting part to be pivoted in respect with the carrying body, wherein the carrier further comprises a gear adjustment structure arranged in linkage with the pivoting part, the gear adjustment structure is able to be operated to lock the pivoting part to one of a plurality of pivoted positions in respect with the carrying body.

The disclosure also provides a base for placing the carrier preciously described, the base is able to be connected to a the vehicle seat, wherein the carrier comprises two pivoting parts with a front connecting shaft connected between the two pivoting parts, and the base comprises: a base engagement member, arranged on the base to be able to move between an engaged position and a non-engagement position, wherein the base engagement member is able to be engaged with the front connecting shaft when in the engaged position, and the base engagement member is able to be disengage from the front connecting shaft when in the non-engagement position; and a base operation member, movably arranged on the base, and arranged to be able to directly or indirectly drive the base engagement member to move toward the non-engagement position.

The disclosure additionally provides a carrier application device which can be connected to a carrier, comprises an application holding part, the application holding part is able to be engaged with a carrier holding part on the carrier, such that the carrier is placed on the carrier application device.

The disclosure also provides an abutting structure capable of abutting a first object to a second object, the abutting structure comprises: a base part, arranged to the first object; an abutting member, mounted to the base part, and being able to be pivoted between a folded position and an extended position around a first pivoting axis in respect to the base part and abutting against the second object; and a biasing member, mounted to the abutting member and abutting against the base part to push the abutting member to the extended position.

The disclosure additionally provides a carrying device, comprising a seat body; a carrying part; the abutting structure according to the application, arranged on the carrying part; wherein the first object is the carrying device, the second object is a vehicle seat.

A beneficial effect of the disclosure is that the carrier according to the disclosure can fix the anchor assembly in a plurality of pivoted positions, thereby facilitating storage and locking the anchor angle conveniently. In addition, it is only necessary to operate the driving part on one side for unlocking the pivoting parts on both sides of the carrying body.

Purposes, features, aspects and advantages of the disclosure will become more apparent from the following detailed description of the disclosure in conjunction with the accompanying

### BRIEF DESCRIPTION OF THE DRAWINGS

The accompanying drawings are included herein for providing a further understanding of the disclosure and are incorporated in and constitute a part of this specification, which illustrate embodiments of the disclosure and together with the description below serve to explain the concept of the disclosure.

In the accompanying drawings:

FIG. 1 is a perspective view of the carrier according to an embodiment of the disclosure.

FIG. 2 is an exploded perspective view of the carrier according to an embodiment of the disclosure.

FIG. 3 is another exploded perspective view of the carrier according to an embodiment of the disclosure.

FIG. 4 is a schematic side view of the carrier according to an embodiment of the disclosure.

FIG. 5 is a partial sectional view taken along line A-A in FIG. 4.

FIG. 6 is a partial sectional view taken along line B-B in FIG. 4.

FIG. 7 is a perspective view of the carrier according to another embodiment of the disclosure.

FIG. 8 is an exploded perspective view of the carrier according to another embodiment of the disclosure.

FIG. 9 is an exploded perspective view of a synchronous link rod assembly of the carrier according to another embodiment of the disclosure.

FIG. 10 is a schematic side view of the carrier according to another embodiment of the disclosure, in which the driving part is not actuated.

FIG. 11 is a partial sectional view taken along line C-C in FIG. 10.

FIG. 12 is a schematic side view of the carrier according to another embodiment of the disclosure, in which one driving part is actuated.

FIG. 13 is a partial sectional view taken along line D-D in FIG. 12.

FIG. 14 is a partial sectional view taken along line E-E in FIG. 10.

FIG. 15 is a partial sectional view taken along line F-F in FIG. 12.

FIG. 16 is a perspective view of part of components of the carrier according to another embodiment of the disclosure.

FIG. 17 is a partial enlarged view of FIG. 16.

FIG. 18 is a perspective view of the carrier according to yet another embodiment of the disclosure.

FIG. 19A is a partial sectional view of the carrier according to yet another embodiment of the disclosure.

FIG. 19B is a partial enlarged view of FIG. 19A.

FIG. 20 is a front plan view of the carrier according to yet another embodiment of the disclosure.

FIG. 21A is a top plan view of the carrier according to yet another embodiment of the disclosure.

FIG. 21B is a partial enlarged view of FIG. 21A.

FIG. 22A is a sectional view taken along line G-G in FIG. 21A.

FIG. 22B is a partial enlarged view of FIG. 22A.

FIG. 23A is a perspective view of the carrier according to yet another embodiment of the disclosure.

FIG. 23B is a partial enlarged view of FIG. 23A.

FIG. 24A is a bottom plan view of the carrier according to yet another embodiment of the disclosure

FIG. 24B is a partial enlarged view of FIG. 24A.

FIG. 25 is a bottom perspective view of the carrier according to yet another embodiment of the disclosure.

FIG. 26A is a schematic side view of the carrier according to yet another embodiment of the disclosure, in which a pivoting part is in a first pivoted position.

FIG. 26B is a top view of the carrier in FIG. 26A.

FIG. 26C is a cross-sectional view and a partial enlarged view taken along line H-H in FIG. 26B.

FIG. 27A is a schematic side view of the carrier according to yet another embodiment of the disclosure, in which the pivoting part is in a second pivoted position.

FIG. 27B is a top view of the carrier in FIG. 27A.

FIG. 27C is a cross-sectional view and a partial enlarged view taken along line H-H in FIG. 27B.

FIG. 28A is a schematic side view of the carrier according to yet another embodiment of the disclosure, in which the pivoting part is in a third pivoted position.

FIG. 28B is a top view of the carrier in FIG. 28A.

FIG. 28C is a sectional view and a partial enlarged view taken along line H-H in FIG. 28B.

FIG. 29 is a side schematic view and a partial enlarged view of the carrier according to yet another embodiment of the disclosure, in which the pivoting part and an engaging member are removed.

FIG. 30 is a perspective view of the engaging member of the carrier according to the disclosure.

FIG. 31 is a perspective view of pivoting parts and a connecting shaft of the carrier according to the disclosure.

FIG. 32A is a top view of the carrier mounted with a modification of the first embodiment of the synchronous unlocking assembly.

FIG. 32B is a partial enlarged view of FIG. 32A.

FIG. 33 is a perspective view of a modification of the first embodiment of the synchronous unlocking assembly and the pivoting parts shown in FIG. 32A.

FIG. 34 is a top view of the carrier mounted with a second embodiment of the synchronous unlocking assembly.

FIG. 35 is a perspective view of the second embodiment of the synchronous unlocking assembly and the pivoting parts shown in FIG. 34.

FIG. 36 is a perspective view of the components shown in FIG. 25 from another angle, in which a hinge structure placement seat is removed.

FIG. 37A is a schematic view of the carrier being placed on a base according to the disclosure.

FIG. 37B is a schematic bottom view of the carrier shown in FIG. 37A.

FIG. 38 is a schematic view of the base shown in FIG. 37A.

FIG. 39 is a schematic view of the base shown in FIG. 38 from another angle.

FIG. 40 is a schematic view of a base engagement member and a base operation member of the base according to the disclosure.

FIG. 41 shows a top view of the base according to the disclosure and a side sectional view taken along line T-T.

FIG. 42 shows a top view of the base according to the disclosure and a side sectional view taken along line U-U.

FIG. 43 is a bottom view of the base according to the disclosure, in which a bottom cover is removed.

FIG. 44 is a bottom view of the base according to the disclosure from another angle, in which the bottom cover is removed.

FIG. 45 is a bottom view of the base according to the disclosure, in which the bottom cover is mounted in place.

FIG. 46 is a perspective view of the carrier mounted with the second embodiment of the driving part, in which the pivoting parts are in a storage pivoted position.

FIGS. 47 to 49 are perspective views of the carrier shown in FIG. 46 from different angles.

FIG. 50 is a perspective view and a partial enlarged view of the carrier shown in FIG. 46 when the pivoting parts are in a working position, in which an outer cover is removed.

FIG. 51 shows an exploded perspective view and a partial enlarged view of the pivoting parts and a gear adjustment structure of the carrier shown in FIG. 50.

FIGS. 52 and 53 are schematic views of a pivoting member pushing section of the driving part pivoting member, respectively, viewed from two angles.

FIG. 54 is a schematic view of a pivoting member pressing section of the driving part pivoting member.

FIG. 55 is a schematic view of the pivoting parts of the carrier according to the disclosure, in which a body member and an inner cover of one of the pivoting parts are removed.

FIG. 56 is a schematic view of the pivoting parts of the carrier according to the disclosure, in which a body member of one of the pivoting parts is removed.

FIG. 57 is a perspective view of an outer cover of a pivoting part of the carrier according to the disclosure.

FIG. 58 is a schematic view of a pivoting part of the carrier according to the disclosure, in which two engaging members are linked with each other through a third link and a hinged structure.

FIG. 59 shows a schematic view and a partial enlarged view of the pivoting part shown in FIG. 58 viewed from another angle, in which one of the engaging members is removed.

FIG. 60 is a schematic side view of the carrier with the third embodiment of the driving part mounted, in which the pivoting part is in the storage pivoted position.

FIGS. 61 and 62 are perspective views of the carrier shown in FIG. 60, in which FIG. 61 shows a state when the driving part pivoting button is not rotated toward the third pivoting direction, and FIG. 62 shows a state after the driving part pivoting button is rotated toward the third pivoting direction.

FIG. 63 is a perspective view and partial enlarged view of the carrier shown in FIG. 60, in which the outer cover is removed.

FIG. 64 is an exploded perspective view of the pivoting part and part of the gear adjustment structure of the carrier shown in FIG. 60.

FIG. 65 is an exploded perspective view of the pivoting part and part of the gear adjustment structure of the carrier shown in FIG. 60 from another angle.

FIG. 66 is a schematic view of a second embodiment of the base according to the disclosure.

FIG. 67 is a schematic view of an internal structure of the base shown in FIG. 66.

FIG. 68 is a top view of the base with the internal structure shown in FIG. 67.

FIG. 69 is a side sectional view taken along the line V-V in FIG. 68.

FIG. 70 is a side sectional view taken along the line W-W in FIG. 68.

FIG. 71 is a side sectional view taken along the line X-X in FIG. 68.

FIG. 72 is a schematic view of another internal structure of the base shown in FIG. 66.

FIG. 73 is a top view of the base with another internal structure shown in FIG. 72.

FIG. 74 is a side sectional view taken along the line Y-Y in FIG. 73.

FIG. 75 is a schematic side view of an embodiment of a carrier application device according to the disclosure.

FIG. 76 is a schematic view of the carrier application device shown in FIG. 75.

FIG. 77 is a schematic side view of a first embodiment of the carrier application device shown in FIG. 75 with a carrier connected.

FIG. 78 is a schematic side view of a second embodiment of the carrier application device shown in FIG. 75 with a carrier connected.

FIG. 79 is a schematic side view of a third embodiment of the carrier application device shown in FIG. 75 with a carrier connected.

FIG. 80 is a schematic view of the carrier application device shown in FIG. 75 with a carrier connected.

FIG. 81 is a schematic view of the carrier application device shown in FIG. 75 viewed from another angle.

FIG. 82 is a schematic view of an embodiment of an application holding part of the carrier application device according to the disclosure.

FIG. 83 is a schematic view of the application holding part shown in FIG. 82 viewed from another angle.

FIG. 84 is a schematic side view of an embodiment of a carrier which can be arranged in a carrier application device.

FIG. 85 is a front schematic view of an embodiment of the carrier which can be arranged in a carrier application device, in which a bulged part is a post with a quadrangular bottom.

FIG. 86 is a front schematic view of an embodiment of a carrier with a retractable bulged part, in which the bulged part is in an extended position.

FIG. 87 is a front schematic view of the carrier shown in FIG. 86, in which the bulged part is in a retracted position.

FIG. 88 is a perspective view of the carrier mounted with an engaging assembly according to the disclosure.

FIG. 89 is a perspective view of the carrier shown in FIG. 88, in which the handle is removed.

FIG. 90 is a perspective view of the shown in FIG. 89 and its partial enlarged view, in which the first unlocking button is removed.

FIG. 91 is a perspective view of a first unlocking button of a first engaging member of the engaging assembly according to the disclosure.

FIG. 92 is a side view of the carrier and a sectional view taken along line V-V shown in FIG. 89, in which the first unlocking button is in a non-working position.

FIG. 92A is a partial enlarged view of the cross-sectional view in FIG. 92.

FIG. 93 is a side view of the carrier and a sectional view taken along line V-V shown in FIG. 89, in which the first unlocking button is in a working position.

FIG. 93A is a partial enlarged view of the sectional view in FIG. 93.

FIG. 94 is a front view of the carrier and a sectional view taken along line W-W shown in FIG. 89, in which the first unlocking button is in the non-working position.

FIG. 94A is a partial enlarged view of the sectional view in FIG. 94.

FIG. 95 is a front view of the carrier and a sectional view taken along line W-W shown in FIG. 89, in which the first unlocking button is in the working position.

FIG. 95A is a partial enlarged view of the sectional view in FIG. 95.

FIG. 96 is a perspective view of a second engaging member of the engaging assembly according to the disclosure.

FIG. 97 is a front schematic view of the first locking member of the first engaging member of the engaging assembly according to the disclosure.

FIG. 98 is a backward schematic view of the first locking member shown in FIG. 97.

FIG. 99 is a front schematic view of the first locking member elastomer of the first engaging member of the engaging assembly according to the disclosure.

FIG. 100 is a side view of a carrying device according to the disclosure.

FIG. 101 is a side view of the carrying device according to the disclosure, in which a schematic view of a carrier seat is also shown.

FIG. 102 is a perspective view of the carrying device according to the disclosure.

FIG. 103 is a perspective view of the carrying device according to the disclosure, in which an abutting structure is shown in a partially exploded state.

FIG. 104 is a partial enlarged view of the circled part in FIG. 103.

FIG. 105 is a perspective view of the carrying device according to the disclosure, in which the abutting structure is shown in a partially exploded state.

FIG. 106 is a partial enlarged view of the circled part in FIG. 105.

FIGS. 107 to 110 are respectively partial enlarged views of the abutting structure, in which the abutting structure is shown gradually transiting from an extended position to a folded position.

FIGS. 111A to 111C are respectively perspective views of two abutting members from different angles.

### DETAILED DESCRIPTION

Hereinafter, exemplary embodiments will be described in detail by referring to the accompanying drawings.

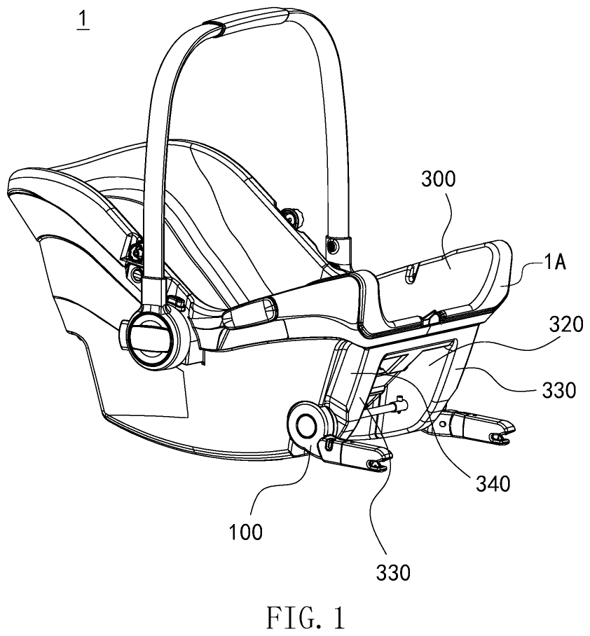

FIG. 1 shows another carrier 1 according to the disclosure. It should be noted, although the carrier 1 shown in the drawings is a baby safety basket, the disclosure is not limited thereto. the carrier 1 according to the disclosure can be used for carrying a person, an animal or articles, including but not limited to a baby safety basket or a child safety basket, a sleeping box, a safety seat, an animal carrying device or an article carrying device and the like. The carrier 1 can be used to be arranged in a vehicle. More specifically, the carrier 1 can be used for a corresponding accessory on a car seat or vehicle seat (not shown) such as on an anchoring interface.

In order to safely and reliably connect the carrier 1 to the vehicle seat, the carrier 1 may be provided with an anchor assembly.

The anchor assembly can be directly engaged with a corresponding accessory such as a connecting rod, a connecting ring, an anchoring interface and the like on the vehicle seat, such that an additional base is unnecessary, which makes connection of the carrier 1 on the vehicle seat more convenient and makes its structure simpler.

For the convenience of description, a baby basket will be taken as example of the carrier 1 in the description, moreover, the direction for the baby in the basket 1 to face is defined as front and the direction for the baby to face back is defined as back, the left and right direction of the baby in the basket 1 is defined as lateral, a side of the basket 1 carrying the baby is defined as an inner side of the basket 1, and an opposite side is defined as an outer side of the basket 1. Other forms of the carrier 1 may be similar or different in structure to the baby basket.

The carrier 1 may include a carrying body 300 and a pivoting parts 100 which can be pivoted in respect with the carrying body 300.

The carrying body 300 can be used to carry a baby or child. The pivoting parts 100 may include an anchor assembly for operatively connecting to a vehicle seat. The anchor assembly may be an ISOFIX joint, but the disclosure is not limited thereto.

When the user is prepares to connect the carrier 1 to the vehicle seat, he may firstly adjust the pivoting parts 100 to a proper pivoted position (described later), and then engage the anchor assembly with the corresponding accessory on the vehicle seat; alternatively, the anchor assembly may be firstly engaged with the corresponding accessory on the vehicle, then, according to the position conditions of the seat back and seat surface of the vehicle seat and the carrier 1, the pivoting parts 100 is adjusted to a proper pivoted position; and finally, the front edge 1A (see FIGS. 1 to 4) of the carrier 1 tightly abuts against the back of the vehicle seat, thereby ensuring that the carrier 1 is safely and reliably connected to the vehicle seat.

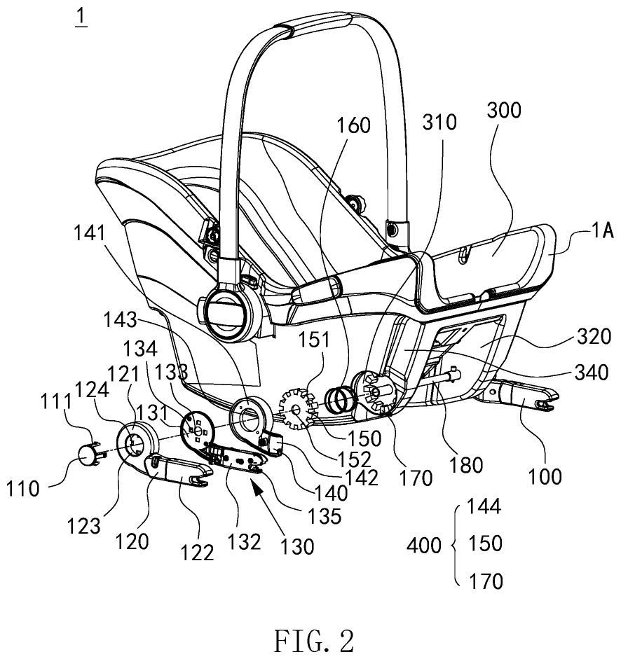

As shown in FIGS. 1 and 2, in an embodiment, the carrier 1 may include a carrying body 300, two pivoting parts 100, two gear adjustment structures 400, and a connecting shaft 180. The carrying body 300 may include a cavity 320 and two side parts 330. The cavity 320 is formed in a front part of the carrying body 300 (the part near the backrest of the car seat when the carrier 1 is mounted on the car seat). The two side parts 330 are respectively formed on both sides of the carrying body 300, and may be formed in the shape of a substantially vertical rib, thereby forming the cavity 320 therebetween. The front part of the cavity 320 is open.

In an embodiment, the two pivoting parts 100 are arranged respectively at inner sides of the two side parts 330 and at the front part of the carrying body 300.

In an embodiment, the two pivoting parts 100 are arranged respectively at outer sides of the two side parts 330 and at the front part of the carrying body 300.

In an embodiment, the two pivoting parts 100 may be arranged in linkage via a connecting shaft 180, such that the two pivoting parts 100 are synchronously pivoted.

In an embodiment, the carrier 1 may not include the connecting shaft 180, such that the two pivoting parts 100 may be pivoted independently of each other.

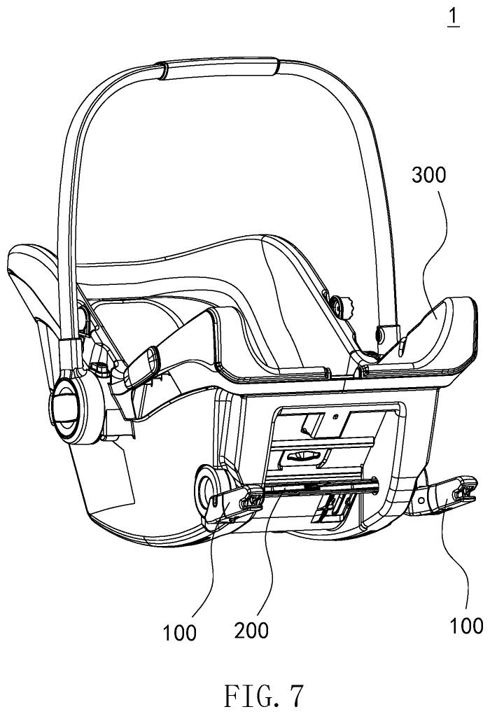

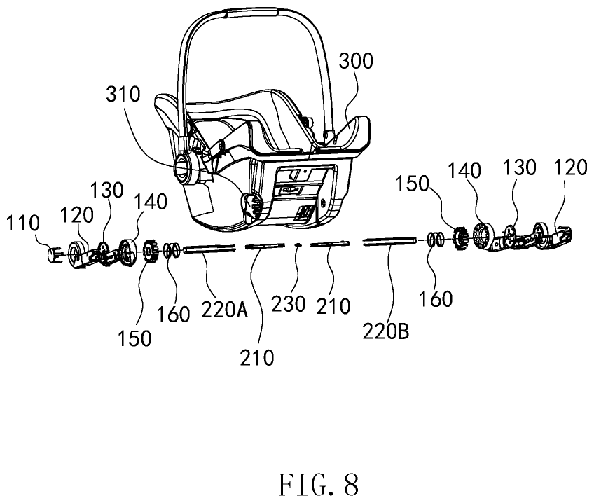

As shown in FIGS. 7 and 8, in an embodiment, the carrier 1 may include a carrying body 300, two pivoting parts 100, two gear adjustment structures 400, and a synchronous link rod assembly 200. The two pivoting parts 100 may be respectively located on outer sides of the two side parts 330, and are arranged in linkage via the synchronous link rod assembly 200, such that the two pivoting parts 100 are synchronously pivoted and respective engaging members 150 of the two gear adjustment structures 400 move a same distance in opposite directions.

In an embodiment, the two pivoting parts 100 may be respectively located on the inner sides of the two side parts 330, and are arranged in linkage via the synchronous link rod assembly 200, such that the two pivoting parts 100 are synchronously pivoted and the respective engaging members 150 of the two gear adjustment structures 400 move the same distance in opposite directions.

### Pivoting Part

Although the carrier 1 according to the disclosure may have two pivoting parts 100, only one pivoting part 100 will be described below, and it can be understood, the two pivoting parts 100 mentioned above may have structures symmetrical to each other.

In the disclosure, the pivoting part 100 of the carrier 1 can be pivoted in respect with the carrying body 300. As shown in FIGS. 1-3, two sides of the carrying body 300 may have a pivoting part 100 respectively, but the disclosure is not limited thereto. The number of the pivoting parts 100 may be arranged based actual requirements or as required by laws and regulations. Moreover, the pivoting part(s) 100 may be located below a position where a baby or a child sits.

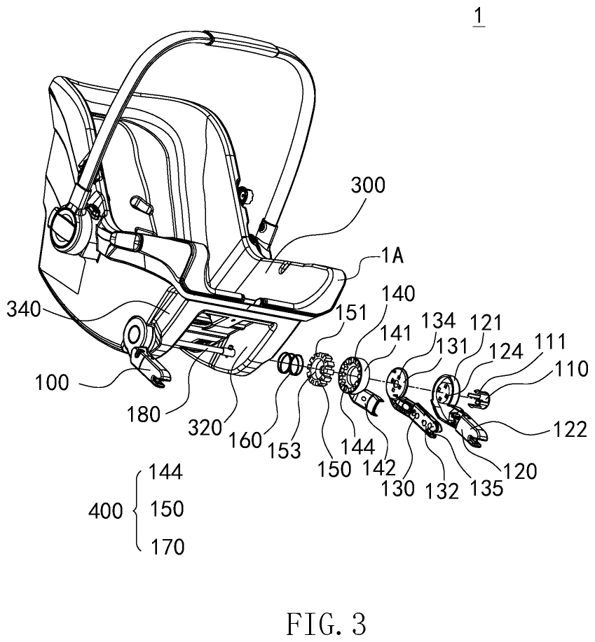

As shown in FIGS. 2 and 3, the pivoting part 100 may include an outer cover 120, a body member 130, and an inner cover 140. The outer cover 120 and the inner cover 140 together enclose a space, and the body member 130 is located in the space.

The outer cover 120 may be located on the outer side of the inner cover 140, i.e., the side away from the carrying body 300.

The outer cover 120 may include a base part 121, an extension part 122, an accommodation slot 123, a hole 124.

The base part 121 of the outer cover 120 may be formed in a substantially circular shape. The extension part 122 may be disposed at an edge of the base part 121. In the embodiment shown in FIGS. 2 and 3, the accommodation slot 123 is centrally formed on the base part 121, and forms concentric circles with the base part 121. The accommodation slot 123 is recessed inward from an outer surface of the base part 121. A bottom wall of the accommodation slot 123 may be formed with a hole 124.

As shown in FIG. 2, in an embodiment, the bottom wall of the accommodation slot 123 may be formed with four holes 124, and the four holes 124 may be arranged in two pairs with the two holes in each pair facing each other, but the disclosure is not limited thereto. The four holes 124 may be uniformly arranged at the outer edge of the bottom wall of the accommodation slot 123 along the circumferential direction of the accommodation slot 123, i.e., the interval between two adjacent holes is 90°, but the disclosure is not limited thereto.

The inner cover 140 may include a base part 141, an extension part 142, and a centre hole 143.

The base part 141 of the inner cover 140 may be formed in a substantially circular shape. The extension part 142 may be disposed at the edge of the base part 141. In the embodiment shown in FIGS. 2 and 3, the centre hole 143 is centrally formed on the base part 141, and forms concentric circles with the base part 141.

The outer cover 120 and the inner cover 140 have shapes corresponding to each other, and can be buckled to each other and/or combined with each other by a fastener (e.g., a screw). The length of the extension part 142 may be smaller than that of the extension part 122. Both the outer cover 120 and the inner cover 140 may be formed of plastic, but the disclosure is not limited thereto.

The body member 130 may be disposed between the outer cover 120 and the inner cover 140, and may include a base part 131, an extension part 132, a centre hole 133, and a hole 134.

The base part 131 of the body member 130 may be formed in a substantially circular shape. The extension part 132 may be disposed at the edge of the base part 131. In the embodiment shown in FIGS. 2 and 3, the centre hole 133 is centrally formed on the base part 131, and forms concentric circles with the base part 131. The centre hole 133 of the body member 130 may be smaller than the centre hole 143 of the inner cover 140. A hole 134 may be formed on the outer side of the centre hole 133.

The hole 134 of the body member 130 may be formed at a position corresponding to the hole 124 of the outer cover 120. The four holes 134 may be arranged in two pairs with the two holes in each pair facing each other, but the disclosure is not limited thereto. The four holes 134 may be uniformly arranged on the base part 131 in the circumferential direction, that is, the interval between two adjacent holes is 90°. The number of the holes 134 may be as same as the number of the hole 124. That is, in an embodiment, the body member 130 may be formed with four holes 134.

The body member 130 may be formed of metal (e.g., steel), but the disclosure is not limited thereto.

The body member 130 may have a locking hook 135. The locking hook 135 may be arranged on the extension part 132 at a position adjacent to the free end. The pivoting part 100 may be anchored to the vehicle seat by the locking hook 135. In other words, the locking hook 135 is anchored to the corresponding accessory on the vehicle seat.

The carrier 1 may have a locking hook unlocking part (not shown) which can unlock the locking hook 135. The locking hook unlocking part may be an unlocking steel wire. One end of the unlocking steel wire may be directly or indirectly connected to the locking hook 135, and the other end of the unlocking steel wire may be directly or indirectly connected to an operation member for facilitating pulling the unlocking steel wire. The operation member is arranged to facilitate the operation of the locking hook 135, but the disclosure is not limited thereto.

In an embodiment, the connecting shaft 180 may penetrate the carrying body 300 of the carrier 1 in a lateral direction of the carrier 1. Two ends of the connecting shaft 180 respectively pass through the two side parts 330 of the carrying body 300 and extend out. The connecting shaft 180 can freely rotate in respect with the carrying body 300. Each end of the connecting shaft 180 may be coupled to the body member 130 of one of the pivoting parts 100, such that the pivoting part 100 rotates synchronously with the connecting shaft 180. The connecting shaft 180 may be formed of an iron pipe.

The middle part of the connecting shaft 180 is located in the cavity 320. In an embodiment, the two pivoting parts 100 on the inner sides of the two side parts 330 of the carrying body 300 may be located inside the cavity 320.

In the case that the carrier 1 has two pivoting parts 100, the two pivoting parts 100 are respectively coupled to both ends of the connecting shaft 180. Thus, the two pivoting parts 100 will synchronously rotate.

In an embodiment, the two pivoting parts 100 are respectively located on the inner sides of the two side parts 330 of the carrying body 300, and at this time, the two pivoting parts 100 can be respectively coupled to the middle part of the connecting shaft 180.

### Gear Adjustment Structure

The carrier 1 further includes a gear adjustment structure 400 arranged in linkage with the pivoting part 100. The gear adjustment structure 400 can be operated to lock the pivoting part 100 at one of a plurality of pivoted positions in respect with the carrying body 300.

In an embodiment, a pivoted angle of the pivoting part 100 may be 120°.

In an embodiment, the pivoted angle of the pivoting part 100 above the horizontal plane may be greater than or equal to the pivoted angle of the pivoting part 100 below the horizontal plane.

In an embodiment, the pivoted angle of the pivoting part 100 above the horizontal plane may be smaller than the pivoted angle of the pivoting part 100 below the horizontal plane.

As an example, the pivoting part 100 may rotate from 60.96° above the horizontal plane to 59.04° below the horizontal plane, but the disclosure is not limited thereto.

The front part of the carrying body 300 may be provided with a recess 340.

In an embodiment, as shown in FIGS. 1 to 3, the recess 340 may have a shape corresponding to the profile of the pivoting part 100, so as to accommodate the pivoting part 100 when the pivoting part 100 is not used, such that the pivoting part 100 does not protrude out of the carrying body 300 in both the longitudinal direction and the lateral direction, and the recess 340 limits the pivoted angle of the pivoting part 100.

In an embodiment, the recess may have a shape not corresponding to the profile of the pivoting part 100, and have an area larger than the area of the pivoting part 100, so as to form a space to avoid the pivoting of the pivoting part 100, thereby enabling the pivoting part 100 to be pivoted completely a circle.

The gear adjustment structure 400 may include: a first engaging slot 170, formed in the carrying body 300; a second engaging slot 144, formed in the pivoting part 100; and an engaging member 150, movably arranged between the first engaging slot 170 and the second engaging slot 144, and can be engaged to the first engaging slot 170 and the second engaging slot 144 at the same time, such that the pivoting part 100 can be locked at one of the pivoted positions in respect with the carrying body 300. The engaging member 150 can be actuated to be separated from being engaged with the second engaging slot 144, so as to allow the pivoting part 100 to be freely pivoted in respect with the carrying body 300.

In an embodiment, the engaging member 150 can be actuated to be separated from being engaged with the first engaging slot 170, so as to allow the pivoting part 100 to be freely pivoted in respect with the carrying body 300.

In an embodiment, the engaging member 150 can be actuated to be separated from being engaged with both the first engaging slot 170 and the second engaging slot 144, so as to allow the pivoting part 100 to be freely pivoted in respect with the carrying body 300.

It can be understood, the engaging member 150 is only required to be actuated to a position where the pivoting part 100 is allowed to be freely pivoted in respect with the carrying body 300. That is, as long as the engaging member 150 is not engaged with both the first engaging slot 170 and the second engaging slot 144, the pivoting part 100 can be freely pivoted in respect with the carrying body 300.

Referring to FIG. 2, the carrying body 300 may include an accommodation slots 310. In an embodiment, two sides of the carrying body 300 respectively include an accommodation slots 310.

In an embodiment, the two pivoting parts 100 are located on the outer sides of the two side parts 330 of the carrying body 300, and at this time, the accommodation slots 310 are formed to be recessed from the outer sides of the two side parts 330 of the carrying body 300, and the positions of the accommodation slots 310 may corresponding to the positions of the pivoting parts 100.

In an embodiment, the two pivoting parts 100 are located on the inner sides of the two side parts 330 of the carrying body 300, and at this time, the accommodation slots 310 are formed to be recessed from the inner sides of the two side parts 330 of the carrying body 300, and the positions of the accommodation slots 310 may corresponding to the positions of the pivoting parts 100.

The connecting shaft 180 may pass through the center of each of the accommodation slots 310. Each of the accommodation slots 310 may be formed in a circular shape, and the sizes of the outlines of the accommodation slots 310 are corresponding to the sizes of the outline of the base part 121 of the outer cover 120 and the outline of the base part 141 of the inner cover 140.

Continually referring to FIG. 2, the first engaging slot 170 includes an internal gear, and the internal gear may be formed inside an accommodation slot 310. The internal gear can contact the inner circumference and the bottom wall of the accommodation slot 310, but the disclosure is not limited thereto.

Referring to FIGS. 2 and 3, the engaging member 150 may include external teeth 151, a centre hole 152, and an accommodation slot 153.

In an embodiment, the engaging member 150 is a locking gear, but the disclosure is not limited thereto. The engaging member 150 is formed as an external gear, such that it can be engaged with the first engaging slot 170 having the internal gear. That is, the engaging member 150 can be received by the accommodation slot 310.

In an embodiment, the engaging member 150 is a bump which can extend into the first engaging slot 170 and the second engaging slot 144.

In order to prevent the engaging member 150 from being accidentally disengaged from the first engaging slot 170 or the second engaging slot 144, thickness, size and material of the engaging member 150 can be specifically set.

In an embodiment, the material of the engaging member 150 is plastic steel (POM).

In an embodiment, the thickness of the engaging member 150 is 14 mm.

In an embodiment, when the engaging member 150 is engaged with both the first engaging slot 170 and the second engaging slot 144, the engaged thicknesses of the engaging member 150 with the first engaging slot 170 and the second engaging slot 144 are respectively 7 mm.

In an embodiment, the depth of each of the first engaging slot 170 and the second engaging slot 144 may be greater than or equal to the thickness of the engaging member 150, thereby ensuring that the engaging member 150 can be actuated to be completely separated from any one of the first engaging slot 170 and the second engaging slot 144.

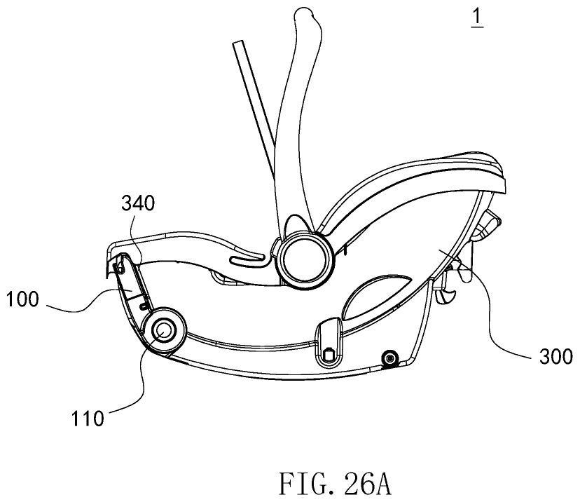

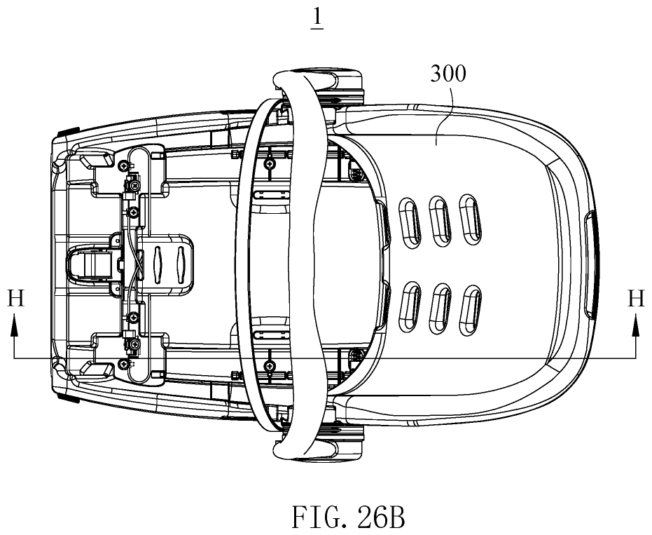

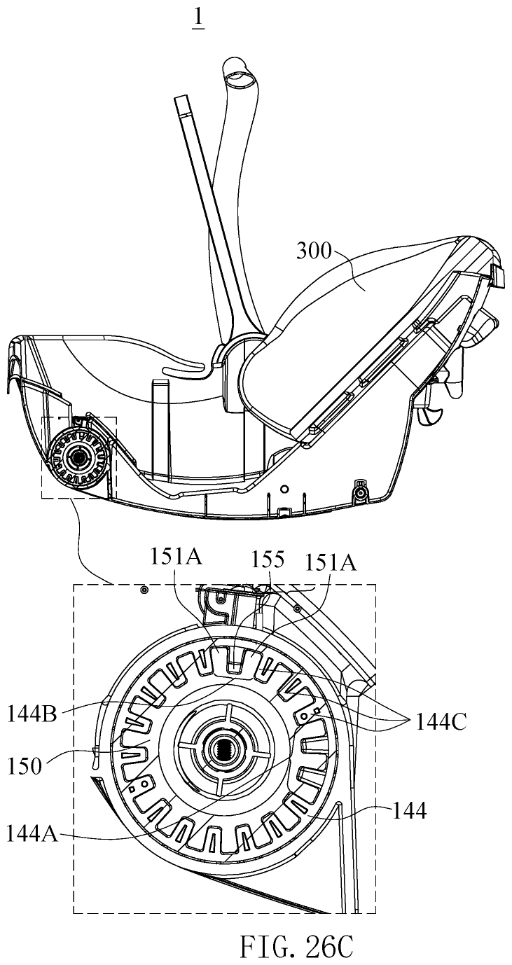

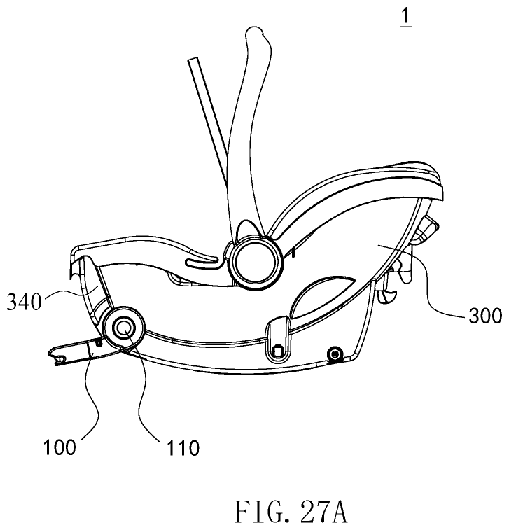

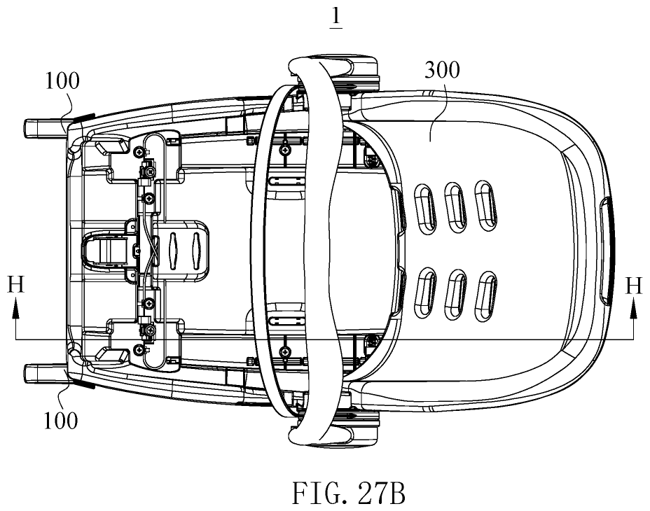

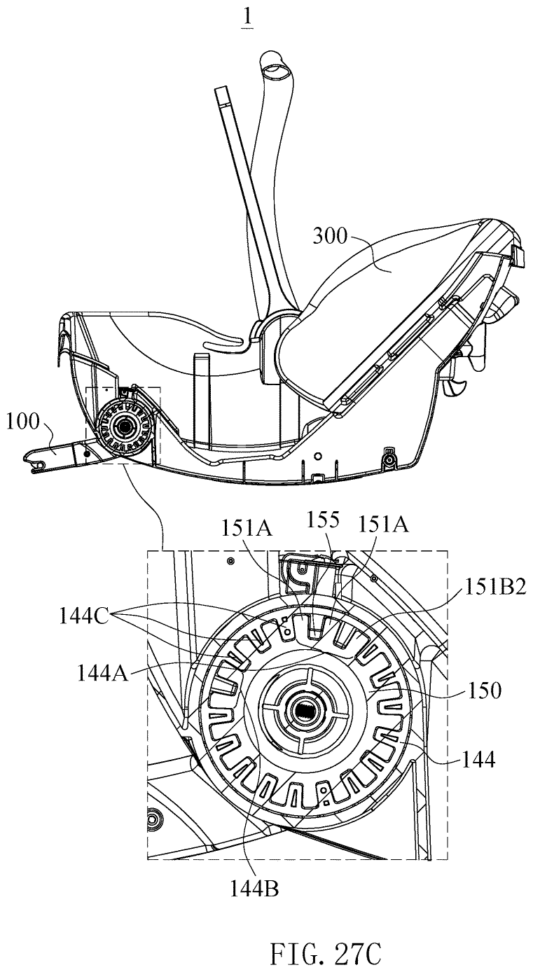

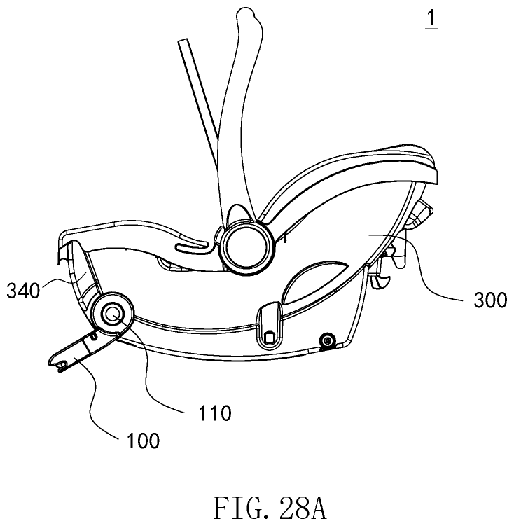

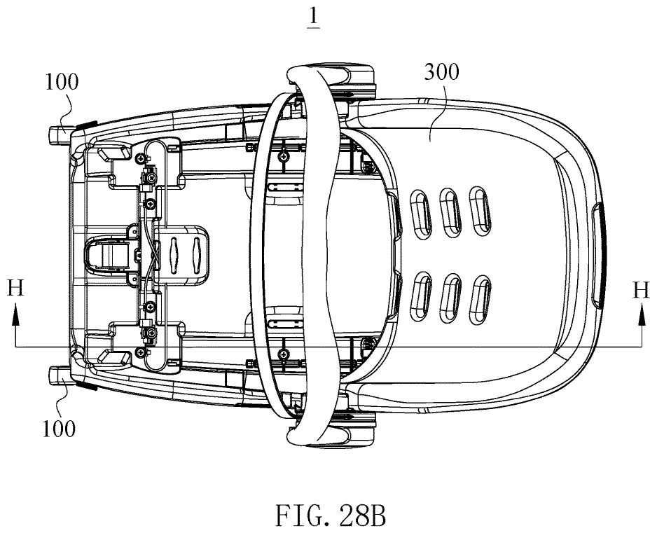

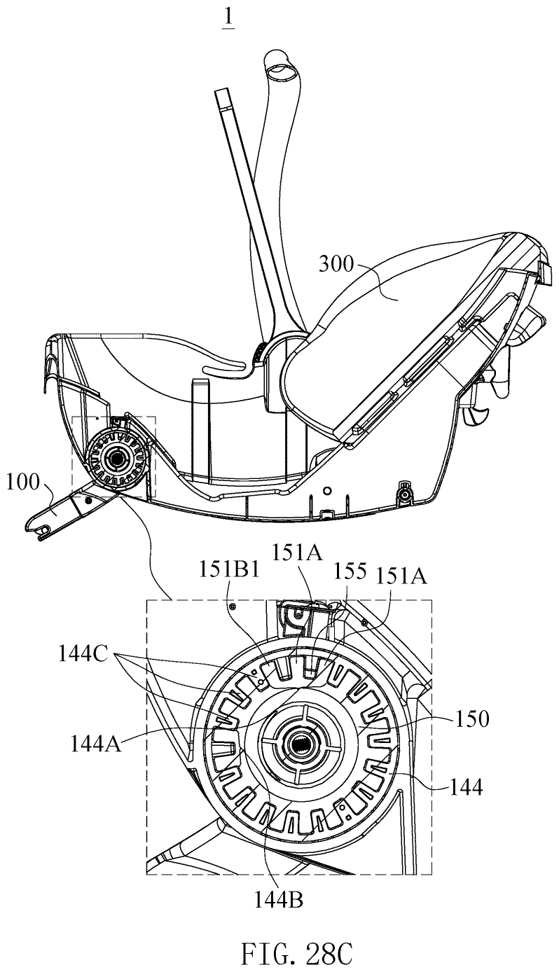

Referring to FIGS. 26A to 28C, in an embodiment, the engaging member 150, which is formed as a locking gear, has a plurality of external teeth. The pivoting part 100 may have three pivoted positions (i.e., the pivoting part 100 can be kept at three pivoted angles), respectively, a first pivoted position (the storage pivoted position shown in FIG. 26A), a second pivoted position (the middle pivoted position shown in FIG. 27A), and a third pivoted position (the maximum pivoted position shown in FIG. 28A). For example, angular difference between the second pivoted position (the middle pivoted position) and the third pivoted position (the maximum pivoted position) may be smaller than angular difference between the second pivoted position (the middle pivoted position) and the first pivoted position (the storage pivoted position). Specifically, the angular difference between the first pivoted position (the storage pivoted position) and the third pivoted position (the maximum pivoted position) may be 120°, and the angular difference between the second pivoted position (the middle pivoted position) and the third pivoted position (the maximum pivoted position) may be 20°, but the disclosure is not limited thereto. The first pivoted position (the storage pivoted position) can serve to store the pivoting part 100, in which the pivoting part 100 can be pivoted into the recess 340 (see FIG. 26A) for storage, and the pivoting part 100 can be stored when the pivoting part 100 is not used. The three pivoted positions of the pivoting part 100 can be realized by adjusting the shape of the second engaging slot 144 of the inner cover 140 and/or the shape of the first engaging slot 170, but the disclosure is not limited thereto.

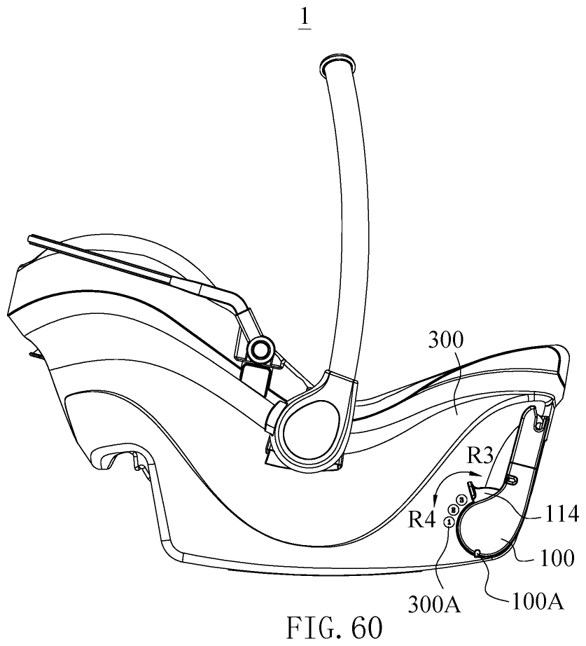

In order to facilitate the user to identify and confirm whether the pivoting part 100 has reached a specified pivoted position, the pivoting part 100 may be provided with a gear indicating mark 100A (see FIGS. 60 to 62, in which the gear indicating mark 100A is disposed at an outer periphery of the pivoting part 100), and at least two gear marks 300A (see FIGS. 60 to 62, in which three gear marks 300A are shown as “1,” “2,” and “3”) are disposed at positions on the carrying body 300 near the pivoting part 100. When the pivoting part 100 is pivoted to a designated pivoted position, the gear indicating mark 100A will be aligned with one of the gear marks 300A, thereby assisting the user to adjust the gear of the pivoting part 100.

In order to realize that the pivoting part 100 can be adjusted and locked among three pivoted positions, in the embodiments shown in FIGS. 26A to 31, taking the scheme that the engaging member 150 can be actuated to be separated from being engaged with the second engaging slot 144 as an example, the disclosure makes the following arrangements for the engaging member 150, the first engaging slot 170, and the second engaging slot 144.

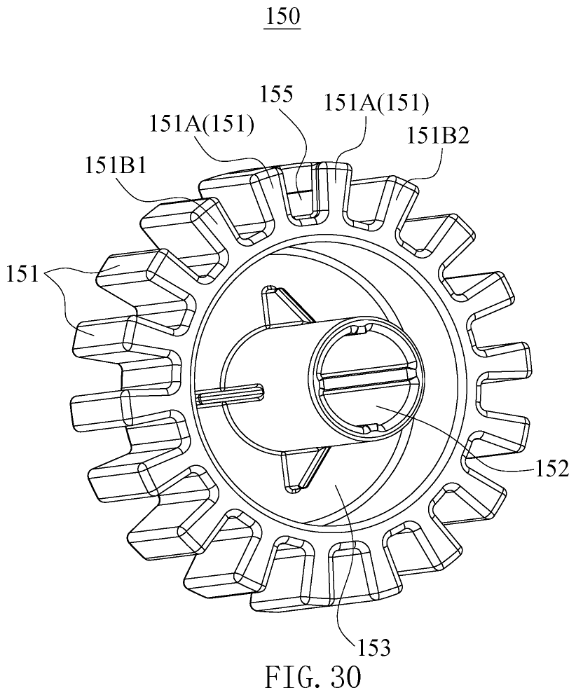

As shown in FIG. 30, two consecutive external teeth 151 of the engaging member 150, which are formed as an external gear, are arranged to have an external teeth connection part 155 therebetween. For convenience of description, two consecutive external teeth 151 with an external teeth connection part 155 therebetween will be defined as gear adjustment external teeth 151A. The external teeth connection part 155 can be integrally formed with, or formed separately and then combined together with the two gear adjustment external teeth 151A of the engaging member 150. In addition, the external teeth connection part 155 may partially or completely fill the space between the two gear adjustment external teeth 151A.

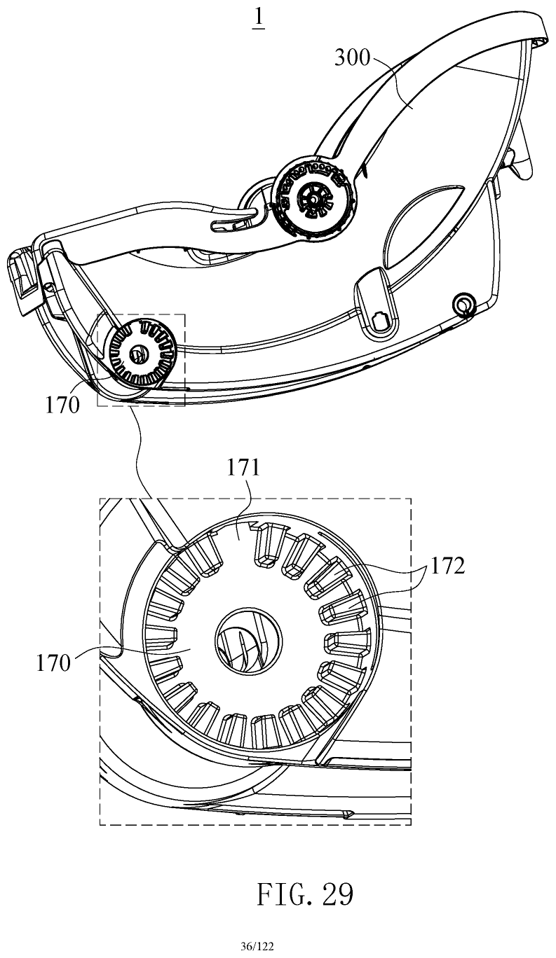

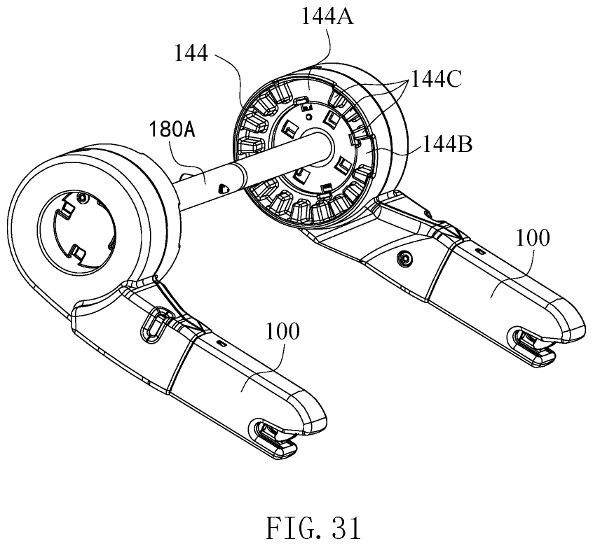

As shown in FIG. 29, the internal gear of the first engaging slot 170 has a plurality of internal teeth, which can be called first engaging slot internal teeth 172. In the scheme that the engaging member 150 can be actuated to be separated from being engaged with the second engaging slot 144 shown in FIG. 31, as shown in FIG. 29, the internal gear of the first engaging slot 170 is provided with a first tooth-lacking part 171. The first tooth-lacking part 171 lacks a first engaging slot internal tooth 172, such that it can accommodate the two consecutive external teeth 151 of the engaging member 150. Thus, the first tooth-lacking part 171 can accommodate the two gear adjustment external teeth 151A of the engaging member 150. In other words, the two gear adjustment external teeth 151A of the engaging member 150 can only be engaged with the first tooth-lacking part 171 of the first engaging slot 170.

The internal gear of the second engaging slot 144 has a plurality of internal teeth, which can be called second engaging slot internal teeth 144C. The second engaging slot internal teeth 144C of the second engaging slot 144 and the first engaging slot internal teeth 172 of the first engaging slot 170 are corresponding to the external teeth 151 of the engaging member 150 in shape and size.

As shown in FIG. 31, the internal gear of the second engaging slot 144 is provided with a second tooth-lacking part 144A and a third tooth-lacking part 144B which are separated from each other by at least one second engaging slot internal tooth 144C (FIG. 31 shows they are separated by three second engaging slot internal teeth 144C). On the premise that number of the second engaging slot internal teeth 144C is fixed, the number of the second engaging slot internal teeth 144C between the second tooth-lacking part 144A and the third tooth-lacking part 144B will affect the angular difference between the first pivoted position (storage pivoted position) and the second pivoted position (the middle pivoted position). If the number is large, the angular difference will be relative large, and if the number is small, the angular difference will be relative small

In the embodiment shown in FIG. 31, the second tooth-lacking part 144A lacks two consecutive second engaging slot internal teeth 144C, such that it can accommodate three consecutive external teeth 151 of the engaging member 150. The third tooth-lacking part 144B lacks one second engaging slot internal tooth 144C, such that it can accommodate two consecutive external teeth 151 of the engaging member 150. Thus, the third tooth-lacking part 144B, which lacks one second engaging slot internal tooth 144C, can accommodate two gear adjustment external teeth 151A of the engaging member 150, and the second tooth-lacking part 144A, which lacks two consecutive second engaging slot internal teeth 144C, can accommodate two gear adjustment external teeth 151A of the engaging member 150 and an adjacent external tooth 151B1 (one side) or 151B2 (the other side). In other words, the two gear adjustment external teeth 151A of the engaging member 150 can only be engaged with the second tooth-lacking part 144A or the third tooth-lacking part 144B.

Based on such arrangement, the engaging member 150 always keeps being engaged with the first engaging slot 170, so the two gear adjustment external teeth 151A of the engaging member 150 are accommodated in the first tooth-lacking part 171 of the first engaging slot 170. When the engaging member 150 is engaged with the second engaging slot 144, since the two gear adjustment external teeth 151A of the engaging member 150 can only be accommodated in the second tooth-lacking part 144A or the third tooth-lacking part 144B of the second engaging slot 144, the second engaging slot 144 and the engaging member 150 can be engaged at three pivoted positions, in which the second tooth-lacking part 144A provides two pivoted positions (i.e., the second pivoted position and the third pivoted position, in other words, the middle pivoted position and the maximum pivoted position), and the third tooth-lacking part 144B provides one pivoted position (i.e., the first pivoted position, in other words, the storage pivoted position), which will be described in detail below. Thus, the pivoting part 100 forming the second engaging slot 144 can only be adjusted and locked at three pivoted positions.

Of course, the above arrangement of the engaging member 150, the first engaging slot 170, and the second engaging slot 144 is only an example, and the disclosure is not limited thereto.

The external gear of the engaging member 150 may have more than two gear adjustment external teeth 151A, correspondingly, the first tooth-lacking part 171 of the first engaging slot 170 may lack more than one consecutive first engaging slot internal teeth 172, the second tooth-lacking part 144A of the second engaging slot 144 may lack more than two consecutive second engaging slot internal teeth 144C, and the third tooth-lacking part 144B of the second engaging slot 144 may lack more than one consecutive second engaging slot internal tooth 144C. Thus, the second tooth-lacking part 144A can provide more than two pivoted positions, and the third tooth-lacking part 144B can provide one pivoted position, such that the second engaging slot 144 and the engaging member 150 can be engaged at more than three pivoted positions.

Specifically, for example, when the external gear of the engaging member 150 has N+1 gear adjustment external teeth 151A, correspondingly, the first tooth-lacking part 171 of the first engaging slot 170 may lack N consecutive first engaging slot internal teeth 172 (when N is 1, the first tooth-lacking part 171 lacks one first engaging slot internal tooth 172), the second tooth-lacking part 144A of the second engaging slot 144 may lack N+M consecutive second engaging slot internal teeth 144C, and the third tooth-lacking part 144B of the second engaging slot 144 may lack N consecutive second engaging slot internal teeth 144C (when N is 1, the third tooth-lacking part 144B lacks one second engaging slot internal tooth 144C), where N and M are integers greater than zero. Thus, after the engaging member 150 is engaged with the second engaging slot 144, and the second tooth-lacking part 144A accommodates all the N+1 gear adjustment external teeth 151A and the M adjacent external teeth 151 of the engaging member 150 therein, the engaging member 150 can be engaged with the second engaging slot 144 at M+1 different pivoted positions, such that the second tooth-lacking part 144A can position the pivoting part 100 at M+1 different pivoted positions. Moreover, the third tooth-lacking part 144B further provides one pivoted position, such that the second engaging slot 144 can be engaged with the engaging member 150 at M+2 different pivoted positions.

FIGS. 26A to 28C show an embodiment of the disclosure to realize three pivoted positions of the pivoting part 100, in which the above N and M are both 1, i.e., the external gear of the engaging member 150 has two gear adjustment external teeth 151A, the first tooth-lacking part 171 of the first engaging slot 170 lacks one first engaging slot internal tooth 172, the second tooth-lacking part 144A of the second engaging slot 144 lacks two consecutive second engaging slot internal teeth 144C, and the third tooth-lacking part 144B of the second engaging slot 144 lacks one second engaging slot internal tooth 144C.

As shown in FIGS. 26A to 26C, the second engaging slot 144 is engaged with the engaging member 150 at the first pivoted position, such that the pivoting part 100 is located at the first pivoted position (i.e., the storage pivoted position). The first pivoted position may be arranged such that at least part of the pivoting part 100 is located inside the recess 340 of the carrying body 300 (see FIG. 26A), and is in the storage position.

As shown in FIG. 26C, when the pivoting part 100 is located at the first pivoted position, the two gear adjustment external teeth 151A of the engaging member 150 are accommodated in the third tooth-lacking part 144B of the second engaging slot 144, which can accommodate two consecutive external teeth 151.

Moreover, as shown in FIGS. 27A to 28C, the second engaging slot 144 is engaged with the engaging member 150 at the second pivoted position and the third pivoted position, such that the pivoting part 100 is correspondingly located at the second pivoted position (i.e., the middle pivoted position) and the third pivoted position (i.e., the maximum pivoted position). The second pivoted position and the third pivoted position may be arranged to enable the pivoting part 100 to be in two working positions, such that the anchor assembly of the pivoting part 100 can be connected to the vehicle seat at two angles.

As shown in FIG. 28C, when the pivoting part 100 is located at the third pivoted position, both the two gear adjustment external teeth 151A of the engaging member 150 and one adjacent external tooth 151B1 on one side thereof are accommodated in the second tooth-lacking part 144A of the second engaging slot 144, which can accommodate three consecutive external teeth 151.

As shown in FIG. 27C, when the pivoting part 100 is located at the second pivoted position, both the two gear adjustment external teeth 151A of the engaging member 150 and another adjacent external tooth 151B2 on the other side thereof are accommodated in the second tooth-lacking part 144A of the second engaging slot 144 which can accommodate three consecutive external teeth 151.

Thus, the pivoting part 100 can be pivoted and locked only between three pivoted positions. The first pivoted position can be used to store the pivoting part 100 in the carrier 1. By setting the angles among the three pivoted positions, for example, as mentioned above, the angular difference between the second pivoted position and the third pivoted position is smaller than the angular difference between the second pivoted position and the first pivoted position, and the second pivoted position and the third pivoted position can ensure that the carrier 1 is connected to the vehicle seat at a proper placement angle through the anchor assembly, thereby avoiding the carrier 1 from accidental situation such as tipping and the like.

Of course, the disclosure is not limited thereto.

In another scheme, the engaging member 150 can be actuated to be separated from being engaged with the first engaging slot 170. Therefore, arrangements of the engaging member 150, the first engaging slot 170, and the second engaging slot 144 need to be modified accordingly. Specifically, the internal gear of the second engaging slot 144 is only provided with a first tooth-lacking part, such that it can accommodate the N+1 gear adjustment external teeth 151A of the engaging member 150; the internal gear of the first engaging slot 170 is provided with a second tooth-lacking part and a third tooth-lacking part which are separated from each other by at least one tooth, such that the third tooth-lacking part lacking N consecutive internal teeth can accommodate N+1 gear adjustment external teeth 151A of the engaging member 150, and the second tooth-lacking part lacking N+M consecutive internal teeth can accommodate N+1 gear adjustment external teeth 151A of the engaging member 150 and M adjacent external teeth, where N and Mare integers greater than zero. Therefore, the first engaging slot 170 can be engaged with the engaging member 150 at M+1 different pivoted positions. Thus, the pivoting part 100 forming the second engaging slot 144 can also be adjusted and locked at M+1 pivoted positions.

In other embodiments, the external gear of the engaging member 150 may not be provided with the external teeth connection part 155, i.e., the gear adjustment external teeth 151A. Thus, the external gear of the engaging member 150 can be engaged with the first engaging slot 170 and the internal gear of the second engaging slot 144 at a plurality of pivoted positions, such that the pivoting part 100 can be adjusted and locked among the plurality of pivoted positions.

For example, in the embodiment shown in FIG. 30, the engaging member 150 may have 18 external teeth 151, and the first engaging slot 170 and the second engaging slot 144 have corresponding internal teeth, in the case that the external gear of the engaging member 150 is not provided with the external teeth connection part 155, the angular difference between the pivoted position of the pivoting part 100 before rotating one tooth and the pivoted position of the pivoting part 100 after rotating one tooth is 20°.

In other embodiments, the engaging member 150 may have 12 external teeth 151, and the first engaging slot 170 and the second engaging slot 144 also have corresponding internal teeth, in the case that the external gear of the engaging member 150 is not provided with the external teeth connection part 155, the angular difference between the pivoted position of the pivoting part 100 before rotating one tooth and the pivoted position of the pivoting part 100 after rotating one tooth is 30°.

It should be understood, the engaging member 150 may have other numbers of teeth, for example, 10, 11, 13, 14, 15, 16, and so on. However, it should be understood, the more the teeth of the engaging member 150, the smaller the strength of each tooth and the force it can bear, the weaker the bearing capacity of the pivoting part 100, and the higher the manufacturing cost. Therefore, the number of the teeth of the engaging member 150 should be set according to the actual requirement.

In an embodiment, the gear height is 1.025 mm.

The connecting shaft 180 may pass through the centre hole 152 of the engaging member 150.

In an embodiment, the accommodation slot 153 is formed on the outer side of the engaging member 150 (the side away from the carrying body 300).

In an embodiment, the accommodation slot 153 is formed on the inner side of the engaging member 150 (the side adjacent the carrying body 300).

Both the centre hole 152 and the accommodation slot 153 can be centrally formed on the engaging member 150. The centre hole 152 and the accommodation slot 153 may form concentric circles, but the disclosure is not limited thereto.

The gear adjustment structure 400 may further include a reset member 160.

In an embodiment, the reset member 160 is a coil spring.

In an embodiment, the reset member 160 is an elastomer.

In an embodiment, the reset member 160 is a magnet. In the disclosure, a magnet may refer to a material which can provide a magnetic force. Accordingly, the engaging member 150 may be a magnet or an iron component, such that it can be actuated by a reset member formed as a magnet. The reset member 160 formed as a magnet may be fixed to the bottom wall of the first engaging slot 170.

In an embodiment, the reset member 160 is arranged between the first engaging slot 170 and the engaging member 150, and abuts against the first engaging slot 170 and the engaging member 150 to provide a restoring force tending to engage the engaging member 150 with the second engaging slot 144 (as shown in FIG. 2). In this embodiment, the engaging member 150 may be actuated, so as to be separated from the second engaging slot 144.

In an embodiment, the reset member 160 is arranged between the inner cover 140 and the engaging member 150, and abuts against the inner cover 140 and the engaging member 150 to provide a restoring force tending to engage the engaging member 150 with the first engaging slot 170 (not shown). In this embodiment, the engaging member 150 may be actuated, so as to be separated from the first engaging slot 170.

One end of the reset member 160 may be located in the accommodation slot 153 of the engaging member 150, and the other end of the reset member 160 may be located in one of the accommodation slots 310 of the carrying body 300 or in an accommodation slot on the inner cover 140 (not shown).

As shown in FIG. 3, the second engaging slot 144 includes an internal gear. The second engaging slot 144 may be formed on the inner side of the inner cover 140 (the side facing the carrying body 300).

The thickness of the engaging member 150 may be set to be engaged with both the first engaging slot 170 and the second engaging slot 144.

Referring to FIGS. 2 to 3, the gear adjustment structure 400 may further include a driving part 110. The driving part 110 is movably arranged in the pivoting part 100, and can be actuated to cause the engaging member 150 to be separated from being engaged with the first engaging slot 170 or the second engaging slot 144.

### First Embodiment of Driving Part

In an embodiment, the driving part 110 is formed as a button.

In an embodiment, the driving part 110 is formed as a pulling component, such as a pull ring, a hook, a grip, and the like.

In an embodiment, the driving part 110 may be at least partially arranged in the accommodation slot 123 of the outer cover 120. The outer side of the driving part 110 (the side away from the carrying body 300) may be exposed, such that it may be contacted by a part of a person (e.g., a hand).

The driving part 110 may include a buckle part 111. The buckle part 111 may be formed in a shape of a straight rod, extending inward from a main body part of the driving part 110. A free end of the buckle part 111 may be formed as a hook. The driving part 110 may include four buckle parts 111 corresponding to the four holes 124 of the outer cover 120 and the four holes 134 of the body member 130, but the disclosure is not limited thereto.

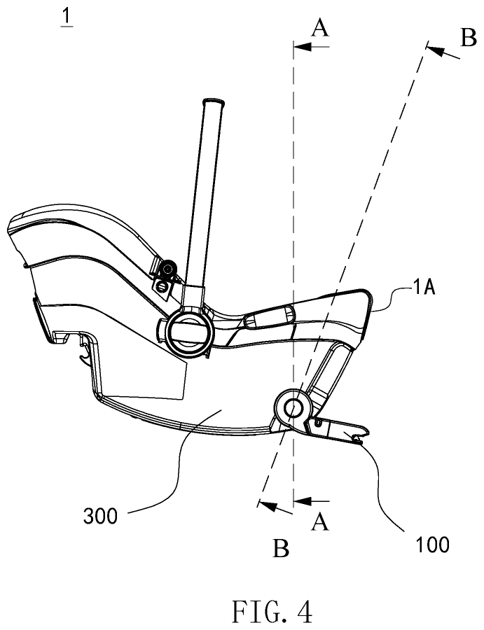

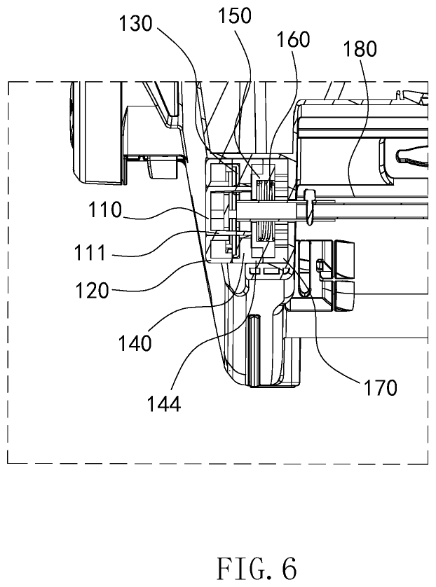

Referring to FIGS. 4 to 6, the buckle part 111 may pass through the hole 124 of the outer cover 120, the hole 134 of the body member 130, and the centre hole 143 of the inner cover 140 to abut against the engaging member 150.

The hole 134 of the body member 130 is not exactly aligned with the hook-shaped free end of the buckle part 111. Thus, when the buckle part 111 passes through the hole 134 of the body member 130, the buckle part 111 is elastically deformed, and after the buckle part 111 passes through the hole 134 of the body member 130, the surrounding part of the hole 134 of the body member 130 will obstruct the hook-shaped free end of the buckle part 111from reversely passing through the hole 134 of the body member 130 again. Therefore, the buckle part 111 prevents the driving part 110 from being separated from the pivoting part 100.

When the driving part 110 is not actuated, the engaging member 150 is engaged with the first engaging slot 170 and the second engaging slot 144 at the same time, such that the pivoting part 100 is locked in one of the pivoted positions in respect with the carrying body 300 and cannot be pivoted around the connecting shaft 180.

When the driving part 110 is not actuated, the outer surface of the driving part 110 is flush with the outer surface of the base part 121 of the outer cover 120, thereby providing a good appearance and operating convenience.

In an embodiment, the outer surface of the base part 121 of the outer cover 120 may not protrude from the outer surface of the side part 330 of the carrying body 300, such that the carrier 1 has a smooth appearance.

In an embodiment, the driving part 110 can be actuated in a direction perpendicular to the pivot plane of the pivoting part 100.

In an embodiment, when the driving part 110 is actuated (e.g., the driving part 110 is pressed in a direction toward the carrying body 300), the buckle part 111 of the driving part 110 actuates the engaging member 150 to move toward the direction being separated from the second engaging slot 144. This process needs to overcome the restoring force of the reset member 160. When the engaging member 150 is completely separated from the second engaging slot 144, the pivoting part 100 can be pivoted around the connecting shaft 180. When the pivoting part 100 is pivoted to the required angle, the actuation of the driving part 110 is released, such that the engaging member 150 is engaged again with the first engaging slot 170 and the second engaging slot 144 at the same time again, so as to avoid unexpected pivoting of the pivoting part 100.

In an embodiment, when the driving part 110 is actuated (e.g., the driving part 110 is pulled out in a direction away from the carrying body 300), since one end of the driving part 110 is connected to the engaging member 150, the driving part 110 can bring the engaging member 150 to move toward a direction being separated from the first engaging slot 170. This process needs to overcome the restoring force of the reset member 160. When the engaging member 150 is completely separated from the first engaging slot 170, the pivoting part 100 can be pivoted around the connecting shaft 180. When the pivoting part 100 is pivoted to the required angle, the actuation of the driving part 110 is released, such that the engaging member 150 is engaged again with the first engaging slot 170 and the second engaging slot 144 at the same time again, so as to avoid unexpected pivoting of the pivoting part 100.

In an embodiment, the driving parts 110 of the pivoting parts 100 on both sides of the carrying body 300 are synchronously actuated to unlock the two pivoting parts 100, and the two pivoting parts 100 are synchronously pivoted.

In an embodiment, the connecting shaft 180 may not be provided. Thus, after the two pivoting parts 100 are unlocked, the two pivoting parts 100 can be pivoted independent to each other.

In an embodiment, the driving part 110 may be formed as a knob, a dial or a pull handle.

In an embodiment, the driving part 110 may be formed on an outer peripheral part of the base part 121 of the outer cover 120 and/or the base part 141 of the inner cover 140, and the driving part 110 may be actuated in a radial direction (the movement direction is directed to the connecting shaft of the pivoting part 100). In this embodiment, the pivoting part 100 may protrude from a side part 330 of the carrying body 300 in the lateral direction of the carrier 1. The pivoting part 100 may include a wedge (not shown). The wedge cooperates with the driving part 110 to convert a radial motion of the driving part 110 into an axial motion of the wedge, such that the driving part 110 is pressed, the wedge actuates the engaging member 150 to be separated from being engaged with the first engaging slot 170 or the second engaging slot 144. This embodiment can make the operation of unlocking the rotation of the pivoting part 100 more convenient, that is, is only required to press the driving part 110 and rotate the pivoting part 100 at the same time with one hand.

### Second Embodiment of Driving Part

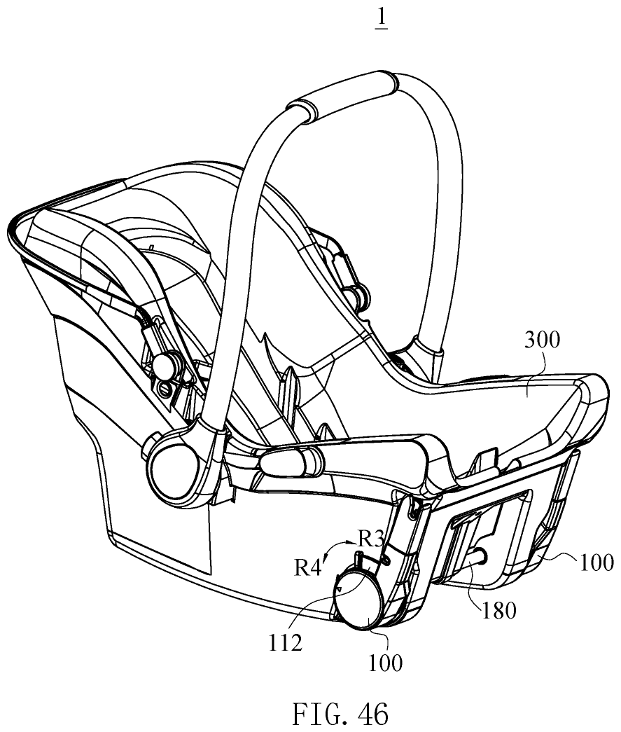

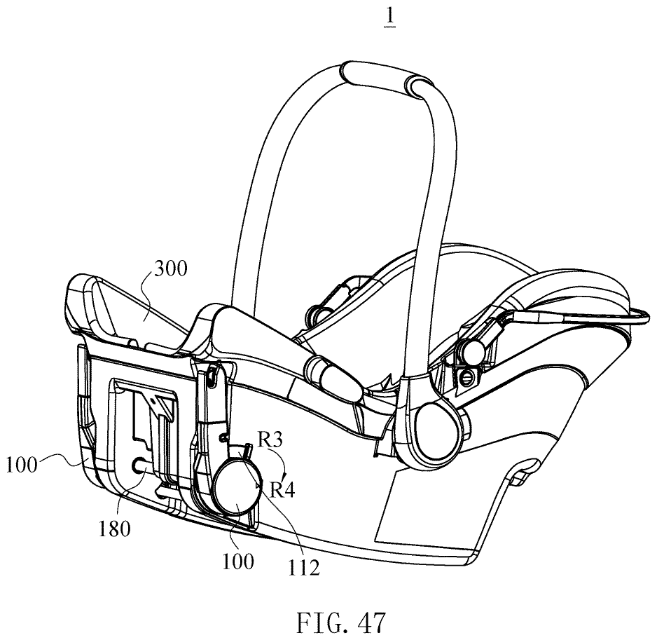

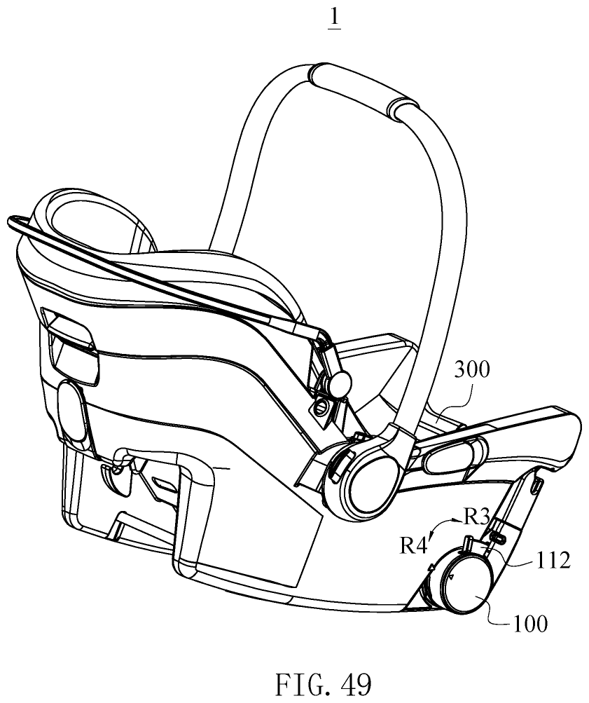

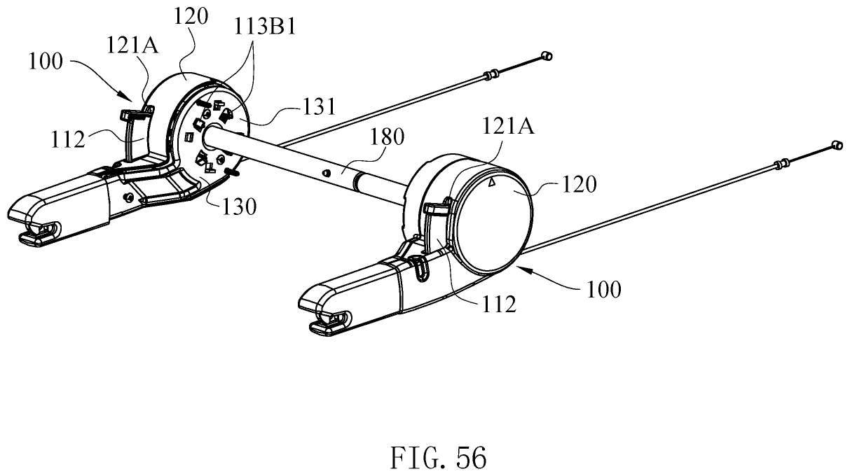

FIGS. 46 to 59 show the second embodiment of the driving part 110′ according to the disclosure, which is different from the first embodiment of the driving part 110 previously described with reference to FIGS. 2 to 6 mainly in that the driving part 110′ in the second embodiment includes two components, i.e., a driving part pivoting member 112 and a driving part pushing member 113, through interaction of the two components, the user only needs to apply an external force in a same direction to the driving part pivoting member 112 of the driving part 110′, which can not only unlock the pivoting part 100, but also cause the pivoting part 100 to be pivoted.

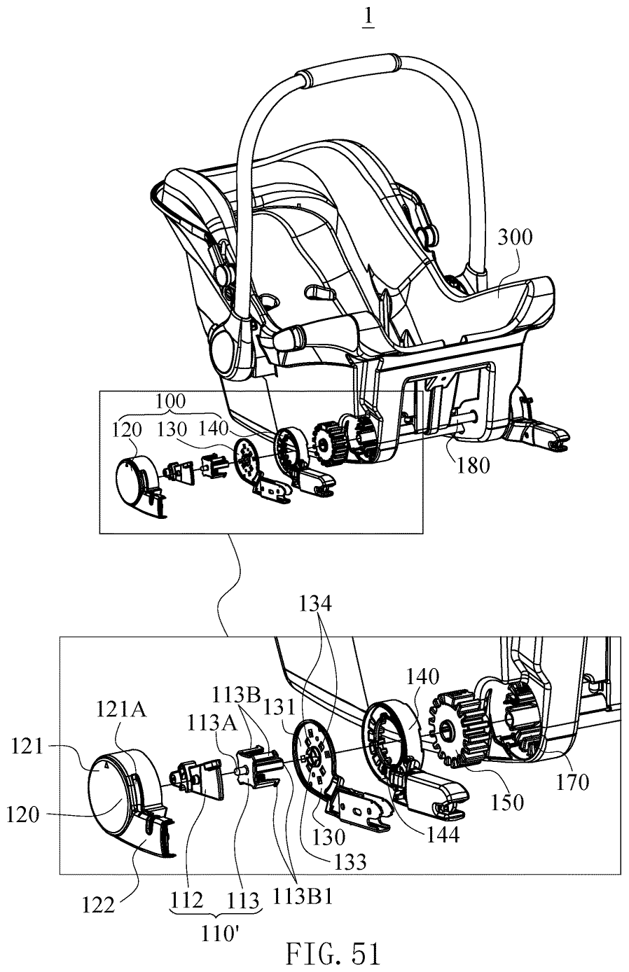

In an embodiment, as shown in FIG. 51, the driving part pivoting member 112 of the driving part 110′ is pivotably arranged in the pivoting part 100, and the driving part pushing member 113 is movably arranged between the driving part pivoting member 112 and the engaging member 150. Furthermore, the driving part pivoting member 112 is arranged to be able to drive the engaging member 150 to be separated from being engaged with the first engaging slot 170 or the second engaging slot 144 via the driving part pushing member 113 under action of an external force.

That is, through the interaction of the driving part pivoting member 112 and the driving part pushing member 113, a pivoting movement of the driving part pivoting member 112 can be converted into a moving of the engaging member 150.

The driving part pivoting member 112 is arranged as its pivot plane is as same as or parallel to the pivot plane of the pivoting part 100, such that the external force in the same direction driving the driving part pivoting member 112 to be pivoted can also drive the pivoting part 100 to be pivoted, thereby greatly facilitating the user's operation.

In the description, “pivot plane” refers to a plane occupied by a component during the pivoting process. For example, the pivot plane of the driving part pivoting member 112 refers to a plane occupied by the driving part pivoting member 112 during the pivoting process, and the pivot plane of the pivoting part 100 refers to a plane occupied by the pivoting part 100 during the pivoting process.

Hereinafter, the driving part pivoting member 112 will be firstly described in detail.

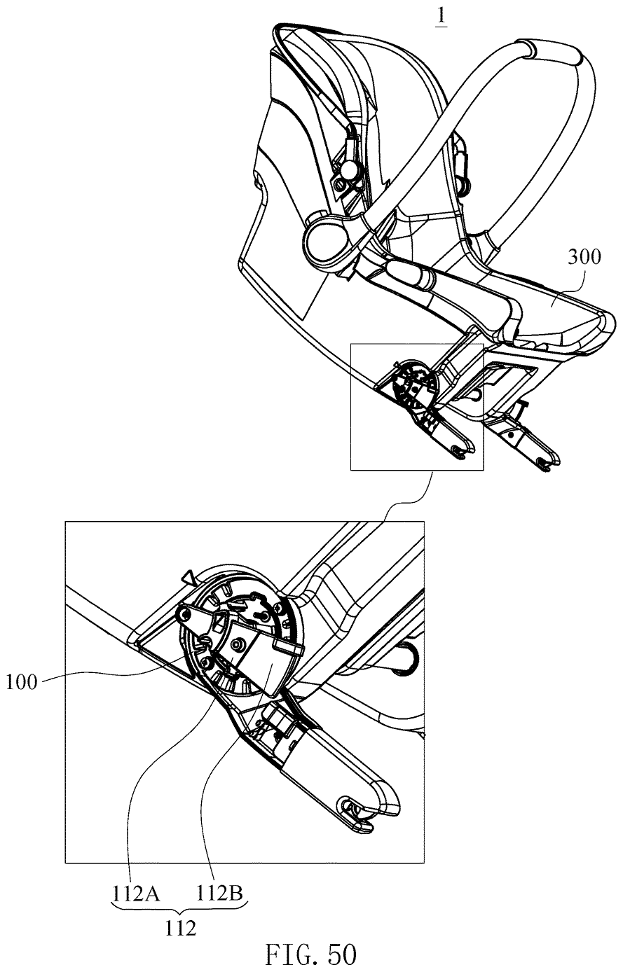

In the embodiments shown in FIGS. 50, 52 and 53, the driving part pivoting member 112 includes a pivoting member pushing section 112A, and the pivoting member pushing section 112A is provided with a pushing ramp 112A1. The pushing ramp 112A1 is arranged to be inclined to the moving direction of the driving part pushing member 113. Specifically, the distance between the pushing ramp 112A1 and a side face of the pivoting member pushing section 112A (the pushing ramp 112A1 is located at the pivoting member pushing section 112A) Add increases or decreases gradually from one side of the pushing ramp 112A1 toward the other side along the pivoting direction, resulting in that the pushing ramp 112A1 is inclined to the side face of the pivoting member pushing section 112A where it is located, and inclined to the moving direction of the driving part pushing member 113. With such structure, when the driving part pivoting member 112 is pivoted, the pushing ramp 112A1 can push the driving part pushing member 113 abutted thereon to move in a direction perpendicular to the pivoting direction, whereby the driving part pushing member 113 drives the engaging member 150.

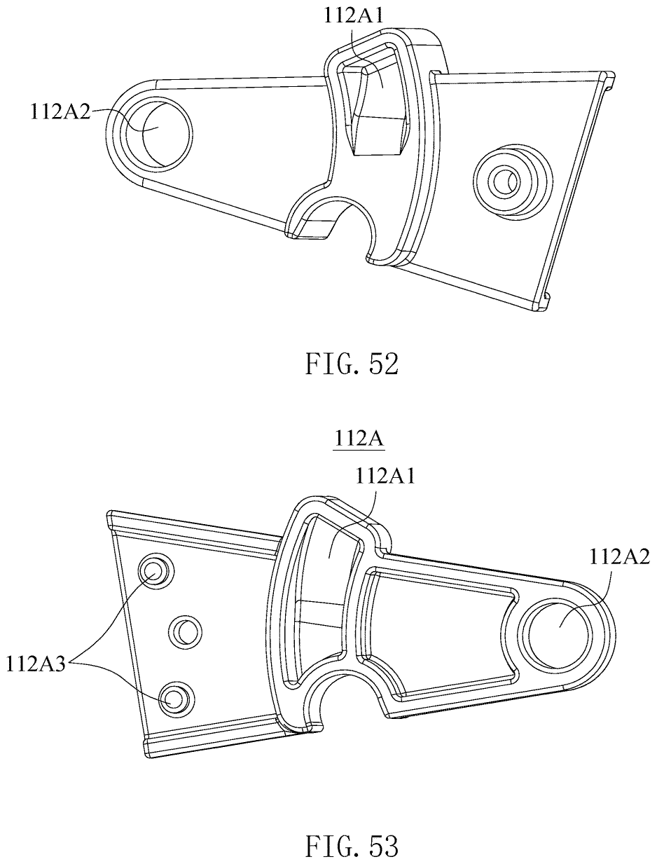

In the embodiment shown in FIGS. 51 to 54, the pivoting member pushing section 112A is in a sheet or plate shape, and the pushing ramp 112A1 is arranged on a side surface of the pivoting member pushing section 112A. In such case, as shown in FIGS. 52 and 53, since the thickness of the pivoting member pushing section 112A is relatively thin, when the pushing ramp 112A1 is formed on one side surface of the pivoting member pushing section 112A, the other side surface will also generate a shape corresponding to the pushing ramp 112A1.

However, the disclosure is not limited thereto, and the pivoting member pushing section 112A may be in the form of a block or a post, as long as it can be pivoted, and its side facing the driving part pushing member 113 can arrange the pushing ramp 112A1.

The pivoting member pushing section 112A has a pivoting member pivoting part 112A2, and the driving part pivoting member 112 can be pivoted around the pivoting member pivoting part 112A2. In the embodiment shown in FIGS. 52 and 53, the pivoting member pivoting part 112A2 is a pivot hole. However, it should be understood, the pivoting member pivoting part 112A2 may also be a pivot shaft.

In order to facilitate the user to apply external force to the driving part pivoting member 112, in the embodiments shown in FIGS. 50 and 51, the driving part pivoting member 112 may further include a pivoting member pressing section 112B. The pivoting member pressing section 112B extends from the pivoting member pushing section 112A in a direction away from the pivoting member pivoting part 112A2 for the user's operation. The existence of the pivoting member pressing section 112B makes a farthest pressure point of the driving part pivoting member 112 farther away from the pivoting member pivoting part 112A2, such that the same external force acting on the farthest pressure point can generate a greater moment to cause the driving part pivoting member 112 to be pivoted, and the user's operation is easier.

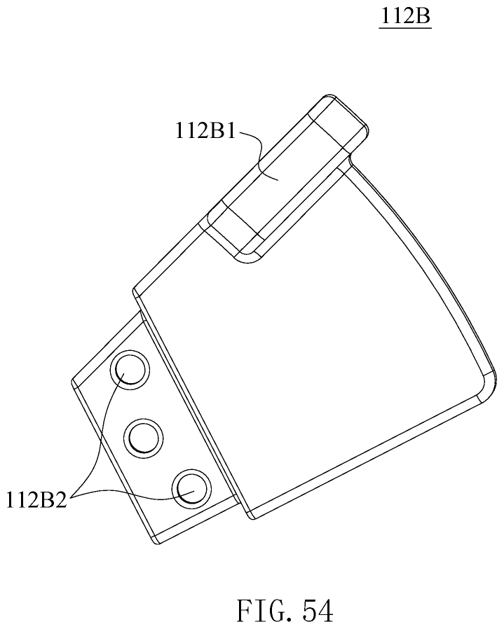

As shown in FIG. 54, the pivoting member pressing section 112B may be provided with a pressing flange 112B1 for external force to act thereon. The pressing flange 112B1 is generally arranged at a position where the farthest pressure point of the driving part pivoting member 112 is located, such that the user can actuate the driving part pivoting member 112 only by applying a relative small external force to the pivoting member pressing section 112B. Of course, the pressing flange 112B1 may be arranged at a position other than the farthest pressure point of the driving part pivoting member 112.

The pivoting member pressing section 112B may be integrally formed with the pivoting member pushing section 112A. In such case, the pivoting member pressing section 112B can be regarded as a part of the pivoting member pushing section 112A. It can also be said, the driving part pivoting member 112 does not include a separate pivoting member pressing section 112B.

The pivoting member pressing section 112B and the pivoting member pushing section 112A may also be formed as two separate components. In such case, the pivoting member pressing section 112B and the pivoting member pushing section 112A may be formed separately and then assembled together.

In the embodiment shown in FIGS. 53 and 54, the pivoting member pushing section 112A is provided with two fixing bulged parts 112A3, and the pivoting member pressing section 112B is provided with fixing recesses 112B2 corresponding to the fixing bulged parts 112A3 of the pivoting member pushing section 112A, such that the pivoting member pushing section 112A and the pivoting member pressing section 112B are connected together by the engagement of the fixing bulged parts 112A3 and the fixing recesses 112B2.

It should be understood, the disclosure is not limited thereto. The fixing bulged part 112A3 may be arranged on the pivoting member pressing section 112B, and the fixing recess 112B2 may be arranged on the pivoting member pushing section 112A. Alternatively, the fixing bulged part 112A3 and the fixing recess 112B2 each can be provided by one or more as required. Alternatively, the pivoting member pushing section 112A and the pivoting member pressing section 112B can be connected together by socked on each other, or threading, or riveting and the like.

As described previously, the pivoting part 100 includes an outer cover 120, a body member 130, and an inner cover 140, as shown in FIG. 51. The outer cover 120 and the inner cover 140 together enclose a space, and the body member 130 is located in the space.

In the embodiments shown in FIGS. 51 and 55-59, a circumferential wall of the base part 121 of the outer cover 120 may be provided with an outer cover notch 121A for the driving part pivoting member 112 to pass therethrough. The outer cover notch 121A extends along the circumferential direction of the base part 121 of the outer cover 120, such that the driving part pivoting member 112 is exposed from the pivoting part 100, so as to facilitate the user's operation thereto.

Of course, the disclosure is not limited thereto. The driving part pivoting member 112 may be pivotably arranged on an outside of an end wall of the base part 121 of the outer cover 120. In such case, the end wall of the base part 121 needs to be provided with a through hole, such that the driving part pushing member 113 located inside the base part 121 can pass through the through hole and contact with the driving part pivoting member 112.

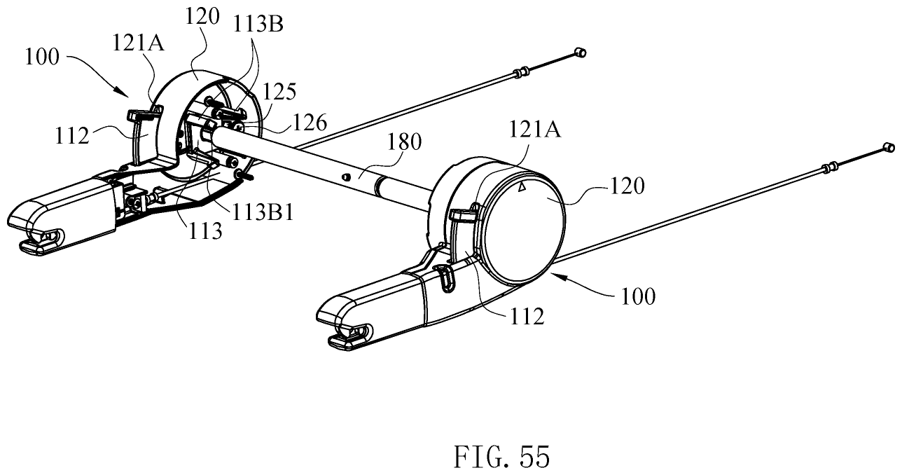

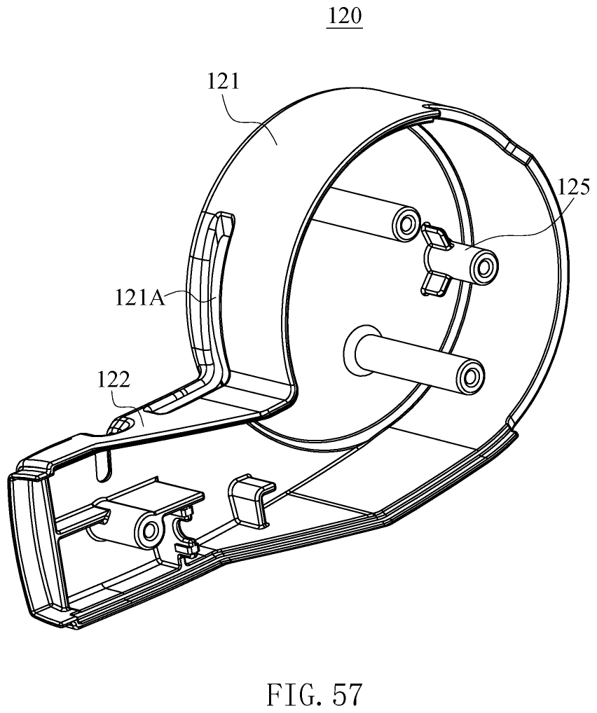

In addition, as shown in FIGS. 55 and 57, the inner end wall of the outer cover 120 is provided with an outer cover pivoting part 125, and the outer cover pivoting part 125 cooperates with the pivoting member pivoting part 112A2 of the driving part pivoting member 112, thereby allowing the driving part pivoting member 112 to be pivoted. In the embodiment shown in FIGS. 55 and 57, the outer cover pivoting part 125 is a pivot hole. However, it should be understood, when the pivoting member pivoting part 112A2 is a pivot shaft, the outer cover pivoting part 125 may be a hole as well.

Further, as shown in FIG. 55, an end of the outer cover pivoting part 125 may be provided a pivoting part obstructing member 126 to prevent the driving part pivoting member 112 from being separated from the outer cover pivoting part 125. The pivoting part obstructing member 126 may be, for example, a screw threadedly connected to the end of the outer cover pivoting part 125, or a pin laterally inserted into the end of the outer cover pivoting part 125, etc.

Next, the driving part pushing member 113 will be described in detail.

The driving part pushing member 113 is arranged between the driving part pivoting member 112 and the engaging member 150. On the one hand, the driving part pushing member 113 is pushed by the driving part pivoting member 112 to move, and on the other hand, the driving part pushing member 113 drives the engaging member 150 to be separated from being engaged with the first engaging slot 170 or the second engaging slot 144.

In order to achieve a better effect for the pushing ramp 112A1 on the pivoting member pushing section 112A to push the driving part pushing member 113, as shown in FIG. 51, the driving part pushing member 113 may be provided with a pushing member pushing end 113A, and the pushing member pushing end 113A abuts against the pushing ramp 112A1.

In order to achieve a better effect for the driving part pushing member 113 to drive the engaging member 150, the driving part pushing member 113 may be provided with at least one pushing member push bar 113B, and the pushing member push bar 113B may be in a shape of a straight rod and abut against the engaging member 150, such that once the pushing member push bar 113B moves, it will drive the engaging member 150.

In the embodiments shown in FIGS. 51 and 55, the pushing member push bar 113B extends along a direction parallel to the movement of the engaging member 150 or a direction parallel to the connecting shaft 180, thereby driving the engaging member 150 better. Of course, it should be understood, the pushing member push bar 113B may extend in a direction inclined to the movement of the engaging member 150.

As shown in FIGS. 51, 56 and 59, the pushing member push bar 113B of the driving part pushing member 113 may pass through the body member 130 and the inner cover 140 to abut against the engaging member 150.

In order to facilitate the pushing member push bar 113B to pass through the body member 130, the body member 130 is provided with a hole 134 corresponding to the pushing member push bar 113B (see FIG. 51).

In order to prevent the pushing member push bar 113B from withdrawing from the hole 134 of the body member 130, resulting in an accidental separation of the driving part pushing member 113 from the body member 130, in the embodiments shown in FIGS. 51, 56 and 59, the end of the pushing member push bar 113B abutting against the engaging member 150 may be provided with a push bar clasp 113B1, and the push bar clasp 113B1 is arranged to be able to be obstructed by a hole wall of the hole 134 and cannot exit the hole 134 after passing through the hole 134 of the body member 130.

In addition, the push bar clasp 113B1 can also limit a moving stroke of the pushing member push bar 113B.

In an embodiment, the hole 134 of the body member 130 is not exactly aligned with the push bar clasp 113B1 of the pushing member push bar 113B. Thus, when the push bar clasp 113B1 passes through the hole 134 of the body member 130, the pushing member push bar 113B will be elastically deformed; and after the push bar clasp 113B1 passes through the hole 134 of the body member 130, the pushing member push bar 113B elastically returns to its original state, so the hole wall of the hole 134 of the body member 130 will obstruct the push bar clasp 113B1 from withdrawing from the hole 134 of the body member 130. Therefore, the push bar clasp 113B1 can prevent the driving part pushing member 113 from being accidentally separated from the body member 130.

When it is necessary to detach the driving part pushing member 113 from the body member 130, the user only needs to apply a force to the push bar clasp 113B1, so as to force the pushing member push bar 113B to be elastically deformed, and when the push bar clasp 113B1 is aligned with the hole 134 of the body member 130, the push bar clasp 113B1 can be withdrawn from the hole 134, thereby realizing separation of the driving part pushing member 113 from the body member 130.

Afterward, the working process of the driving part 110′ including the driving part pivoting member 112 and the driving part pushing member 113 will be described in detail.

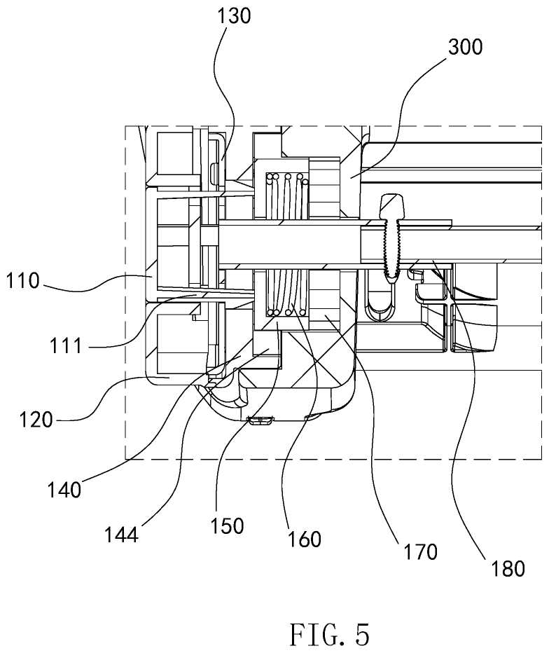

When the driving part 110′ is not actuated, the engaging member 150 is engaged with the first engaging slot 170 and the second engaging slot 144 at the same time as shown in FIG. 5, such that the pivoting part 100 is locked to one of the pivoted positions (e.g., the storage position shown in FIGS. 46 to 49) in respect with the carrying body 300 and cannot be pivoted around the connecting shaft 180.

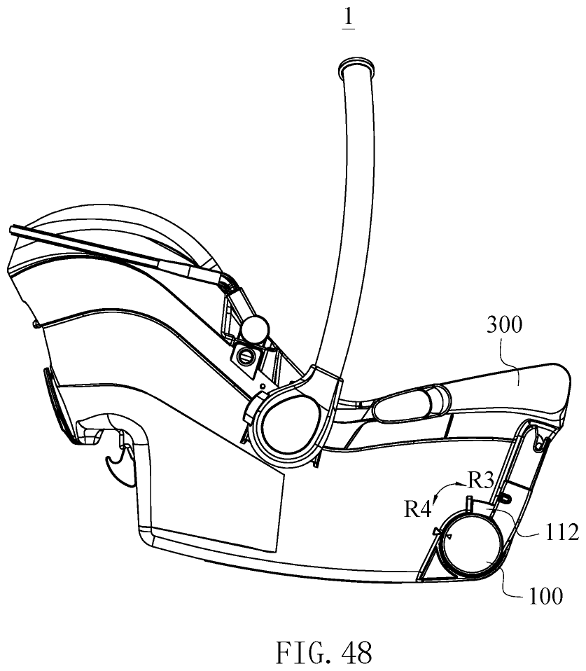

When it is necessary to make the pivoting part 100 be pivoted from the storage position or a certain working position to another working position toward the third pivoting direction R3, the user may apply an external force to the driving part pivoting member 112 to make it be pivoted, and the driving part pivoting member 112 is pivoted toward the third pivoting direction R3 (see FIGS. 46 to 49). Then, referring to FIGS. 48, 51 and 53, in the process that the driving part pivoting member 112 is pivoted toward the third pivoting direction R3, the pushing ramp 112A1 of the pivoting member pushing section 112A will push the driving part pushing member 113, such that the driving part pushing member 113 moves in the direction perpendicular to the pivoting direction, thus the driving part pushing member 113 drives the engaging member 150 to move toward a direction of separating from the second engaging slot 144.

When the engaging member 150 is completely separated from the second engaging slot 144, the pivoting part 100 is unlocked and can be pivoted around the connecting shaft 180. Then, under action of the external force applied by the user in the same direction, the pivoting part 100 is also pivoted toward the third pivoting direction R3 (see FIGS. 46 to 49), until the pivoting part 100 reaches the required pivoted angle (i.e., another working position).

Afterward, the user can release the actuation of the driving part 110′, that is, the user no longer applies external force to the driving part pivoting member 112, and the engaging member 150 is engaged again with the first engaging slot 170 and the second engaging slot 144 at the same time under action of the reset member 160 (see FIGS. 2, 3, 5, 6 and 8), thereby locking the pivoting part 100 at the pivoted angle. Meanwhile, the driving part pivoting member 112 will also be pivoted toward the fourth pivoting direction R4 (see FIGS. 46 to 49), for example, due to the acting force of the reset member 160, thereby returning to the initial position (this process will be described below).

Thus, in the case that the second embodiment of the driving part 110′ according to the disclosure is adopted, the user only needs to apply an external force in the same direction to the driving part pivoting member 112 of the driving part 110′, for example, with his thumb, he can not only make the driving part pivoting member 112 be pivoted and unlock the pivoting part 100, but also make the pivoting part 100 be pivoted toward the third pivoting direction R3, thereby greatly facilitating the user's operation.

When it is necessary to make the pivoting part 100 be pivoted from a certain working position to another working position or storage position toward the fourth pivoting direction R4, the user similarly applies an external force to driving part pivoting member 112 for make it be pivoted, and the driving part pivoting member 112 is pivoted toward the third pivoting direction R3, until the pivoting part 100 is unlocked and can be pivoted around the connecting shaft 180. Afterward, the user applies an external force in the opposite direction to the pivoting part 100, such that the pivoting part 100 is pivoted toward the fourth pivoting direction R4, until the pivoting part 100 reaches the required pivoted angle (i.e., another working position or storage position). In this process, the user can press the driving part pivoting member 112 with the thumb of one hand to make it be pivoted toward the third pivoting direction R3, so as to unlock the pivoting part 100, and then use the remaining fingers to pluck the pivoting part 100 to make it be pivoted toward the fourth pivoting direction R4, thereby completing the operation of making the pivoting part 100 be pivoted by using one hand, which is also convenient for the user to operate.

In another embodiment, the driving part pivoting member 112 may be arranged not to be pivoted toward the third pivoting direction R3 to unlock the pivoting part 100, but to be pivoted toward the fourth pivoting direction R4 to unlock the pivoting part 100. In such embodiment, the inclined direction of the pushing ramp 112A1 of the pivoting member pushing section 112A is opposite to the inclined direction of the pushing ramp 112A1 in the previous embodiments, such that in the process for the driving part pivoting member 112 to be pivoted toward the fourth pivoting direction R4, the pushing ramp 112A1 of the pivoting member pushing section 112A can push the driving part pushing member 113 to move in the direction perpendicular to the pivoting direction.

Correspondingly, the driving part pivoting member 112 can be provided with a pulling flange (not shown), so as to facilitate the user to pull the driving part pivoting member 112 to be pivoted toward the fourth pivoting direction R4.

In another embodiment mentioned above, the user only needs to apply an external force on the driving part pivoting member 112 of the driving part 110′ in the same direction, then not only the driving part pivoting member 112 can be pivoted to unlock the pivoting part 100, but also the pivoting part 100 can be pivoted toward the fourth pivoting direction R4, which also greatly facilitate the user's operation.

After the pivoting part 100 reaches the required pivoted angle, the user will no longer apply external force to the driving part pivoting member 112. At this time, the driving part pivoting member 112 will return to the initial position under action of the restoring force of the aforementioned reset member 160.

Specifically, when the user no longer applies external force to the driving part pivoting member 112, the restoring force of the reset member 160 will force the engaging member 150 to move toward the second engaging slot 144 and is engaged with the second engaging slot 144, thereby locking the pivoting part 100 at the pivoted angle. In this process, the engaging member 150 will drive the driving part pushing member 113 abutting against it to move toward the driving part pivoting member 112. Then, the driving part pushing member 113 will push the pushing ramp 112A1 of the pivoting member pushing section 112A in turn, whereby making the pivoting member pushing section 112A, i.e., the driving part pivoting member 112, be pivoted toward the fourth pivoting direction R4 (see FIGS. 46 to 49) to return to the initial position.

In another embodiment, the driving part 110′ may be provided with a driving part reset member (not shown). When the driving part pivoting member 112 is not acted by external force, the driving part reset member will drive the driving part pivoting member 112 back to the initial position. The driving part reset member may adopt a torsion spring arranged around the pivoting member pivoting part 112A2 of the driving part pivoting member 112, or adopt another elastomer such as a spring or a tension spring which can exert elastic force to the driving part pivoting member 112.

In the case that the carrier 1 has two pivoting parts 100, the two pivoting parts 100 are respectively coupled to both ends of the connecting shaft 180, and a driving part 110′ (i.e., a driving part pivoting member 112) can be respectively arranged at each of the two pivoting parts 100, as shown in FIGS. 46-49, 55, 56, 58, 59.

### Third Embodiment of Driving Part

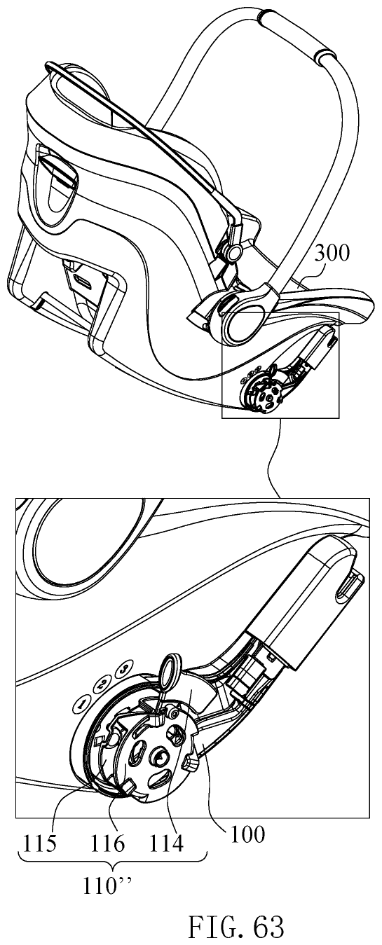

FIGS. 60 to 65 show the third embodiment of the driving part 110″ according to the disclosure, which includes a driving part pivoting button 114, a driving part rotating disk 115, and a driving part moving member 116. The third embodiment of the driving part 110″ is different from the second embodiment of the driving part 110′previously described with reference to FIGS. 46 to 59 9 mainly in that the driving part pivoting button 114 and the driving part rotating disk 115 which can rotate together in the driving part 110″ of the third embodiment replace the driving part pivoting member in the second embodiment, and the driving part moving member 116 the driving part 110″ of the third embodiment replaces the driving part pushing member in the second embodiment. In the driving part 110″ of the third embodiment, through interaction between the driving part rotating disk 115 and the driving part moving member 116, the user only needs to exert an external force in the same direction to the driving part pivoting button 114, which can not only unlock the pivoting part 100, but also enable the pivoting part 100 to be pivoted.

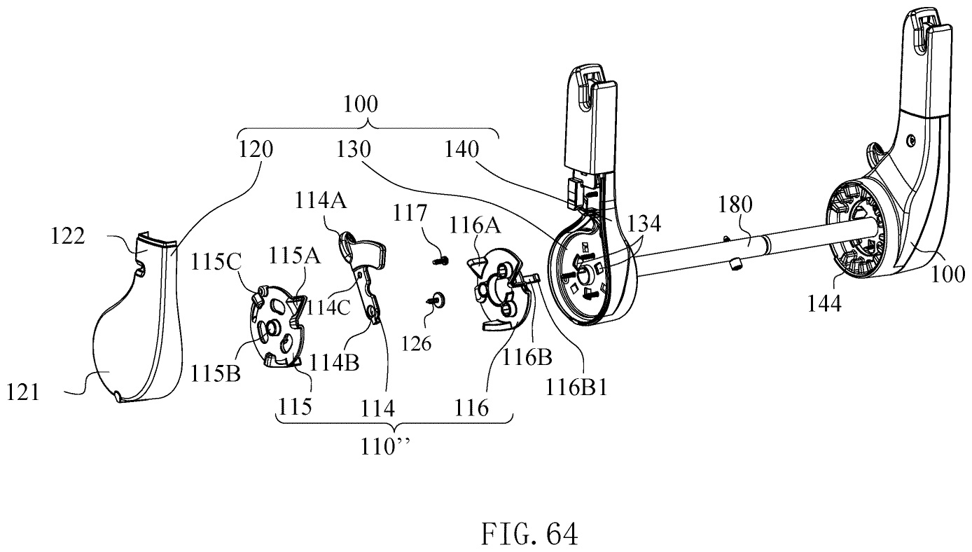

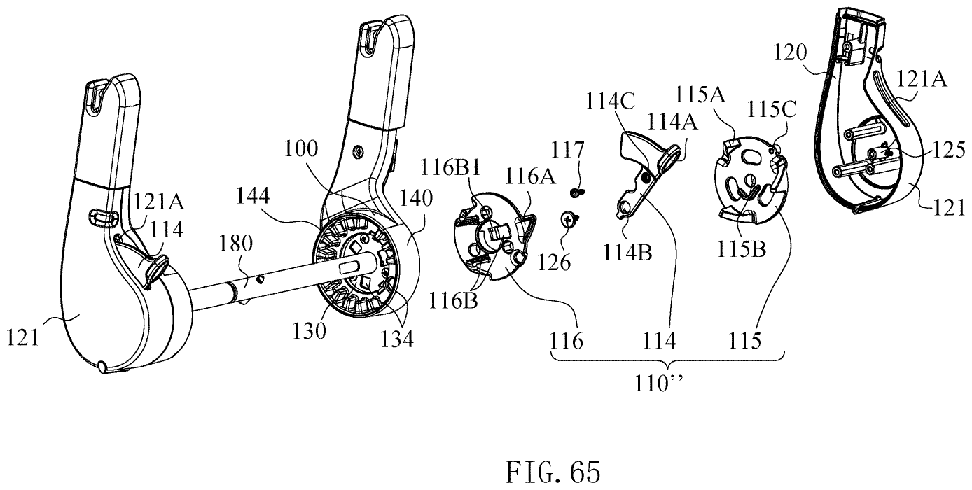

In an embodiment, as shown in FIGS. 64 and 65, the driving part pivoting button 114 and the driving part rotating disk 115 in the driving part 110″ can be rotatably arranged on the pivoting part 100, and the driving part moving member 116 is movably arranged between the driving part rotating disk 115 and an engaging member 150 (not shown). Moreover, the driving part pivoting button 114 is arranged to be able to drive the engaging member 150 (not shown) to be separated from being engaged with the first engaging slot 170 (not shown) on the carrying body 300 or the second engaging slot 144 (see FIGS. 64 and 65) on the pivoting part 100 through the driving part rotating disk 115 and the driving part moving member 116 under action of an external force.

That is, through interaction between the driving part rotating disk 115 and the driving part moving member 116, a rotation of the driving part pivoting button 114 can be converted into a movement of the engaging member 150.

The driving part pivoting button 114 is arranged such that its rotation plane is as same as or parallel to the pivot plane of the pivoting part 100, such that the external force in the same direction driving the driving part pivoting button 114 to be pivoted can also drive the pivoting part 100 to be pivoted, thus greatly facilitating the user's operations.

Throughout the disclosure, the meaning of the term “rotation plane” is similar to that of the aforementioned term “pivot plane,” which refers to a plane occupied by a component in the process of rotation. For example, the rotation plane of the driving part pivoting button 114 refers to a plane occupied by the driving part pivoting button 114 in the process of rotation.

Next, firstly, the driving part pivoting button 114 and the driving part rotating disk 115 will be described in detail.

The driving part pivoting button 114 is provided with a button rotating part 114B, such that the driving part pivoting button 114 can rotate around the button rotating part 114B. In the embodiment shown in FIGS. 64 and 65, the button rotating part 114B is a rotation hole. However, it should be understood, the button rotating part 114B may also be a rotation shaft.

In order to facilitate the user to exert external force to the driving part pivoting button 114, in the embodiments shown in FIGS. 64 and 65, the driving part pivoting button 114 may be further provided with a button pressing part 114A for an external force acting thereon. The button pressing part 114A is generally arranged at a farthest pressure point of the driving part pivoting button 114 farthest away from the button rotating part 114B, such that the user only needs exerting a small external force to the button pressing part 114A to actuate the driving part pivoting button 114. Of course, the button pressing part 114A may also be arranged at other positions other than the farthest stress point of the driving part pivoting button 114.

The driving part rotating disk 115 is provided with a rotating disk pivoting part 115B, such that the driving part rotating disk 115 can rotate around the rotating disk pivoting part 115B. In the embodiment shown in FIGS. 64 and 65, the rotating disk pivoting part 115B is a rotation hole. However, it should be understood, the rotating disk pivoting part 115B may also be a rotation shaft.

The driving part rotating disk 115 may be arranged in a shape of a disk as shown in FIGS. 64 and 65, and may also arranged in a shape of a polygon or other suitable shapes.

In order to enable the driving part pivoting button 114 and the driving part rotating disk 115 to rotate together, the button rotating part 114B of the driving part pivoting button 114 and the rotating disk pivoting part 115B of the driving part rotating disk 115 should be arranged to be corresponding to each other, such that the rotating axis of the driving part pivoting button 114 overlaps with the rotating axis of the driving part rotating disk 115, thereby realizing that the driving part pivoting button 114 and the driving part rotating disk 115 rotate around the same rotating axis.

In an embodiment, the driving part pivoting button 114 and the driving part 115 can be connected together. For example, the driving part pivoting button 114 may be provided with a button connecting part 114C, while the driving part rotating disk 115 may be provided with a rotating disk connecting part 115C, and the button connecting part 114C and the rotating disk connecting part 115C are connected to each other through a rotation connecting member 117.

In the embodiment shown in FIGS. 64 and 65, the button connecting part 114C may be a through hole, the rotating disk connecting part 115C may be a screwed hole, and the rotation connecting member 117 may be a screw. By making the rotation connecting member 117 pass through the button connecting part 114C and be threadedly connected to the rotating disk connecting part 115C, the driving part pivoting button 114 and the driving part rotating disk 115 are connected together.

Of course, the disclosure is not limited thereto.

In another embodiment, the driving part pivoting button 114 and the driving part rotating disk 115 can be connected together in other ways.

For example, the button connecting part 114C may be a through hole, the rotating disk connecting part 115C may be a screwed connecting pin passing through the through hole, and the rotation connecting member 117 may be a nut. After the connecting pin on the driving part rotating disk 115 passes through the through hole on the driving part pivoting button 114, by threadedly connecting the nut as the rotation connecting member 117 onto the connecting pin on the driving part rotating disk 115, the driving part pivoting button 114 and the driving part rotating disk 115 are connected together.

For another example, the driving part pivoting button 114 and the driving part rotating disk 115 can be connected together by being sleeved onto each other or in a rivet connection and the like.

In yet another embodiment, the driving part pivoting button 114 may be formed integrally with the driving part rotating disk 115. In such case, the driving part pivoting button 114 and be regarded as a part of the driving part rotating disk 115.

In another embodiment, the driving part pivoting button 114 and the driving part rotating disk 115 may not be connected together, instead, they are arranged to be abutting against each other together in the rotating direction, such that the rotation of one can drive the rotation of the other.

For example, the driving part pivoting button 114 may be arranged in a rod shape, and the driving part rotating disk 115 may be provided with an accommodation part for accommodate the rod-shaped driving part pivoting button 114, thereby realizing that they can rotate together.

As shown in FIG. 64, the pivoting part 100 includes an outer cover 120, a body member 130, and an inner cover 140. The outer cover 120 and the inner cover 140 together enclose a space, and the body member 130 is located in the space.

In the embodiment shown in FIG. 65, a circumferential wall of a base part 121 of the outer cover 120 may be provided with an outer cover notch 121A for the driving part pivoting button 114 to pass therethrough. The outer cover notch 121A extends along the circumferential direction of the base part 121 of the outer cover 120, such that the driving part pivoting button 114 is exposed from the pivoting part 100, so as to facilitate the user's operation thereto.

In addition, as shown in FIG. 65, in inner end wall of the outer cover 120 is provided with an outer cover pivoting part 125, and the outer cover pivoting part 125 cooperates with the button rotating part 114B of the driving part pivoting button 114 and the rotating disk pivoting part 115B of the driving part rotating disk 115, thereby allowing the driving part pivoting button 114 and the driving part rotating disk 115 to rotate around the outer cover pivoting part 125. In the embodiment shown in FIG. 65, the outer cover pivoting part 125 is a pivot shaft, and the button rotating part 114B and the rotating disk pivoting part 115B are rotation holes. However, it should be understood, when the button rotating part 114B or the rotating disk pivoting part 115B is a pivot shaft, the outer cover pivoting part 125 may also be a pivot hole.

Further, as shown in FIG. 65, an end of the outer cover pivoting part 125 may be provided a pivoting part obstructing member 126 to prevent the driving part pivoting button 114 and the driving part rotating disk 115 from being separated from the outer cover pivoting part 125. The pivoting part obstructing member 126 may be, for example, a screw threadedly connected to the end of the outer cover pivoting part 125, or a pin laterally inserted into the end of the outer cover pivoting part 125.

Next, the driving part moving member 116 will be described in detail.

The driving part moving member 116 may be arranged in a disk shape as shown in FIGS. 64 and 65, or may be arranged in a polygonal shape or other suitable shapes.

The driving part moving member 116 may be arranged between the driving part rotating disk 115 and the engaging member 150. On the one hand, the driving part moving member 116 is pushed by the driving part rotating disk 115 to move, and on the other hand, the driving part moving member 116 drives the engaging member 150 to be separated from being engaged with the first engaging slot 170 or the second engaging slot 144.

In order to make rotation of the driving part rotating disk 115 drive the driving part moving member 116 to move, the driving part rotating disk 115 is provided with a rotating disk pushing inclined body 115A, and the driving part moving member 116 is provided with a moving member pushing inclined body 116A. Moreover, the rotating disk pushing inclined body 115A and the moving member pushing inclined body 116A are arranged to be able to interact with each other, such that when the driving part rotating disk 115 rotates, by the rotating disk pushing inclined body 115A pushing the moving member pushing inclined body 116A, the driving part moving member 116 moves and drives the engaging member 150.

In an embodiment, the rotating disk pushing inclined body 115A on the driving part rotating disk 115 may be a protuberance or a recessed part arranged on a side surface of the driving part rotating disk 115. The rotating disk pushing inclined body 115A may be arranged to be inclined to the side surface of the driving part rotating disk 115 along a rotating direction of the driving part rotating disk 115. Specifically, the distance between the rotating disk pushing inclined body 115A and the side surface where it is located gradually increases or decreases from one side of the rotating disk pushing inclined body 115A toward the other side along the rotating direction, resulting in that the rotating disk pushing inclined body 115A is inclined to the side surface where it is located, and inclined to the moving direction of the driving part moving member 116.

Correspondingly, the moving member pushing inclined body 116A on the driving part moving member 116 may be a protuberance or a recessed part arranged on the side surface of the driving part moving member 116, and its position is corresponding to that of the rotating disk pushing inclined body 115A. The moving member pushing inclined body 116A may be arranged to be inclined to the side surface of the moving member pushing inclined body 116A along the of the rotating direction driving part rotating disk 115. Specifically, the distance between the moving member pushing inclined body 116A and the side surface where it is located gradually increases or decreases from one side of the moving member pushing inclined body 116A toward the other side along the rotating direction of the driving part rotating disk 115, resulting in that the moving member pushing inclined body 116A is inclined to the side surface where it is located, and inclined to the moving direction of the driving part moving member 116.

Due to such structure, when the driving part rotating disk 115 rotates, the rotating disk pushing inclined body 115A can push the moving member pushing inclined body 116A abutting against it, such that the driving part moving member 116 moves in a direction perpendicular to the pivoting direction of the driving part rotating disk 115, thus the driving part moving member 116 drives the engaging member 150.

Either of the rotating disk pushing inclined body 115A and the moving member pushing inclined body 116A may be provided by one or more, so as to form one or more groups cooperating with each other. In the embodiment shown in FIGS. 64 and 65, the rotating disk pushing inclined body 115A and the moving member pushing inclined body 116A are arranged in three groups cooperating with each other. by arranging the rotating disk pushing inclined body 115A and the moving member pushing inclined body 116A in a plurality of groups which are cooperating with each other, the driving part moving member 116 can be driven more smoothly.

In order to achieve a better effect for the driving part moving member 116 to drive the engaging member 150, the driving part moving member 116 may be provided with at least one moving member push bar 116B, and the moving member push bar 116B may be in a shape of a straight rod and abut against the engaging member 150, such that once the moving member push bar 116B moves, it will drive the engaging member 150.

In the embodiment shown in FIGS. 64 and 65, the moving member push bar 116B extends along a direction parallel to the movement of the engaging member 150 or parallel to the connecting shaft 180, thereby driving the engaging member 150 better. Of course, it should be understood, the moving member push bar 116B may extend in a direction inclined to the movement of the engaging member 150.

In addition, the moving member push bar 116B of the driving part moving member 116 may pass through the body member 130 and the inner cover 140 to abut against the engaging member 150.

In order to facilitate the moving member push bar 116B to pass through the body member 130, the body member 130 is provided with a hole 134 corresponding to the moving member push bar 116B (see FIGS. 64 and 65).

In order to prevent the moving member push bar 116B from withdrawing from the hole 134 of the body member 130, resulting in an accidental separation of the driving part moving member 116 from the body member 130, in the embodiment shown in FIGS. 64 and 65, an end of the moving member push bar 116B abutting against the engaging member 150 may be provided with a push bar obstructing hook 116B1, and the push bar obstructing hook 116B1 is arranged to be able to be obstructed by a hole wall of the hole 134 and cannot exit the hole 134 after passing through the hole 134 of the body member 130.

In addition, the push bar obstructing hook 116B1 can also limit a moving stroke of the moving member push bar 116B.

In an embodiment, the hole 134 of the body member 130 is not exactly aligned with the push bar obstructing hook 116B1 of the moving member push bar 116B. Thus, when the push bar obstructing hook 116B1 passes through the hole 134 of the body member 130, the moving member push bar 116B will be elastically deformed; and after the push bar obstructing hook 116B1 passes through the hole 134 of the body member 130, the moving member push bar 116B elastically returns to its original position, so the hole wall of the hole 134 of the body member 130 will obstruct the push bar obstructing hook 116B1 from withdrawing from the hole 134 of the body member 130. Therefore, the push bar obstructing hook 116B1 can prevent the driving part moving member 116 from being accidentally separated from the body member 130.

When it is necessary to detach the driving part moving member 116 from the body member 130, the user only needs to exert a force to the push bar obstructing hook 116B1, so as to force the moving member push bar 116B to be elastically deformed, and when the push bar obstructing hook 116B1 is aligned with the hole 134 of the body member 130, the push bar obstructing hook 116B1 can be withdrawn from the hole 134, thereby realizing separation of the driving part moving member 116 from the body member 130.

Afterward, the working process of the driving part 110″ including the driving part pivoting button 114, the driving part rotating disk 115 and the driving part moving member 116 will be described in detail.

When the driving part 110″ is not actuated, the engaging member 150 is engaged with the first engaging slot 170 and the second engaging slot 144 at the same time as shown in FIG. 5, such that the pivoting part 100 is locked to one of the pivoted positions (e.g., the storage position shown in FIGS. 46 to 49) in respect with the carrying body 300 and cannot be pivoted around the connecting shaft 180.

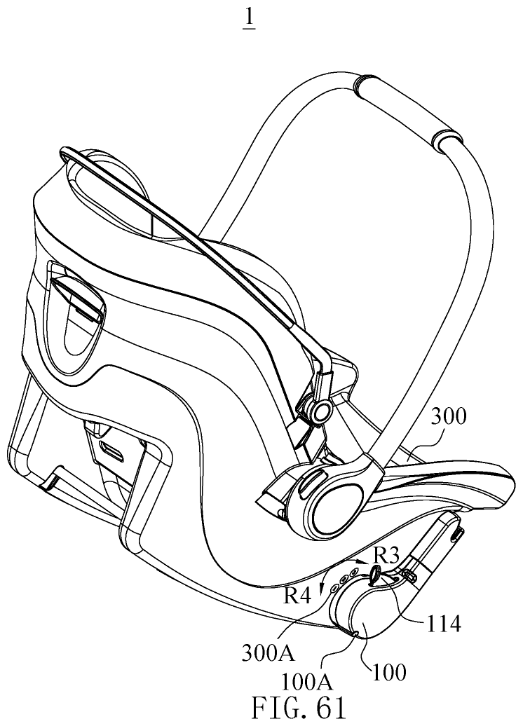

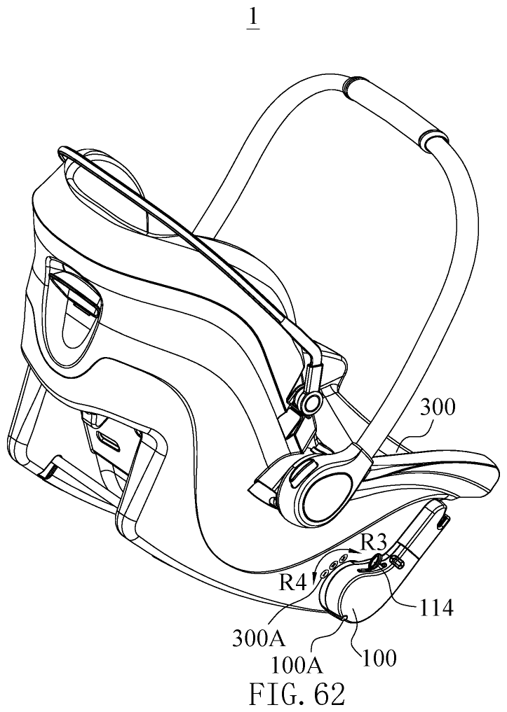

When it is necessary to make the pivoting part 100 be pivoted from the storage position or a certain working position to another working position toward the third pivoting direction R3, the user may exert an external force to the driving part pivoting button 114 to rotate it, the driving part pivoting button 114 rotates from a button initial position shown in FIGS. 60 and 61 toward the third pivoting direction R3 to a button termination position shown in FIG. 62, and brings the driving part rotating disk 115 to rotate together toward the third pivoting direction R3. Then, in the process that the driving part rotating disk 115 rotates toward the third pivoting direction R3, the rotating disk pushing inclined body 115A thereon will push the moving member pushing inclined body 116A on the driving part moving member 116, such that the driving part moving member 116 moves in a direction perpendicular to the rotating direction, thus the driving part moving member 116 drives the engaging member 150 to move toward a direction of separating from the second engaging slot 144.

When the engaging member 150 is completely separated from the second engaging slot 144, the pivoting part 100 is unlocked and can be pivoted around the connecting shaft 180. Then, under action of the external force exerted by the user in the same direction, the pivoting part 100 is also pivoted toward the third pivoting direction R3 (see FIGS. 60 to 62), until the pivoting part 100 reaches the required pivoted angle (i.e., another working position).

Afterward, the user can release the actuation of the driving part 110″, the user no longer exerts external force to the driving part pivoting button 114, and the engaging member 150 is engaged again with the first engaging slot 170 and the second engaging slot 144 at the same time under action of the reset member 160 (see FIGS. 2, 3, 5, 6 and 8), thereby locking the pivoting part 100 at the pivoted angle. Meanwhile, the driving part pivoting button 114 will also be pivoted toward the fourth pivoting direction R4 (see FIGS. 60 to 62) for example due to the force of the reset member 160, thereby returning to the initial position (this process will be described below).

Thus, in the case that the third embodiment of the driving part 110″ according to the disclosure is adopted, the user only needs to exert an external force in the same direction to the driving part pivoting button 114 of the driving part 110″, for example, with his thumb, he can not only make the driving part pivoting button 114 rotate to unlock the pivoting part 100, but also make the pivoting part 100 be pivoted toward the third pivoting direction R3, thereby greatly facilitating the user's operation.

When it is necessary to make the pivoting part 100 be pivoted from a certain working position to another working position or storage position toward the fourth pivoting direction R4, the user may similarly exert an external force to the driving part pivoting button 114 for rotating it, and the driving part pivoting button 114 is pivoted toward the third pivoting direction R3, until the pivoting part 100 is unlocked and can be pivoted around the connecting shaft 180. Afterward, the user exerts an external force in the opposite direction to the pivoting part 100, such that the pivoting part 100 is pivoted toward the fourth pivoting direction R4, until the pivoting part 100 reaches the required pivoted angle (i.e., another working position or storage position). In this process, the user can press the driving part pivoting button 114 with the thumb of one hand to make it be pivoted toward the third pivoting direction R3, so as to unlock the pivoting part 100, and then use the remaining fingers to pluck the pivoting part 100 to make it be pivoted toward the fourth pivoting direction R4, thereby completing the operation of making the pivoting part 100 be pivoted by using one hand, which is also convenient for the user to operate.

In another embodiment, the driving part pivoting button 114 may be arranged not to rotate toward the third pivoting direction R3 to unlock the pivoting part 100, but to rotate toward the fourth pivoting direction R4 to unlock the pivoting part 100. n such embodiment, the rotating disk pushing inclined body 115A on the driving part rotating disk 115 and the moving member pushing inclined body 116A on the driving part moving member 116 may be arranged such that in the process for the driving part rotating disk 115 to rotate toward the fourth pivoting direction R4, its rotating disk pushing inclined body 115A can push the moving member pushing inclined body 116A, thus driving the driving part moving member 116 to move in a direction perpendicular to the rotating direction.

Correspondingly, the driving part pivoting button 114 can be provided with a pulling flange (not shown), so as to facilitate the user to pull the driving part pivoting button 114 to be pivoted toward the fourth pivoting direction R4.

In another embodiment mentioned above, the user only needs to exert an external force on the driving part pivoting button 114of the driving part 110″ in the same direction, then not only the driving part pivoting button 114 can rotate to unlock the pivoting part 100, but also the pivoting part 100 can be pivoted toward the fourth pivoting direction R4, which also greatly facilitate the user's operation.

After the pivoting part 100 reaches the required pivoted angle, the user will no longer exerts external force to the driving part pivoting button 114. At this time, the driving part pivoting button 114 will return to the initial position under action of the previously described reset member 160.

Specifically, when the user no longer exerts external force to the driving part pivoting button 114, the restoring force of the reset member 160 will force the engaging member 150 to move toward the second engaging slot 144 and is engaged with the second engaging slot 144, thereby locking the pivoting part 100 at the pivoted angle. In this process, the engaging member 150 will drive the driving part moving member 116 abutting against it to move toward the driving part rotating disk 115. Then, the moving member pushing inclined body 116A on the driving part moving member 116 will push the rotating disk pushing inclined body 115A on the driving part rotating disk 115 in turn, whereby making the driving part rotating disk 115 rotate toward the fourth pivoting direction R4 (see FIGS. 60 to 62) to return to the initial position.

In another embodiment, the driving part 110″ may be provided with a driving part reset member (not shown). When the driving part pivoting button 114 is not acted by external force, the driving part reset member will drive the driving part pivoting button 114 back to the initial position. The driving part reset member may adopt a torsion spring arranged around the button rotating part 114B of the driving part pivoting button 114, or adopt another elastomer such as a spring or a tension spring which can exert elastic force to the driving part pivoting button 114.

In the case that the carrier 1 has two pivoting parts 100, the two pivoting parts 100 are respectively coupled to both ends of the connecting shaft 180, and a driving part 110″ can be respectively arranged at each of the two pivoting parts 100, as shown in FIGS. 60 to 65.

Of course, it should be understood, the connecting shaft 180 may not be arranged between the two pivoting parts 100, thus, after the two pivoting parts 100 are unlocked by the driving part 110′, the two pivoting parts 100 can be pivoted independently to each other.

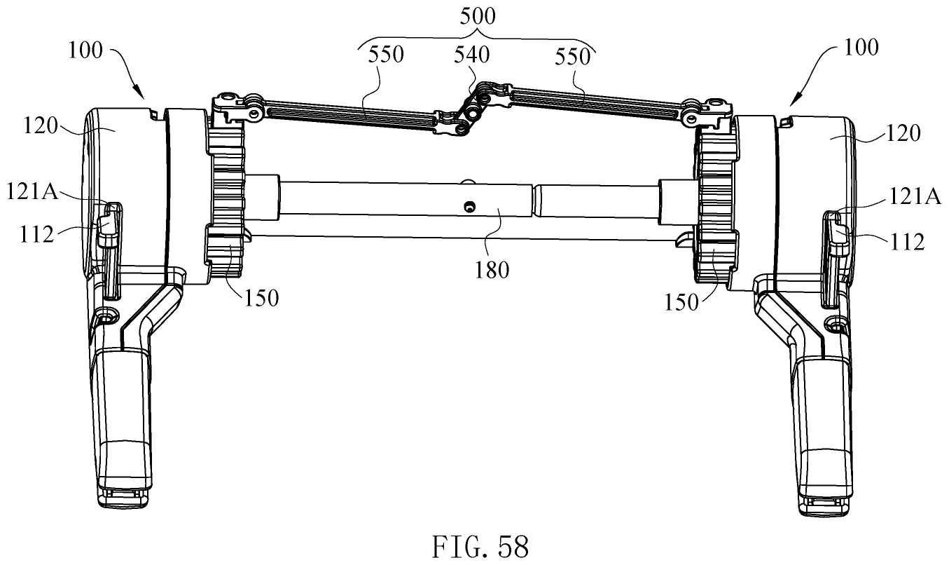

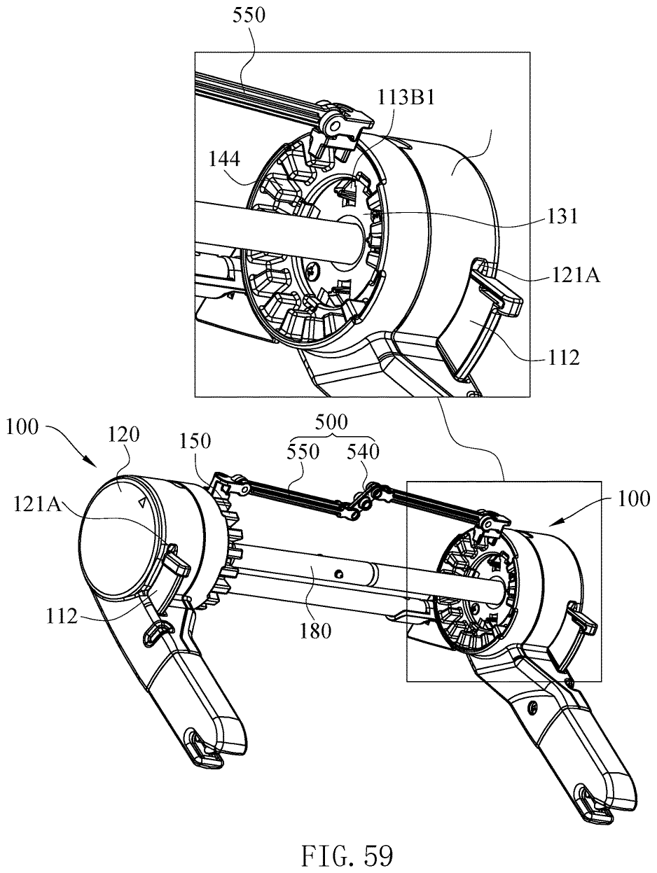

In addition, as shown in FIGS. 58 and 59, the carrier 1 may include a synchronous unlocking assembly 500 (described below) constituted by a hinged structure 540 and two third link rods 550, such that the two engaging members 150 can be linked-moving with each other.

### Synchronous Link Rod Assembly

Referring to FIG. 7, in an embodiment, the carrier 1 include a synchronous link rod assembly 200. The synchronous link rod assembly 200 can replace the connecting shaft 180 for connecting the two pivoting parts 100. The synchronous link rod assembly 200 serves to make the two pivoting parts 100 be pivoted synchronously, and make two engaging members 150 be linked-moving with each other.

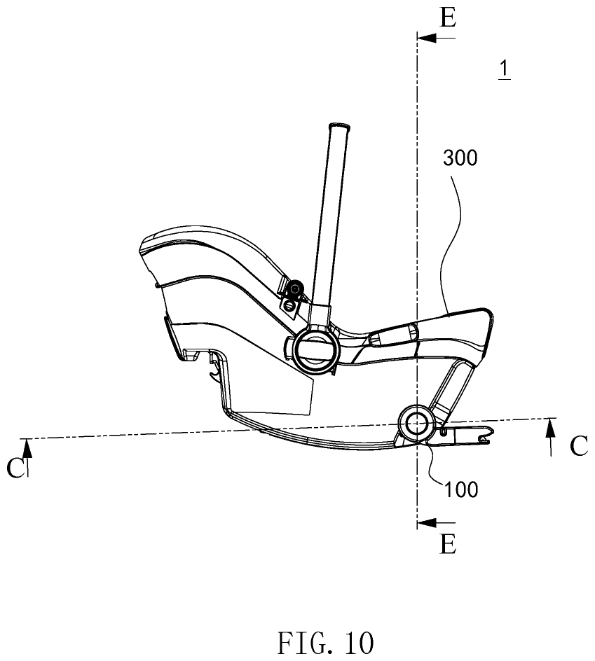

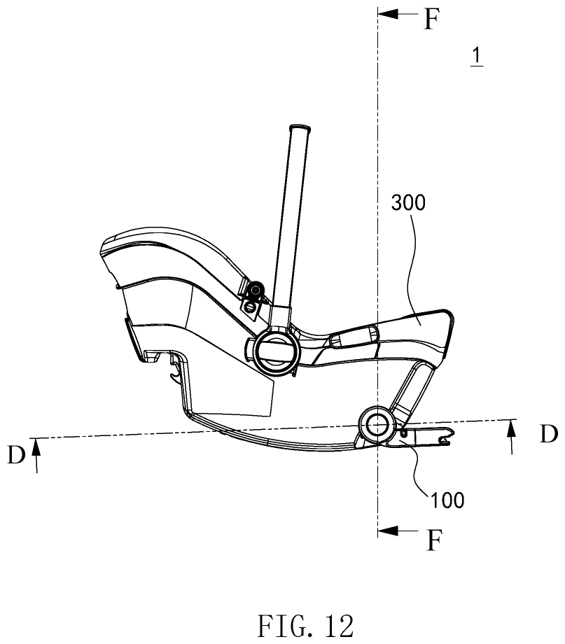

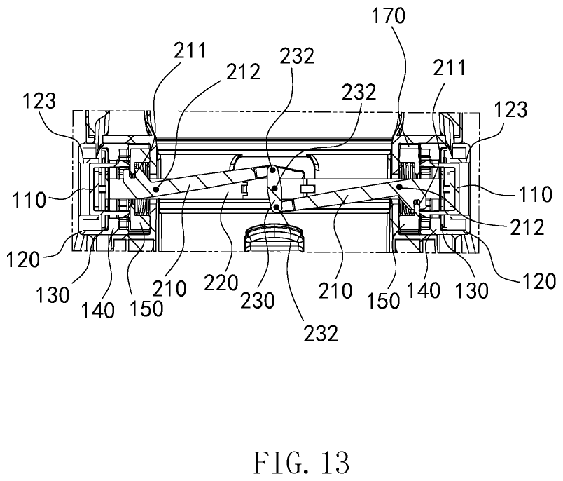

Referring to FIGS. 8 to 15, the synchronous link rod assembly 200 may include: a hinge member 230, with a middle part thereof pivotably arranged on the carrying body 300; two first link rods 210, with one ends thereof respectively pivotably connected to two ends of the hinge member 230, and the other ends thereof respectively coupled to the two engaging members 150; and a second link rod 220, with both ends thereof respectively coupled to the two body members 130.

The hinge member 230 may be formed as a sheet. The hinge member 230 can make inner ends of the two first link rods 210 be hinged together to form a linkage.

Each of the first link rods 210 may have a bent shape. Thus, the first link rods 210 can be conveniently connected to the second link rod 220 and the hinge member 230 at the same time, and can convert pivoting of the hinge member 230 into a linear motion of the first link rods 210. The two first link rods 210 are arranged central symmetrically about the pivot shaft of the hinge member 230.

An end of each of the first link rods 210 away from the hinge member 230 may have an engaging part 211, and the engaging parts 211 are engaged with the engaging members 150. The end of each of the first link rods 210 away from the hinge member 230 passes through the accommodation slot 310 of the carrying body 300 and the centre holes 152 of the engaging members 150.

In an embodiment, the engaging part 211 is formed as a notch, and the notch 211 can engage the engaging members 150.

Specifically, the engaging parts 211 of the first link rods 210 can engage the outer ends of the centre holes 152, such that the outer ends of the first link rods 210 are coupled to the engaging members 150.

Alternatively, the first link rods 210 may be coupled to the engaging members 150 by rivet, screws or other connectors.

Thus, when the engaging member 150 on one side of the carrying body 300 moves (e.g., moves in the lateral direction of the carrier 1), the movement is transmitted to the engaging member 150 on the other side of the carrying body 300 via one of the first link rods 210, the hinge member 230, and the other of the first link rods 210, such that the two engaging members 150 on both sides of the carrying body 300 are moved in opposite directions. In the disclosure, since the first link rods 210 is arranged central symmetrically about the pivot shaft of the hinge member 230, the two engaging members 150 on both sides move same distance in opposite directions. Therefore, in an embodiment, only one engaging member 150 needs to be actuated to unlock the two pivoting parts 100 at the same time.

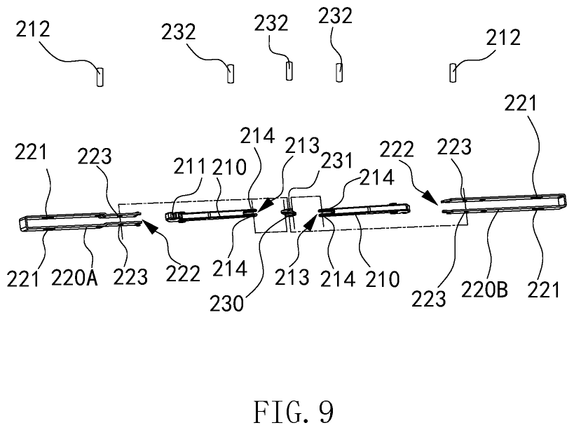

Referring to FIG. 9, the second link rod 220 may include a first part 220A and a second part 220B. The first part 220A and the second part 220B are symmetrical to each other, and can be connected together. Alternatively, the second link rod 220 may be integrally formed. The first part 220A and the second part 220B may be respectively formed for example, in a shape of a frame. Specifically, the frame may be a rectangular frame in lack of one side.

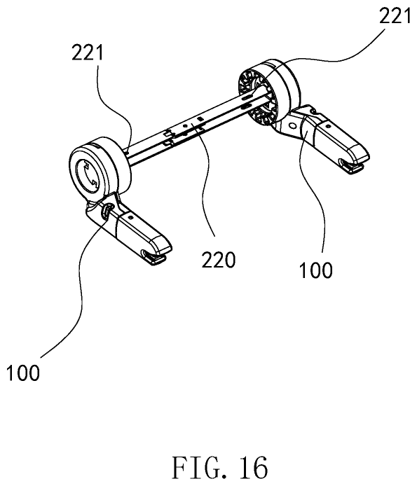

Referring to FIGS. 9 and 16, the second link rod 220 may be provided with a chute 221. The chute 221 may be formed in a long shape along a length direction of the second link rod 220. The first link rods 210 each can be confined in the chute 221 via a latch 212, such that the chute 221 can guide the movement of the first link rods 210. Since the second link rod 220 is formed as a frame, upper and lower parts of the second link rod 220 may be respectively formed with one chute 221 whose positions are aligned with each other. In an embodiment of the disclosure, since the second link rod 220 can be arranged along the lateral direction of the carrier 1, and the chutes 221 each can be formed in a long shape along the length direction of the second link rod 220, the chutes 221 of the second link rod 220 can guide the first link rods 210 to move along the lateral direction of the carrier 1. In an embodiment, the first part 220A and the second part 220B are respectively provided with a chute 221, the two first link rods 210 are respectively confined in the chutes 221 on the first part 220A and the second part 220B via the latches 212.

In an embodiment, the chutes 221 may be arranged at other positions, for example, on the carrying body 300, as long as the chutes 221 are arranged to enable the first link rods 210 to bring the engaging members 150 to move linearly.

Referring to FIG. 9, each of the first part 220A and the second part 220B may be formed into a rectangular frame similar to the letter “C.” In other words, the shape of each of the first part 220A and the second part 220B has three sides in a rectangle, and lacks the fourth side in the rectangle, thereby forming an open end 222.

In an embodiment, both the first part 220A and the second part 220B may be formed by bending a plate material, but the disclosure is not limited thereto.

One of the first part 220A and the second part 220B may be narrowed inward at a position adjacent to its open end 222, so as to allow the open ends 222 of the first part 220A and the second part 220B to be inserted into each other.

In an embodiment, as shown in FIG. 9, the first part 220A is narrowed inward at a position adjacent to the open end 222.

Alternatively, in an embodiment, the second part 220B is narrowed inward at a position adjacent to the open end 222.

Both the first part 220A and the second part 220B may be formed with a perforation 223. Specifically, each of the first part 220A and the second part 220B may be formed with two perforations 223 whose positions are aligned with each other.

Similarly, each first link rod 210 may be formed with two perforations 214 whose positions are aligned with each other.

The center and two ends of the hinge member 230 may be respectively formed with perforations 231.

The perforation 231 at the center of the hinge member 230, the perforations 223 of the first part 220A and the perforations 223 of the second part 220B are pivotally connected via a connecting pin 232.

The perforations 231 at two ends of the hinge member 230 are pivotally connected to the perforations 214 on the two first link rods 210 via a connecting pin 232.

The second link rod 220 subsequently passes through the first engaging slot 170 of the carrying body 300, the centre holes 152 of the engaging members 150, the centre hole 143of the inner cover 140, and is finally engaged to the centre hole 133 of the body member 130.

Referring to FIGS. 9, 14 and 15, the second link rod 220 may be formed as a frame structure, and at least a part of the first link rods 210 may be arranged inside the second link rod 220, thereby saving the space required for the synchronous link rod assembly 200.

The two ends of the second link rod 220 may be connected to the two body members 130 (e.g., by rivets, screws, or welding), such that the two body members 130 on both sides of the carrying body 300 can be synchronously pivoted, thereby bringing the two pivoting parts 100 to be synchronously pivoted.

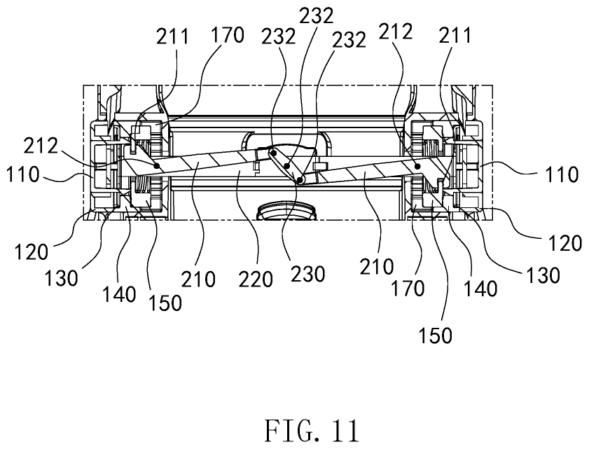

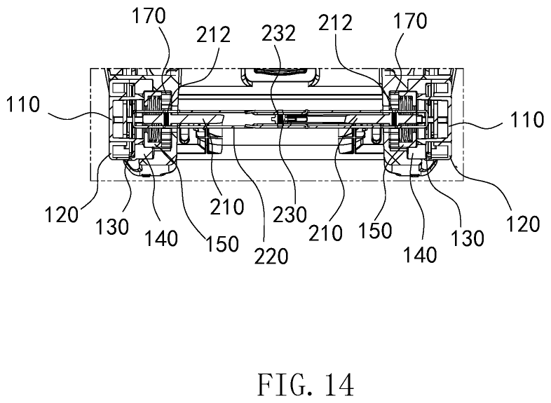

Referring to FIGS. 11 and 14, when the driving parts 110 are not actuated, the engaging members 150 are engaged with the first engaging slots 170 and the second engaging slots 144 at the same time, such that the pivoting part 100 is fixed to the carrying body 300 and cannot be pivoted.

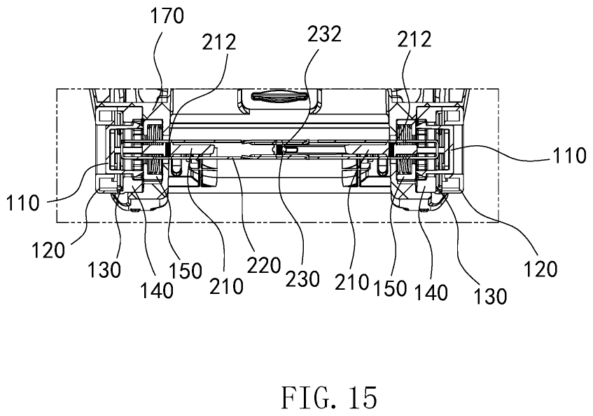

In an embodiment, referring to FIGS. 11 and 15, when one driving part 110 on one side of the carrying body 300 is actuated (e.g., the driving part 110 is pressed), the buckle part 111 of the driving part 110 may actuate the engaging member 150 on the same side to move toward the direction of being separated from the second engaging slot 144. The movement of the engaging member 150 brings the first link rod 210 on the same side to move, and the movement of the first link rod 210 causes the hinge member 230 to be pivoted, and the pivoting of the hinge member 230 brings the other first link rod 210 to move in the opposite direction, such that the engaging member 150 on the other side of the carrying body 300 moves toward the direction of being separated from the corresponding first engaging slot 170 and/or the second engaging slot 144. In this embodiment, the driving part 110 may be, for example, formed as a button.

In an embodiment, when one driving part 110 on one side of the carrying body 300 is actuated (e.g., the driving part 110 is pulled out), the driving part 110 may actuate the engaging member 150 on the same side to move toward the direction of being separated from the first engaging slot 170 on the same side (e.g., an end of the driving part 110 is connected to the engaging members 150). The movement of the engaging member 150 brings the first link rod 210 on the same side to move, and the movement of the first link rod 210 causes the hinge member 230 to be pivoted, and the pivoting of the hinge member 230 brings the other first link rod 210 to move in the opposite direction, such that the engaging member 150 on the other side of the carrying body 300 moves toward the direction of being separated from the corresponding first engaging slot 170. In this embodiment, the driving part 110 may be, for example, formed as a pull handle or a pull ring.

Actuating the driving part 110 needs overcoming the restoring force of the reset member 160. When the engaging members 150 on both sides of the carrying body 300 are completely separated from the corresponding first engaging slots 170 and/or the second engaging slots 144, the pivoting parts 100 on both sides of the carrying body 300 can be pivoted synchronously. At this time, through the linkage of the second link rod 220, the pivoting parts 100 on both sides can be brought to be synchronously pivoted to a position suitable for the current configuration of the vehicle seat, so as to allow the carrier 1 according to the disclosure can adapt to different vehicle types. When the two pivoting parts 100 are pivoted the required angle, the actuation of one of the driving parts 110 may be released, such that the engaging members 150 on both sides of the carrying body 300 are engaged with the corresponding first engaging slots 170 and the second engaging slots 144 at the same time again, so as to avoid unexpected pivoting of the pivoting part 100. That is, the pivoting part 100 can be locked at a specific pivoted position after pivoting.

In this embodiment, only one driving part 110 needs to be actuated to realize unlocking of the two pivoting parts 100.

In an embodiment, the carrier 1 may be provided with the driving part 110 on one side, such that the number of the driving parts 110 can be saved and the cost can be reduced.

In an embodiment, the carrier 1 can be provided with driving parts 110 on both sides, such that the user can chose to drive the driving part 110 on which side for better operation convenience.

### First Embodiment of Synchronous Unlocking Assembly

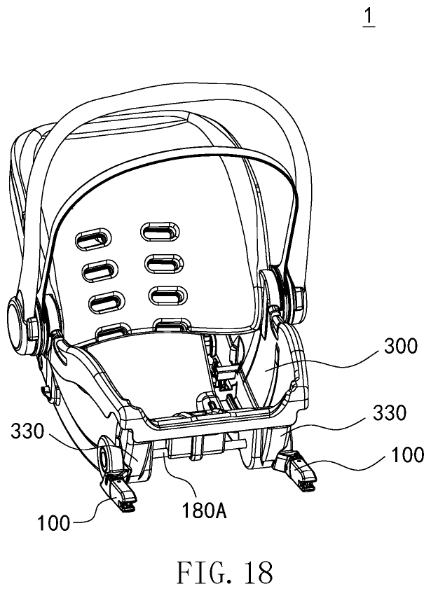

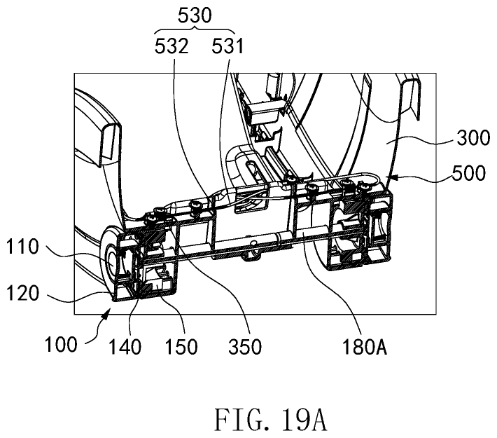

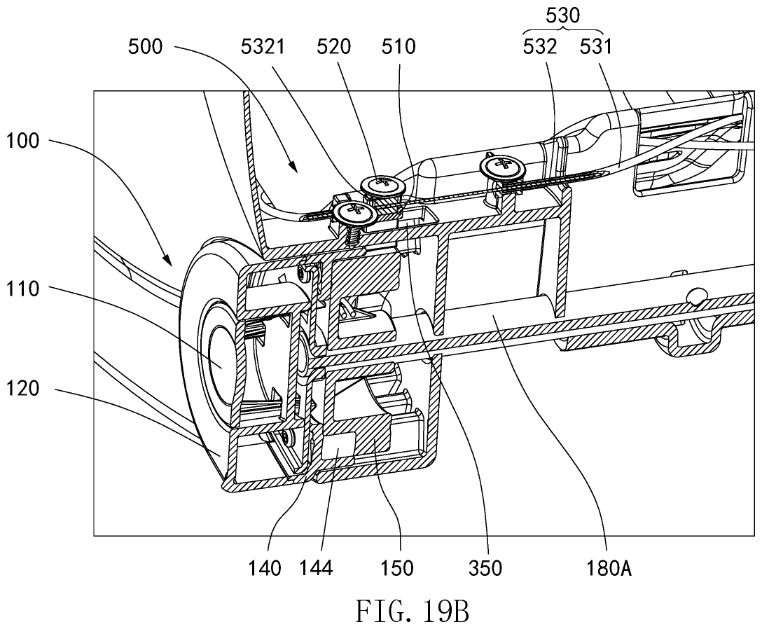

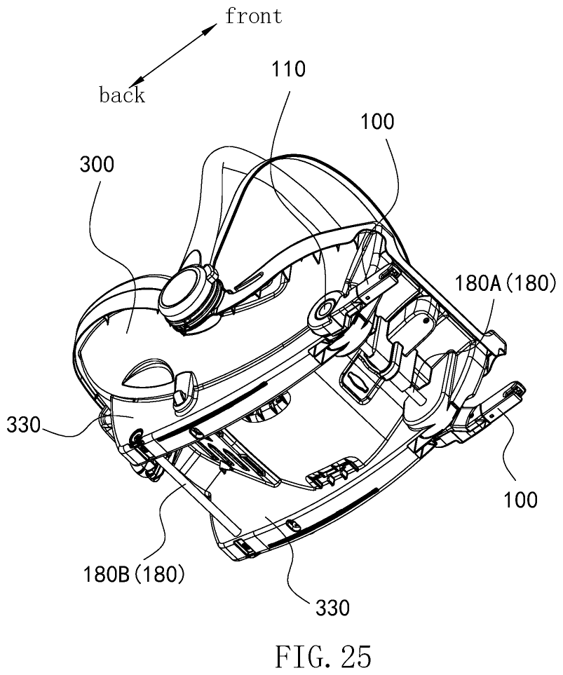

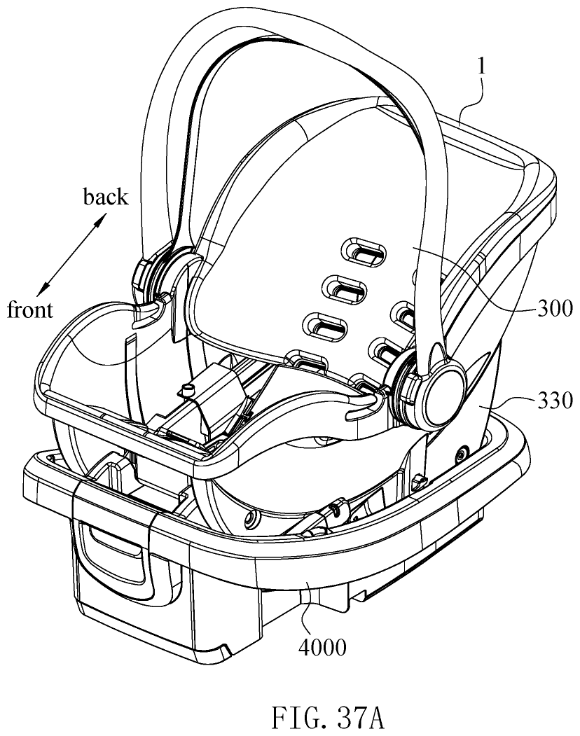

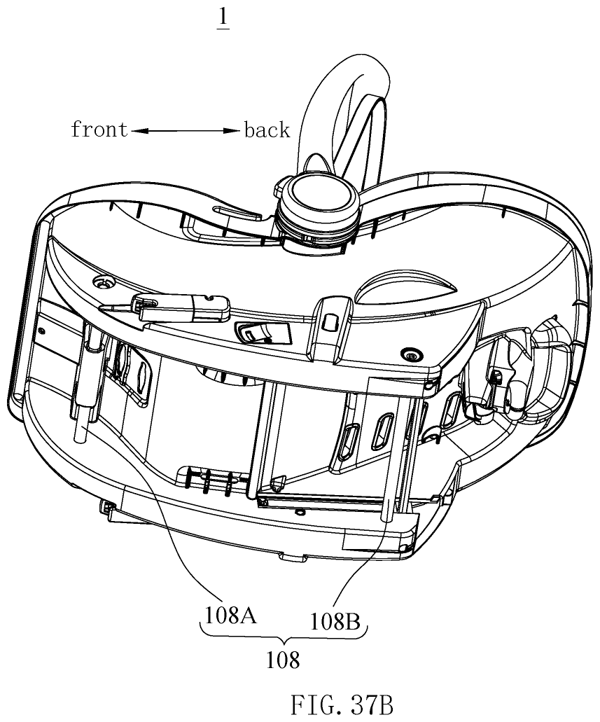

Referring to FIGS. 18 to 19A, in an embodiment, the carrier 1 may include a synchronous unlocking assembly 500. In this embodiment, the carrier 1 does not include the synchronous link rod assembly 200 as shown in FIG. 7, and instead, the carrier 1 includes two connecting shafts 180A, 180B. Referring to FIG. 25, a front connecting shaft 180A of the two connecting shafts 180A, 180B is used to connect the two pivoting parts 100. A rear connecting shaft 180B of the two connecting shafts 180A, 180B is used to connect the two side parts 330 at the bottom of the carrying body 300. Furthermore, the front connecting shaft 180A of the two connecting shafts 180A, 180B is used to make the two pivoting parts 100 to be pivoted synchronously, and the synchronous unlocking assembly 500 make the two engaging members 150 to be linked-moving with each other. The synchronous unlocking assembly 500 may be located substantially inside the carrying body 300. The two connecting shafts 180A, 180B can be selectively engaged with an additional base 4000 (see FIG. 37A, which will be described later).

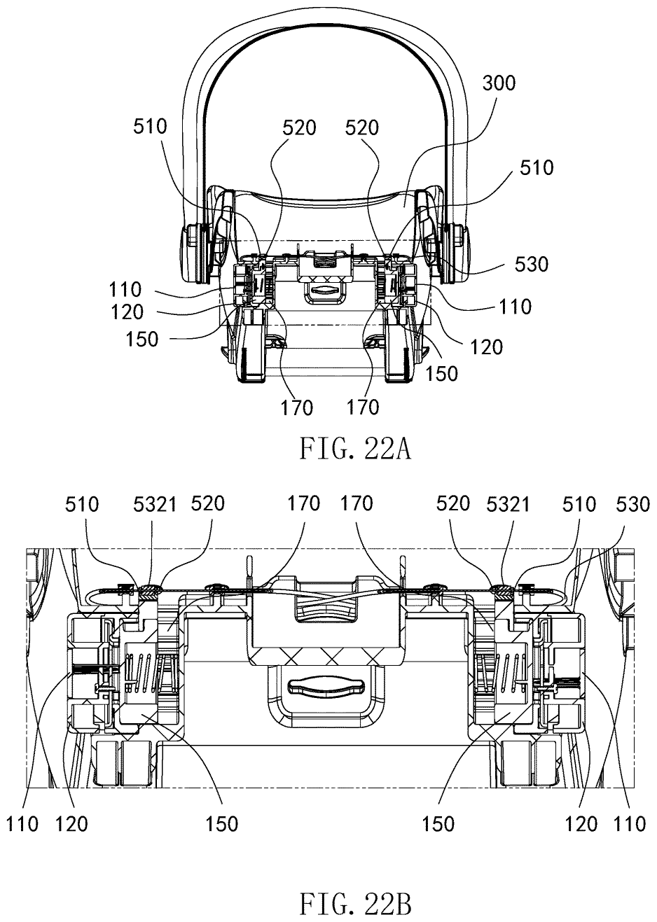

Referring to FIGS. 19B, 21B and 22B, the synchronous unlocking assembly 500 may include a fixed seat 510, a fixing member 520, and a wire component 530. Two fixed seats 510 may be respectively fixed to two engaging members 150 by two fixing members 520. The two fixing members 520 may respectively fix two parts of the wire component 530 to the two fixed seats 510, and each of the fixing members 520 passes through a corresponding fixed seat 510 to be fixed with a corresponding engaging member 150. Thus, the two parts of the wire component 530 respectively connected to the two engaging members 150 (be arranged in linkage). Alternatively, each of the fixed seats 510 is integrally formed with a corresponding engaging member 150. Alternatively, the fixed seats 510 and the engaging members 150 are formed separately. It can be understood, the wire component 530 can be connected to the engaging members 150 by other means. That is, the fixed seats 510 and the fixing members 520 may be replaced or omitted.

Referring to FIGS. 19A and 19B, the wire component 530 may include an outer jacket 531 and a core 532. The core 532 can slide in the outer jacket 531. The core 532 may be exposed outside the outer jacket 531 at two positions. The two fixing members 520 can respectively fix the parts of the core 532 at the above two positions (i.e., the two positions exposed outside the outer jacket 531) to the two fixed seats 510. That is, the parts of the core 532 exposed outside the outer jacket 531 at the above two positions are linked-moving with the two engaging members 150.

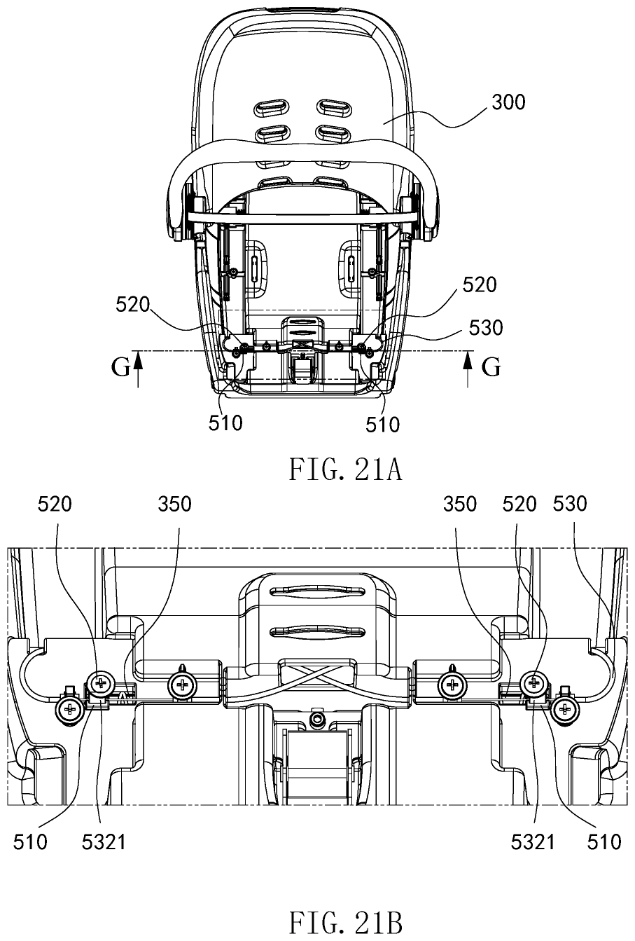

Referring to FIGS. 19B and 21B, in an embodiment, the core 532 may be a steel wire. The core 532 may include two steel wire heads 5321. The two steel wire heads 5321 may be exposed outside the outer jacket 531. The two steel wire heads 5321 can be respectively fixed on the two fixed seats 510 by the two fixing members 520, such that the motion of each of the fixed seats 510 can be transmitted to the core 532 via a corresponding steel wire head 5321.

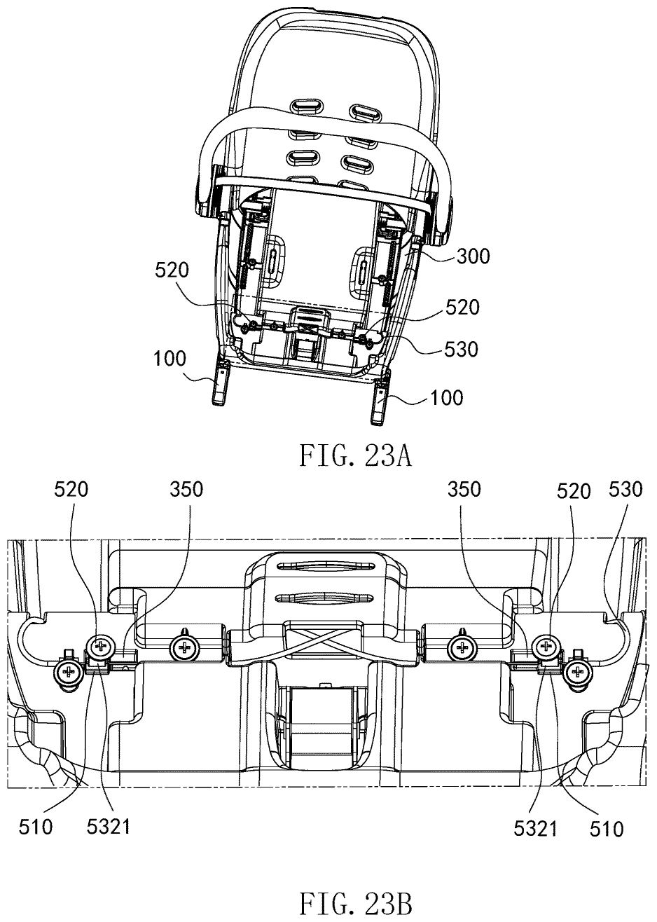

Referring to FIGS. 21A to 23B, the wire component 530 may be formed in a ring shape and bent into a shape of a number “8” (i.e., a part of said ring shape is twisted by 180°), but the disclosure is not limited thereto. Thus, the movement of one engaging member 150 in one direction is transmitted to the core 532, such that the core 532 slides in the outer jacket 531, and causes the other engaging member 150 to move in the opposite direction. It can be understood, the wire component 530 can be formed in other shapes, as long as after one engaging member 150 is actuated, the core 532 can bring the other engaging member 150 to move in the direction opposite to the moving direction of said one engaging member 150.

Referring to FIGS. 19B and 21B, the carrying body 300 may include two guide slots 350. The two fixed seats 510 may be located respectively in the two guide slots 350, such that each fixed seat 510 (and each fixing member 520 on the fixed seat 510) can move in a corresponding guide slot 350. The length of each guide slot 350 may be greater than or equal to a movable distance of the engaging members 150. The two guide slots 350 can respectively guide the moving directions of two groups of the fixed seats 510 and the fixing members 520, and further guide the two engaging members 150 to move in opposite directions. The fixing members 520 may be screws, but the disclosure is not limited thereto.

Referring to FIGS. 19A and 19B, after the driving part 110 on left side is actuated, the engaging member 150 on left side is pushed and separated from the second engaging slot 144 of the inner cover 140 of the pivoting part 100 on left side. At the same time, one part of the core 532 fixed on the engaging member 150 on left side brings the core 532 to move. This movement is transmitted to the engaging member 150 on right side through the core 532 (because the other part of the core 532 fixed on the engaging member 150 on right side). Therefore, the engaging member 150 on right side and the engaging member 150 on left side will move synchronously in opposite directions. After the driving part 110 on right side is actuated, the above members will move in opposite directions. Thus, by actuating one driving part 110, the pivoting parts 100 on both sides can be unlocked synchronously, thereby simplifying the operation of the carrier 1.

Referring to FIGS. 19A and 19B, in this embodiment, the gear adjustment structure 400 may include two driving parts 110, and the two driving parts 110 are movably arranged in the two pivoting parts 100, but the disclosure is not limited thereto. In other embodiments, the gear adjustment structure 400 may only include one driving part 110, and the one driving part 110 is movably arranged in one of the two pivoting parts 100. By actuating the one driving part 110 through the synchronous unlocking assembly 500, the pivoting parts 100 on both sides can be synchronously unlocked.

The outer jacket 531 can make the wire component 530 have a fixed shape when the core 532 moves. The outer jacket 531 may be flexible and made of metal or plastic, but the disclosure is not limited thereto.

The core 532 can slide and change shape in a rigid outer jacket 531. The core 532 may be flexible and made of metal, specifically, made of stainless steel, but the disclosure is not limited thereto.

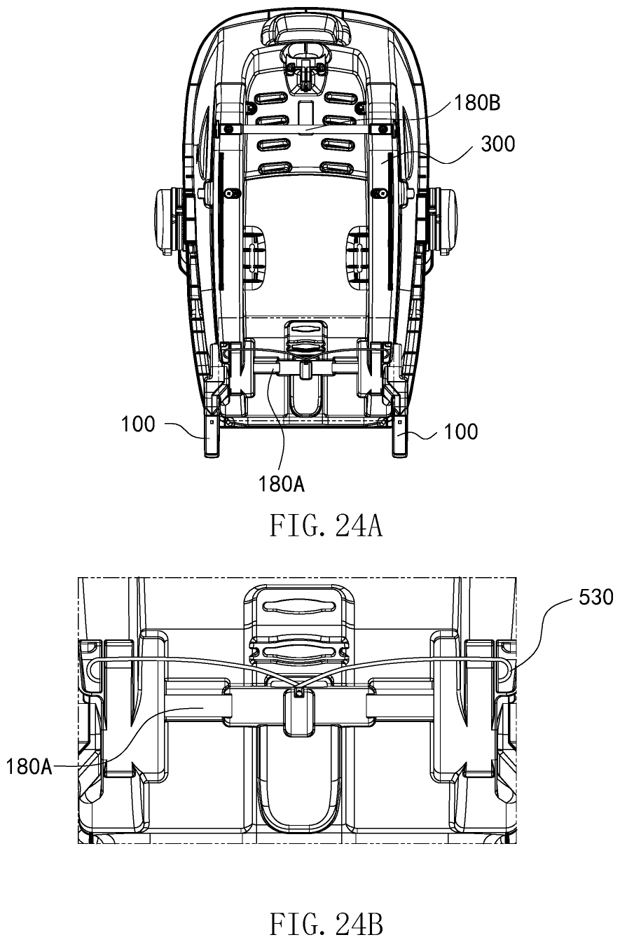

Referring to FIGS. 24A to 25, compared with other embodiments, in this embodiment, since the mechanism of the synchronous unlocking assembly 500 is relatively simplified and occupies less volume, most of the synchronous unlocking assembly 500 can be accommodated in the interior of the carrying body 300, and the wire component 530 of the synchronous unlocking assembly 500 cannot be seen or can only be seen less from below the carrier 1, and even if a small part of the wire component 530 is exposed outside the carrying body 300, it can be covered with a seat cloth, which improves the overall aesthetics of the carrier 1.

In the above embodiment, the wire component 530 is a single member. However, the disclosure is not limited thereto.

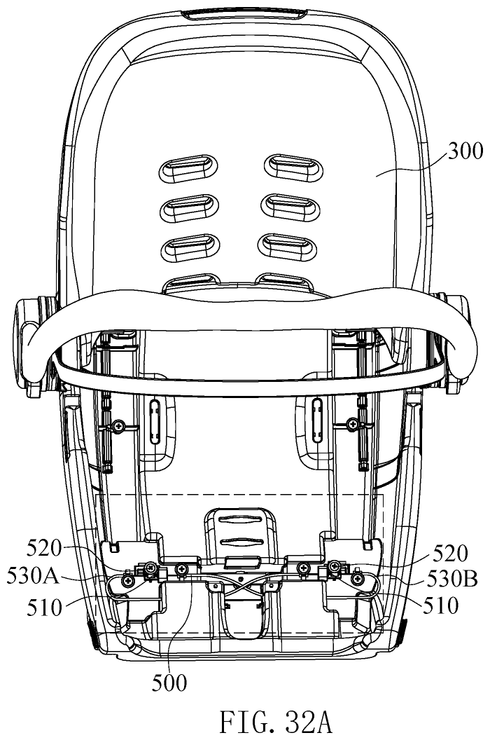

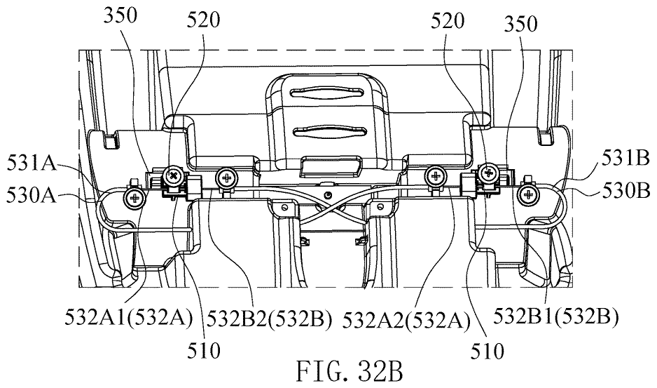

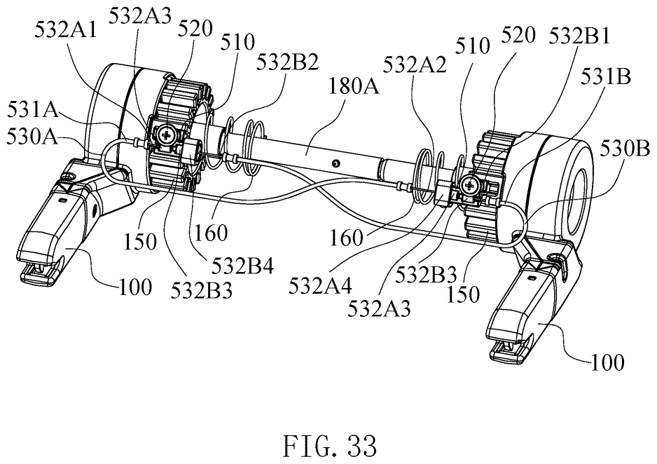

In another embodiment as shown in FIGS. 32A to 33, the wire component 530 may include a first wire component 530A and a second wire component 530B. That is, the wire component 530 may be constituted by two members.

Specifically, as shown in FIGS. 32B and 33, the first wire component 530A includes a first outer jacket 531A and a first core 532A slidably arranged inside the first outer jacket 531A. The first core 532A has two first exposed parts 532A1, 532A2 exposed outside the first outer jacket 531A.

Moreover, the first outer jacket 531A is arranged as not to move following the first core 532A. For example, the first outer jacket 531A may be partially or completely fixed to the carrying body 300. In an embodiment, the end of the first outer jacket 531A which exposes the two first exposed parts 532A1, 532A2 is fixed to the carrying body 300.

Similarly, the second wire component 530B includes a second outer jacket 531B and a second core 532B slidably arranged inside the second outer jacket 531B. The second core 532B has two second exposed parts 532B1, 532B2 exposed outside the second outer jacket 531B.

Moreover, the second outer jacket 531B is arranged as not to move following the second core 532B. For example, the second outer jacket 531B may be partially or completely fixed to the carrying body 300. In an embodiment, the end of the second outer jacket 531B which exposes the two second exposed parts 532B1, 532B2 is fixed to the carrying body 300.

Of course, the disclosure is not limited thereto, and the wire component 530 may take other forms. For example, the wire component 530 may only have a core, and at least one wire component guide structure (not shown) such as a guide groove, a guide hook, or a guide ring and the like is arranged on the carrying body 300, furthermore, the wire component guide structure is arranged to guide the movement of the wire component 530, such that the two ends of the wire component 530 move toward opposite directions.

In the embodiment shown in FIGS. 32B and 33, the two first exposed parts 532A1, 532A2 are respectively fixed to the two fixed seats 510 by the two fixing members 520, and the two second exposed parts 532B1, 532B2 are also respectively fixed to the two fixed seats 510 by the two fixing members 520. Since the fixed seats 510 are arranged on the engaging members 150, the movements of the first core 532A and the second core 532B will be respectively transmitted to the two engaging members 150 via the two fixed seats 510, thereby bringing the two engaging members 150 to move toward opposite directions.

As described previously, the fixed seats 510 may be integrally formed with the engaging members 150 or separately formed. In the case that the fixed seats 510 and the engaging members 150 are formed separately, the two fixing members 520 may respectively fix the two fixed seats 510 to the two engaging members 150.

In order to facilitate fixing the first core 532A and the second core 532B to the two fixed seats 510, referring to FIG. 33, at least one of the two first exposed parts 532A1, 532A2 may be provided with a first steel wire head 532A3. The first steel wire head 532A3 may be fixed to one of the fixed seats 510 by a corresponding fixing member 520 (see the first steel wire head 532A3 on left side in FIG. 33), or alternatively, the first steel wire head 532A3 may be fixed to one of the fixed seats 510 by a first steel wire head connecting member 532A4 (see the first steel wire head 532A3 on right side in FIG. 33). The first steel wire head connecting member 532A4 may be sleeve-shaped, as shown in FIG. 33, and fixes the first steel wire head connecting member 532A4 and the fixed seats 510 by sleeving them together. It should be understood, the first steel wire head connecting member 532A4 may take other structures, as long as it can fix the first steel wire head connecting member 532A4 and the fixed seats 510 together.

At least one of the two second exposed parts 532B1, 532B2 may also be provided with a second steel wire head 532B3. The second steel wire head 532B3 may be fixed to one of the fixed seats 510 by a corresponding fixing members 520 (see the second steel wire head 532B3 on right side in FIG. 33), or one of the fixed seats 510 by a second steel wire head connecting member 532B4 (see the second steel wire head 532B3 on left side in FIG. 33). The second steel wire head connecting member 532B4 may take a structure as same as the first steel wire head connecting member 532A4 or a different structure, as long as it can fix the second steel wire head 532B3 and the fixed seats 510 together.

Of course, the disclosure is not limited thereto, and the two first exposed parts 532A1, 532A2 may be directly connected to the two engaging members 150, respectively. The two second exposed parts 532B1, 532B2 may be directly connected to the two engaging members 150, respectively. Thus, the two fixed seats 510 can be omitted.

Hereinafter, the working process in which the first wire component 530A plays a linkage role will be described.

As shown in FIGS. 32B and 33, when the engaging member 150 on left side is actuated by the driving part 110 to move toward right in the drawings, the fixed seat 510 on the engaging member 150 on left side similarly moves toward right along the guide slot 350 on left side (see FIG. 32B). Then, the first wire component 530A plays a linkage role, and the first exposed part 532A1 of the first wire component 530A which is connected to the fixed seat 510 on left side is brought to move toward right by the fixed seats 510. Since the first outer jacket 531A does not move following the first core 532A, the first exposed part 532A1 on left side protrudes further outside the first outer jacket 531A toward right. The movement of the first exposed part 532A1 on left side will cause the first core 532A to slide inside the first outer jacket 531A, such that the first exposed part 532A2 on right side will be further retracted into the first outer jacket 531A toward left in the drawings. That is, the first wire component 530A may be arranged such that the protruding direction of one first exposed part 532A1 protruding outside the first outer jacket 531A is opposite to the retracting direction of the other first exposed part 532A2 retracting into the first outer jacket 531A. Thus, the first exposed part 532A2 on right side brings the fixed seat 510 on right side to move toward left along the guide slot 350 on right side (see FIG. 32B), thereby bringing the engaging member 150 on right side toward left. Thus, it is realized that the engaging member 150 on left side can bring the engaging member 150 on right side synchronously move in directions opposite to each other, such that the pivoting parts 100 on both sides can be unlocked synchronously.

As shown in FIG. 33, the front connecting shaft 180A connected between the two pivoting parts 100 can make the two pivoting parts 100 be pivoted synchronously.

On the other hand, when the engaging member 150 on left side is no longer actuated by the driving part 110, the engaging member 150 on left side will move toward left under the restoring force of the reset member 160 on left side, meanwhile, the engaging members 150 on right side will move toward right under the restoring force of the reset member 160 on right side. Then, the first exposed part 532A1 on left side further retracted into the first outer jacket 531A toward left, and the first exposed part 532A2 on right side protrudes further outside the first outer jacket 531A toward right; moreover, the second exposed part 532B1 on right side further retracted into the second outer jacket 531B toward right, and the second exposed part 532B2 on left side protrudes further outside the second outer jacket 531B toward left. Finally, the two engaging members 150 are engaged with the respective first engaging slots 170, the second engaging slots 144 at the same time, such that the two pivoting parts 100 are locked synchronously.

Similarly, as shown in FIGS. 32B and 33, when the engaging member 150 on right side is actuated by the driving part 110 to move toward left, the fixed seat 510 on the engaging member 150 on right side also moves toward left along the guide slot 350 on right side (see FIG. 32B). Then, the second wire component 530B plays a linkage role. The working process of the second wire component 530B is basically as same as that of the first wire component 530A, except only that the movement direction of the related parts is opposite, so the details are not redundantly repeated here.

### Second Embodiment of Synchronous Unlocking Assembly

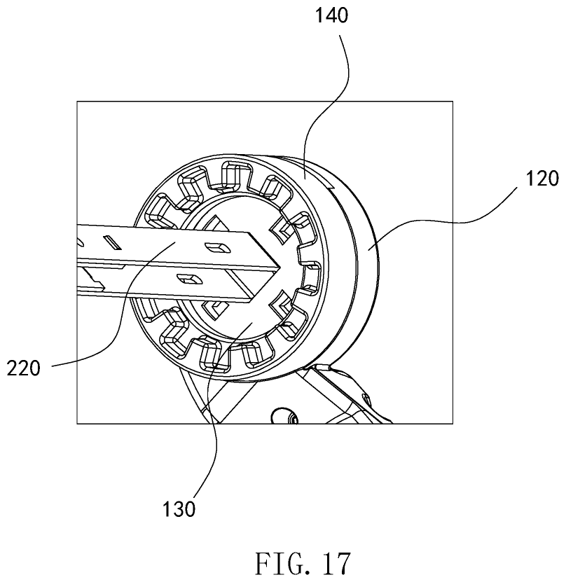

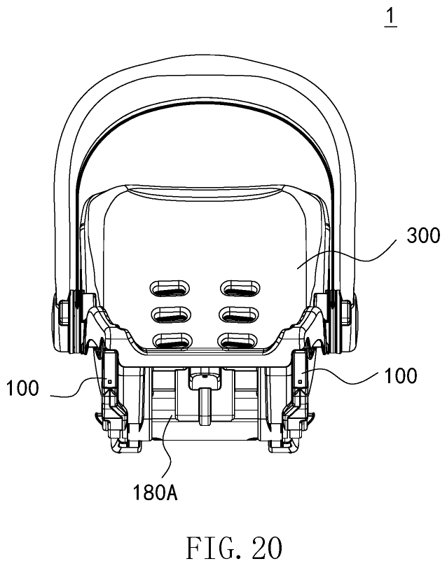

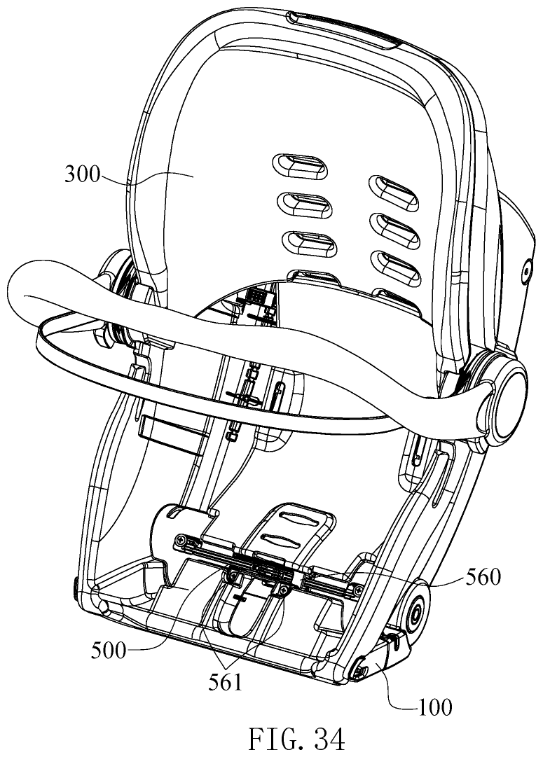

FIGS. 34 to 36 show a second embodiment of the synchronous unlocking assembly of the carrier according to the disclosure, which is different from the first embodiment of the synchronous unlocking assembly described above with reference to FIGS. 1-25 and 32A-33 mainly in that the wire component is replaced by a link rod structure.

As shown in FIGS. 34 to 36, the synchronous unlocking assembly 500 includes a hinged structure 540 and two third link rods 550. The hinged structure 540 may be formed into a sheet, a rod or a block.

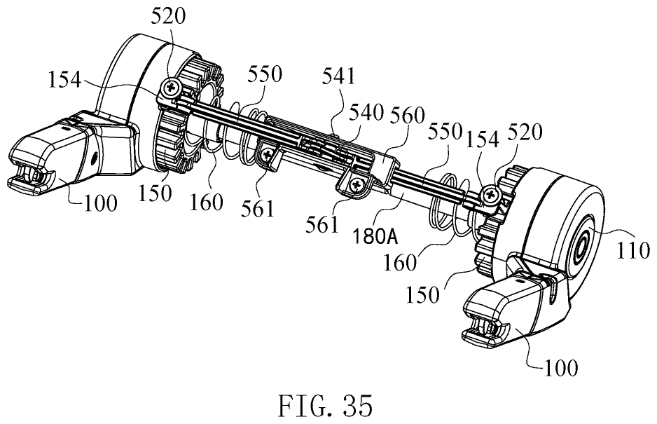

Specifically, the hinged structure 540 is rotatably arranged on the carrying body 300. In the embodiment shown in FIGS. 34 and 35, and the synchronous unlocking assembly 500 includes a hinge structure placement seat 560. The hinge structure placement seat 560 is fixed to the carrying body 300 by, for example, a placement seat fixing member 561, and the hinged structure 540 is rotatably arranged on the hinge structure placement seat 560. For example, the middle part of the hinged structure 540 is connected to a hinge pin 541, and two ends of the hinge pin 541 are rotatably connected to the hinge structure placement seat 560.

It should be understood, the hinged structure 540 can be directly arranged on the carrying body 300. In such case, both ends of the hinge pin 541 are rotatably connected to the carrying body 300.

One ends of the two third link rods 550 are respectively pivotably connected to the two ends of the hinged structure 540, such that the two third link rods 550 can form a linkage.

The other ends of the two third link rods 550 are respectively pivotably connected to the two engaging members 150, such that movement between the third link rods 550 and the engaging members 150 can be transmitted to each other.

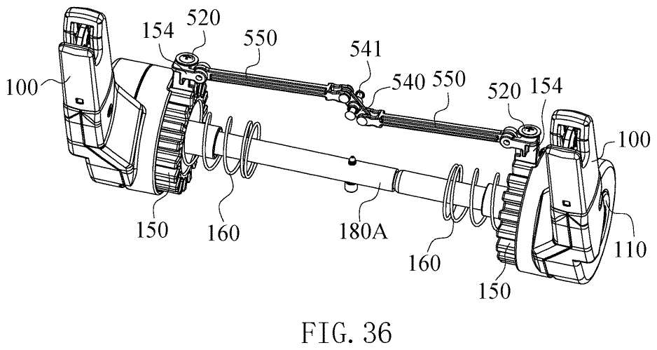

In the embodiment shown in FIG. 36, each of the engaging members 150 is provided with an engaging member connecting structure 154, and the other ends of the third link rods 550 are pivotably connected to the engaging member connecting structures 154. The engaging member connecting structures 154 may be respectively fixed to the engaging members 150 by the fixing members 520.

The working process of the hinged structure 540 and the two third link rods 550 playing a linkage role in the second embodiment is basically as same as that of the hinge member 230 and the two first link rods 210.

When the engaging member 150 on one side of the carrying body 300 is actuated by the driving part 110 to move toward the engaging member 150 on the other side (e.g., to move in the lateral direction of the carrier 1), the movement is transmitted to the engaging member 150 on the other side via one third link rod 550, the hinged structure 540, and the other third link rod 550. When the hinged structure 540 rotates around the hinge pin 541 at its middle part, the motion tangent directions of the two ends of the hinged structure 540 are opposite, so the two third link rods 550 pivotably connected to said two ends also have motion components in opposite directions, thus, the third link rod 550 on the other side brings the engaging member 150 on the other side being pivotably connected thereto to move synchronously toward the engaging member 150 on said one side, thereby realizing that the pivoting parts 100 on both sides are synchronously unlocked.

In addition, since the two third link rods 550 are arranged central symmetrically about a rotating shaft of the hinged structure 540 (e.g., the hinge pin 541), the two engaging members 150 on both sides move same distance in opposite directions. Therefore, in an embodiment, only one the engaging members 150 needs to be actuated to realize that the two pivoting parts 100 are unlocked synchronously.

As shown in FIGS. 35 and 36, the front connecting shaft 180A connected between the two pivoting parts 100 can make the two pivoting parts 100 to be pivoted synchronously.

On the other hand, when the engaging member 150 on one side is no longer actuated by the driving part 110, the two engaging members 150 will move toward directions away from each other under the restoring forces of their respective reset members 160. Finally, the two engaging members 150 are engaged with their respective first engaging slots 170 and second engaging slots 144 at the same time again, thereby realizing that the two pivoting parts 100 are locked synchronously.

In the second embodiment of the synchronous unlocking assembly, as shown in FIG. 34, since most of the synchronous unlocking assembly 500 can be accommodated in the interior of the carrying body 300, and the part of the synchronous unlocking assembly 500 exposed outside the carrying body 300 can also be covered with a seat cloth, the overall aesthetics of the carrier 1 is improved.

### Base for Placing Carrier

In order to facilitate the user to connect the carrier 1 to the vehicle seat, the disclosure further provides another scheme, i.e., as shown in FIG. 37A, connecting the carrier 1 to the vehicle seat by a base 4000.

The base 4000 according to the disclosure may be connected to the vehicle seat in advance by a conventional way such as a seat belt or ISOFIX and the like. Thus, when the carrier 1 is connected to or removed from the base 4000, i.e., when the carrier 1 is connected to or removed from the vehicle seat, this way can greatly improve the convenience for connecting or removing the carrier 1 to/from the vehicle seat.

The base 4000 according to the disclosure may serve to place the previously described carrier 1 including the pivoting part 100. For facilitating description, as described previously, the direction for a baby in the carrier 1 to face is defined as front, the direction for the baby to face back is defined as back, the left and right direction of the baby in the carrier 1 is defined as lateral, as shown in FIGS. 37A to 40. It should be understood, positional terms such as “front,” “rear,” and “lateral” are merely used for clarity and convenience of description, rather than limitations of the disclosure.

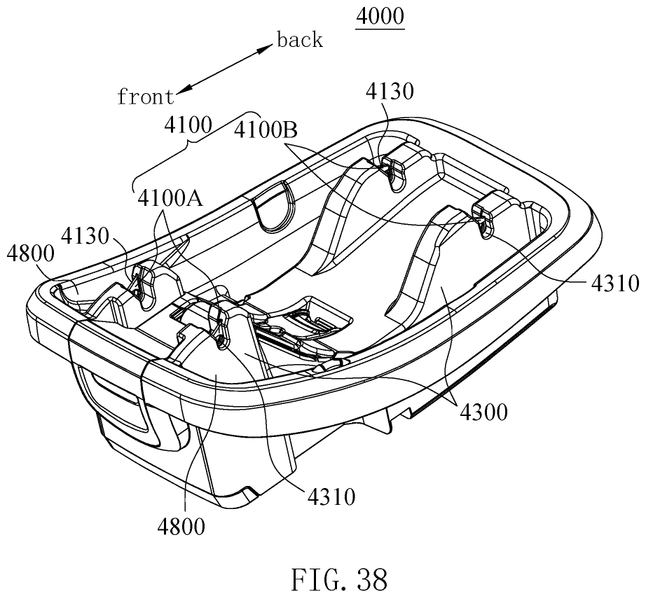

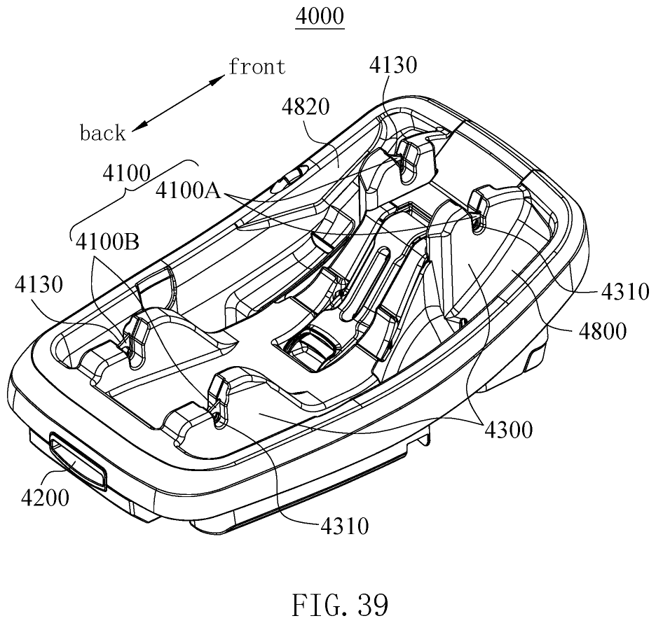

As shown in FIGS. 38 and 39, the base 4000 is provided with an avoidance space 4800. The avoidance space 4800 can be arranged inside a front side of the base 4000 at a position corresponding to the pivoting part 100 of the carrier 1, such that when the carrier 1 is placed on the base 4000, the avoidance space 4800 can accommodate the pivoting part 100 of the carrier 1. For example, the avoidance space 4800 may be a space formed among two side walls of a front and two base bulged parts 4300 (described later) of the base 4000 and an upper surface of the base 4000. In order to ensure that the avoidance space 4800 has a width sufficient to accommodate the pivoting part 100, as shown in FIG. 39, a recession 4820 may be formed on each of the side walls of the base 4000 forming the avoidance space 4800, and the recession 4820 extend downward from tops of the side walls to middle parts of the side walls. Thus, when the carrier 1 is placed on the base 4000, the avoidance space 4800 can accommodate the pivoting part 100 of the carrier 1. Before the carrier 1 is placed on the base 4000, the pivoting part 100 can be adjusted to an appropriate pivoted position according to the situation of the avoidance space 4800, for example, to a storage pivoted position.

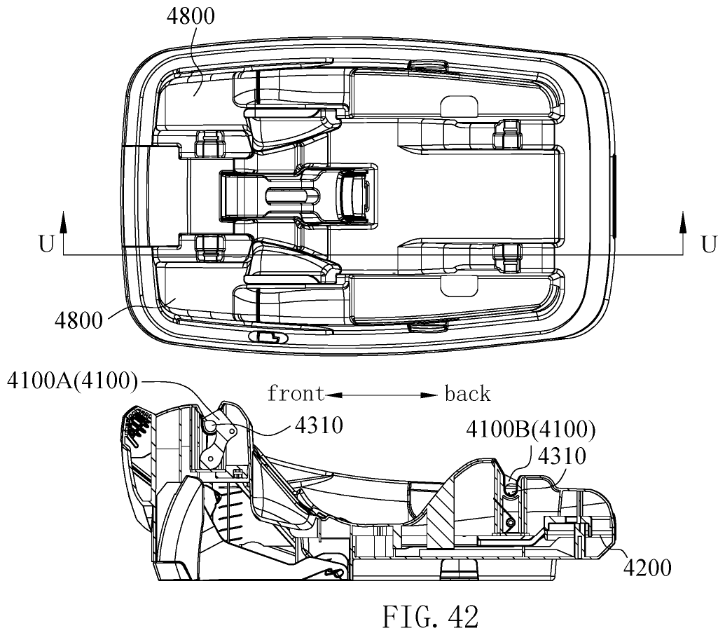

FIGS. 37A to 45 show an embodiment of the base 4000 according to the disclosure for placing the carrier 1.

In an embodiment, as shown in FIGS. 38 and 39, the base 4000 according to the disclosure includes a base engagement member 4100 and a base operation member 4200. Among them, the base engagement member 4100 is used to engage the carrier 1, and the base operation member 4200 is used to drive base engagement member 4100.

Hereinafter, the base engagement member 4100 and its related components will be firstly described in detail.

As shown in FIGS. 38-39 and 40-42, the base engagement member 4100 on the base 4000 is arranged to be movable between an engaged position and a non-engaged position. Among them, the base engagement member 4100 can be engaged with a front connecting shaft 180A arranged on the carrier 1 in the engaged position, thereby connecting the carrier 1 to the base 4000; moreover, the base engagement member 4100 can be disengaged from the front connecting shaft 180A in the non-engaged position, thereby allowing the carrier 1 to move away from the base 4000.

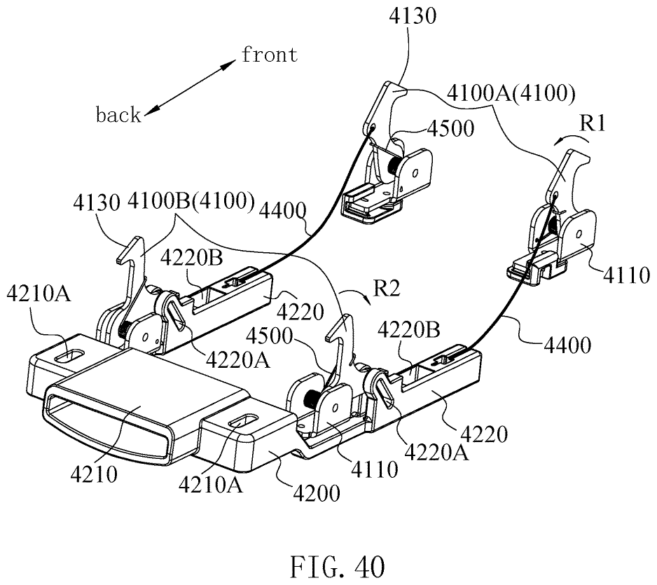

As shown in FIG. 40, after the base engagement member 4100 moves to the non-engaged position under driving of the base operation member 4200, it can return to the engaged position by a base elastic member 4500. The base elastic member 4500 is arranged to drive the base engagement member 4100 toward to move toward the engaged position. In the embodiment shown in FIG. 40, the base elastic member 4500 is a torsion spring. However, the base elastic member 4500 may take another form of an elastic member such as a compression spring, a hydraulic rod and the like, as long as it can drive the base engagement member 4100 to move toward the engaged position. In addition, it should be understood, the base elastic member 4500 is not necessary for the disclosure, and the base engagement member 4100 can be arranged to return to the engaged position under driving of the base operation member 4200.

In order to more firmly place the carrier 1 in the base 4000, in the embodiment shown in FIGS. 38 to 42, the base engagement member 4100 may include a front base engagement member 4100A and a rear base engagement member 4100B separated by a certain distance along the front-rear direction of the base 4000. Among them, the front base engagement member 4100A is located at a front of the base 4000, and the rear base engagement member 4100A is located at a rear of the base 4000.

Accordingly, as shown in FIG. 25, the carrier 1 may further include a rear connecting shaft 180B additional to the front connecting shaft 180A. The rear connecting shaft 180B is connected to the two side parts 330 of the carrying body 300 at the bottom of the carrying body 300, and the rear connecting shaft 180B is spaced apart from the front connecting shaft 180A in the front-rear direction of the carrier 1, such that the front base engagement member 4100A can be engaged with or disengaged from the front connecting shaft 180A, the rear base engagement member 4100B can be engaged with or disengaged from the rear connecting shaft 180B. Such a configuration structure can avoid the carrier 1 from being overturned in the front-back direction on the base 4000.

In the process for the user to place the carrier 1 on the base 4000, in order to facilitate the user to move the base engagement member 4100 to the non-engaged position without operating the base operation member 4200, each of the front base engagement member 4100A and the rear base engagement member 4100B is arranged provided with an end structure. In the embodiment shown in FIGS. 38 to 40, the front base engagement member 4100A and the rear base engagement member 4100B have same end structures, and here the front base engagement member 4100A will be taken as example to described. The end of the front base engagement member 4100 which is engaged with the front connecting shaft 180A is provided with an engagement member ramp 4130, and the engagement member ramp 4130 is arranged such that when the front base engagement member 4100A and the front connecting shaft 180A are ready to be engaged, the front connecting shaft 180A can abut against the engagement member ramp 4130, thereby pushing the front base engagement member 4100 to move toward the non-engagement position, thus making it more convenient for the user.

As shown in FIG. 25, in an embodiment, the base engagement member 4100 may be a base engaging hook pivotably arranged on the base 4000. The base engagement member 4100 may include a front base engaging hook 4100A and a rear base engaging hook 4100B (see FIGS. 38 to 40).

In this embodiment, as shown in FIG. 40, the end of the front base engaging hook 4100A (to be described later) which is engaged with the front connecting shaft 180A shown in FIG. 125 is provided with an engagement member ramp 4130, and the engagement member ramp 4130 is inclined in respect with the horizontal direction, such that when the front base engaging hook 4100A is ready to be engaged with the front connecting shaft 180A, the front connecting shaft 180A can abut against the engagement member ramp 4130, thereby generating a pivoting moment to the front base engaging hook 4100A, and pushing the front base engaging hook 4100A to be pivoted toward the first pivoting direction R1 to reach the non-engagement position. Similarly, as shown in FIG. 40, an end of a rear base engaging hook 4100B (to be described later) which is engaged with the rear connecting shaft 180B may also be provided with an engagement member ramp 4130, and the engagement member ramp 4130 is inclined in respect with the horizontal direction, such that when the rear base engaging hook 4100B is ready to be engaged with the rear connecting shaft 180B, the rear connecting shaft 180B can abut against the engagement member ramp 4130, thereby generating a pivoting moment to the rear base engaging hook 4100B, and pushing the rear base engaging hook 4100B be pivoted toward the second pivoting direction R2 to reach the non-engagement position. It should be understood, in this embodiment, since the direction in which the front base engaging hook 4100A is pivoted toward the non-engagement position (i.e., the first pivoting direction R1) is different from the direction in which the rear base engaging hook 4100B is pivoted toward the non-engagement position (i.e., the second pivoting direction R2), the inclined direction of the engagement member ramp 4130 of the front base engaging hook 4100A is also different from the inclined direction of the engagement member ramp 4130 of the rear base engaging hook 4100B. However, if the front base engaging hook 4100A and the rear base engaging hook 4100B are arranged in the same direction to be pivoted toward the non-engagement position, the inclined direction of the engagement member ramp 4130 of the front base engaging hook 4100A may be arranged as same as the inclined direction of the engagement member ramp 4130 of the rear base engaging hook 4100B.

In the embodiment shown in FIG. 40, the base engaging hook 4100 is pivotably connected to an engaging hook fixed seat 4110, and the engaging hook fixed seat 4110 is fixed to the base 4000. In other embodiments, the base engaging hook 4100 may also be directly connected to the base 4000. In addition, the base engaging hook 4100 is not limited to be pivoted, and may also be adopted to be sliding.

In order to better place the carrier 1 in the base 4000, in the embodiment shown in FIGS. 38 and 39, the base 4000 may have base bulged parts 4300 arranged on a surface thereof contacting with the carrier 1, and each of the base bulged parts 4300 is provided with a base groove 4310 capable of accommodating the front connecting shaft 180A and the rear connecting shaft 180B. Moreover, the base engaging hook 4100 is at least partially movably arranged in the base groove 4310 and is arranged such that the base engaging hook 4100 can lock the front connecting shaft 180A and the rear connecting shaft 180B inside the base groove 4310 when in the engaged position; and the base engagement member 4100 allows the front connecting shaft 180A and the rear connecting shaft 180B to enter or leave the base groove 4310 when in the non-engagement position.

Next, the base operation member 4200 and its related components will be described in detail.

In the base 4000 according to the disclosure, the base operation member 4200 is movably arranged on the base 4000, and is arranged to directly or indirectly drive the base engagement member 4100 to move toward the non-engagement position.

In the embodiment shown in FIGS. 38 to 42, the base engagement member 4100 includes a front base engagement member 4100A and a rear base engagement member 4100B, and the base operation member 4200 may be arranged to directly drive the rear base engagement member 4100B to be pivoted toward the second pivoting direction R2 as shown FIG. 40 (i.e., to move toward the non-engagement position), and simultaneously indirectly drive the front base engagement member 4100A to be pivoted toward the first pivoting direction R1 (i.e., to move toward the non-engagement position) through a base linked movement member 4400. In this embodiment, the pivoting direction R1 of the front base engagement member 4100A and the pivoting direction R2 of the rear base engagement member 4100B are opposite are opposite. However, it should be understood, the pivoting direction R1 of the front base engagement member 4100A and the pivoting direction R2 of the rear base engagement member 4100B may be arranged to be the same, for example, the rear base engagement member 4100B may be arranged to be pivoted toward the first pivoting direction R1 to reach the non-engagement position.

The base linked movement member 4400 can be a flexible member made of various materials, such as a thread, a wire, a rope and the like, or a rigid member in the form of a rod, a plate or a block. The base linked movement member 4400 serves to transmit the movement of the base operation member 4200 to the front base engagement member 4100A.

More specifically, as shown in FIGS. 39 to 44, the base operation member 4200 includes: an operation member body 4210, arranged to be capable of operating the base 4000 from outside; an operation member extension part 4220, extending from the operation member body 4210 toward an interior of the base 4000, so as to be able to contact and drive the base engagement member 4100.

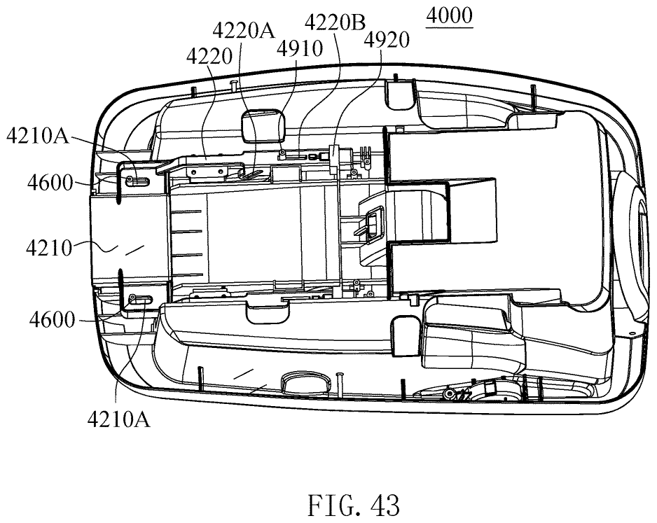

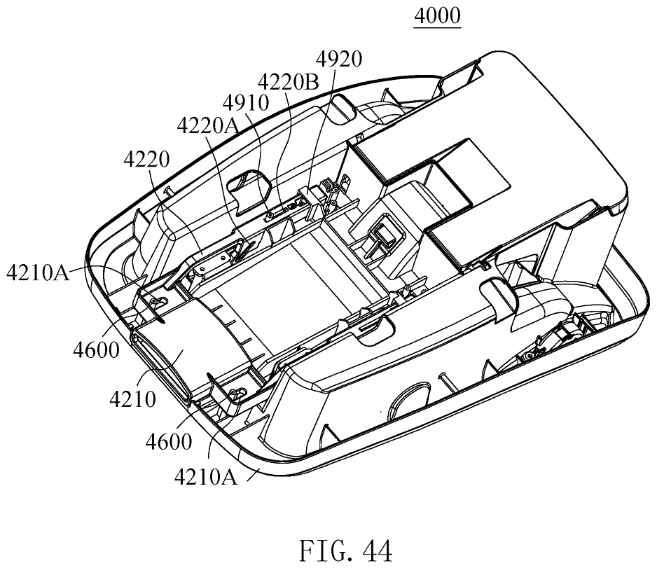

In the embodiments shown in FIGS. 40, 43, 44, the operation member body 4210 is provided with an operation member long slot 4210A extending along the front-rear direction of the base 4000, and the base 4000 is provided with a base bulged post 4600 (see FIGS. 43 and 44) passing through the operation member long slot 4210A, such that the base operation member 4200 can move in respect with the base 4000. Moreover, since the base bulged post 4600 can only slide inside the operation member long slot 4210A, the position and the movement stroke of the base operation member 4200 in respect with the base 4000 are limited, thereby avoiding the base operation member 4200 from being accidentally separated from the base 4000.

Of course, the disclosure is not limited thereto. In another embodiment, as shown FIGS. 40, 43, 44, the operation member extension part 4220 is provided with an operation member limiting slot 4220B extending along the front-rear direction of the base 4000, and the base 4000 is provided with a base limiting post 4910 passing through the operation member limiting slot 4220B. Such configuration can also limit the movement of the base operation member 4200 in respect with the base 4000. This configuration can be used together with the above configuration of the operation member long slot 4210A and the base bulged post 4600, or can be used alone.

In order to make the movement of the base operation member 4200 in respect with the base 4000 more stable, the base 4000 may be provided with a U-shaped base limiting rib 4920, and the operation member extension part 4220 may be arranged to be able to pass through the base limiting rib 4920 and move along the base limiting rib 4920. Such configuration can be used together with the above configuration of the operation member long slot 4210A and base bulged post 4600 or the above configuration of the operation member limiting slot 4220B and the base limiting post 4910, or can be used alone.

In addition, the base operation member 4200 may drive the base engagement member 4100 in various ways.

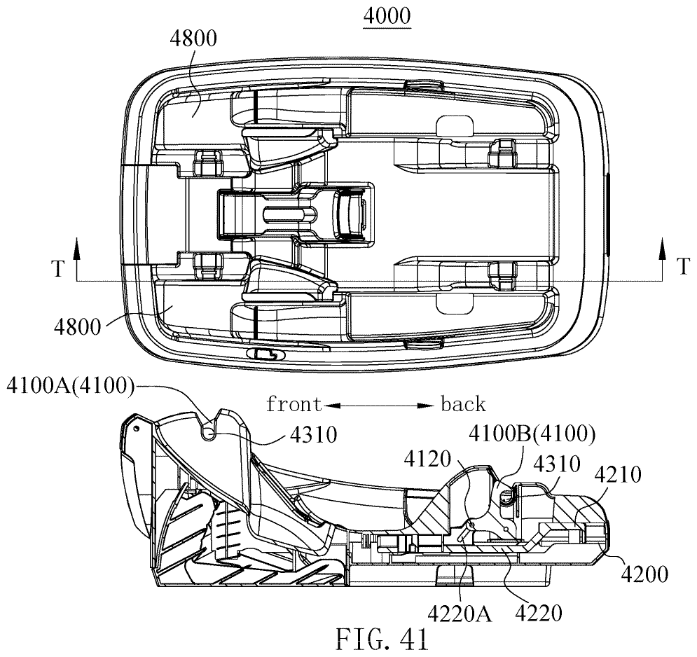

In the embodiment shown in FIGS. 40 and 41, the operation member extension part 4220 of the base operation member 4200 is provided with a long operation member drive slot 4220A; the base engagement member 4100 is provided with an engagement member driving pin 4120 (see FIG. 41), and the engagement member driving pin 4120 passes through the operation member drive slot 4220A. Moreover, the extending direction of the operation member drive slot 4220A is inclined to the moving direction of the base operation member 4200, such that when the base operation member 4200 moves in respect with the base 4000, the operation member drive slot 4220A drives the engagement member driving pin 4120 to slide therein, and the sliding direction of the engagement member driving pin 4120 inside the operation member drive slot 4220A will also be inclined to the moving direction of the base operation member 4200, so the base engagement member 4100 will be pivoted or move, thus realizing that the base engagement member 4100 moves toward the non-engagement position.

As shown in FIG. 40, when the base operation member 4200 is operated to move, its operation member extension part 4220 moves synchronously, by driving of the operation member drive slot 4220A of the operation member extension part 4220 to the engagement member driving pin 4120 of the rear base engagement member 4100B (see FIG. 41), the rear base engagement member 4100B will be pivoted toward the second pivoting direction R2 (i.e., toward the non-engagement position). At the same time, the base linked movement member 4400 connected to the operation member extension part 4220 transmits the movement of the base operation member 4200 to the front base engagement member 4100A, and drives the front base engagement member 4100A to be pivoted toward the first pivoting direction R1 (i.e., toward the non-engagement position).

Of course, the disclosure is not limited thereto, and the base operation member 4200 may drive the base engagement member 4100 in other ways. For example, in an embodiment where the movement direction of the base operation member 4200 is as same as the direction of the base engagement member 4100 to move toward the non-engagement position, the base operation member 4200 may be fixed together with or integrally formed with the base engagement member 4100, thereby realizing synchronous movement. Alternatively, an intermediate member similar to the base linked movement member 4400 may be arranged between the base operation member 4200 and the base engagement member 4100, and the movement of the base operation member 4200 can be transmitted to the base engagement member 4100 by the intermediate member. Alternatively, the operation member extension part 4220of the base operation member 4200 may extend not only to the rear base engagement member 4100B, but also to the front base engagement member 4100A, such that the operation member extension part 4220 of the base operation member 4200 can simultaneously drive the rear base engagement member 4100B and the front base engagement member 4100A to be pivoted toward the same direction, thus omitting the base linked movement member 4400.

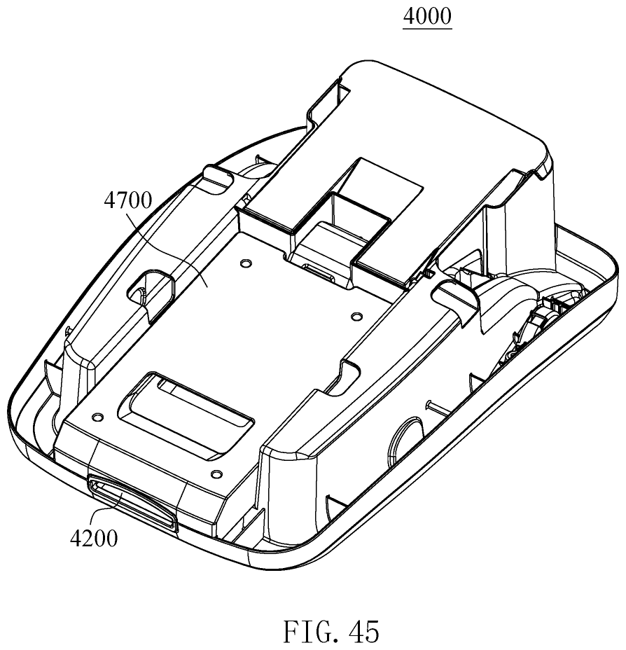

In order to avoid the problem that the base operation member 4200 is exposed to outside, resulting in unsightly appearance or easy damage of internal members, the base 4000 further includes a bottom cover 4700, as shown in FIG. 45, the bottom cover 4700 is fixed to the base 4000 and partially covers the base operation member 4200. The bottom cover 4700 partially covers the base operation member 4200, which not only protects the internal members, but also enables the user to contact and operate the base operation member 4200 from outside of the base 4000.

### Second Embodiment of Base for Placing Carrier

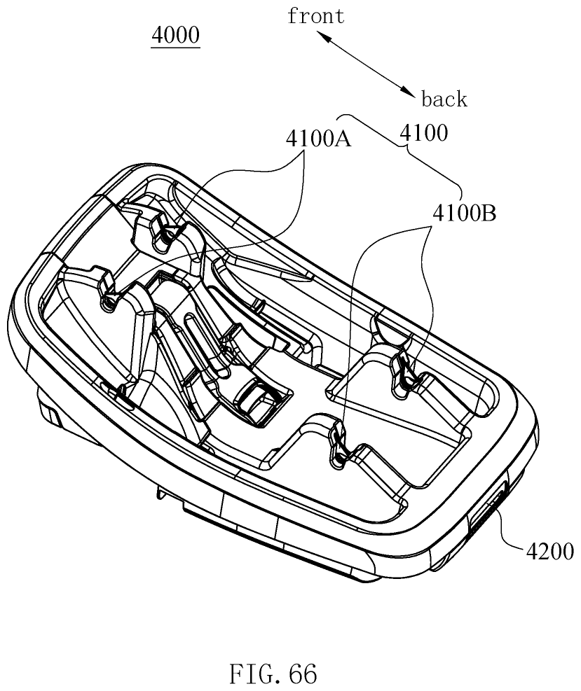

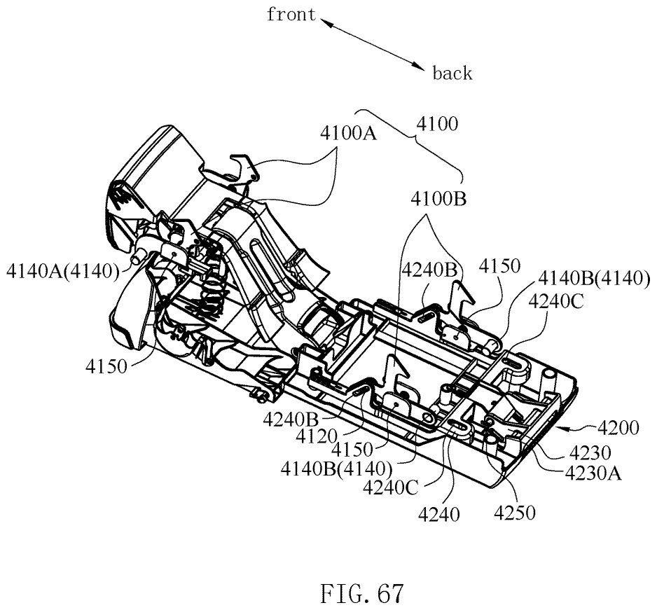

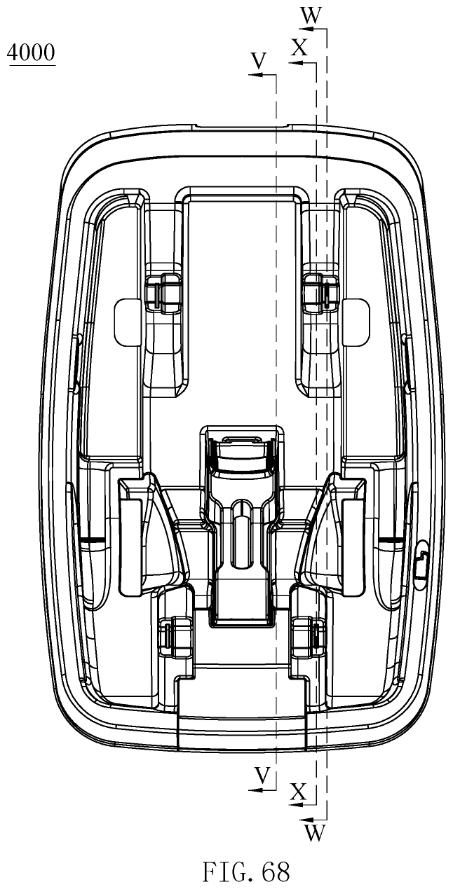

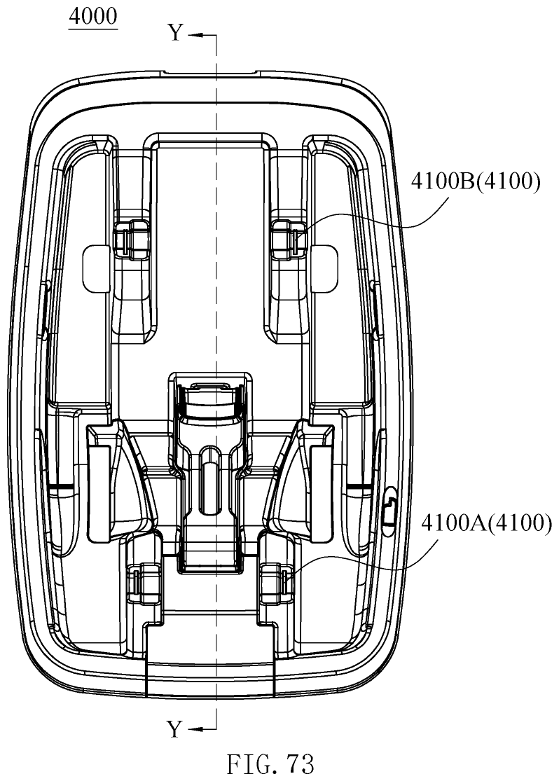

FIGS. 66 to 74 show the second embodiment of the base 4000 for placing the carrier 1 according to the disclosure, which is different from the first embodiment of the base 4000 described above with reference to FIGS. 37A to 45 mainly in that in the first embodiment, the base operating member 4200 is constituted by a single component, and the user drives the base engagement member 4100 by operating the single component for translation, while in the second embodiment, the base operating member 4200 is constituted by a plurality of components, and the user drives the base engagement member 4100 by operating one of the components to rotate.

Specifically, in the second embodiment of the base 4000, the base operating member 4200 includes an operating member rotating part 4230 and an operating member driving part 4240.

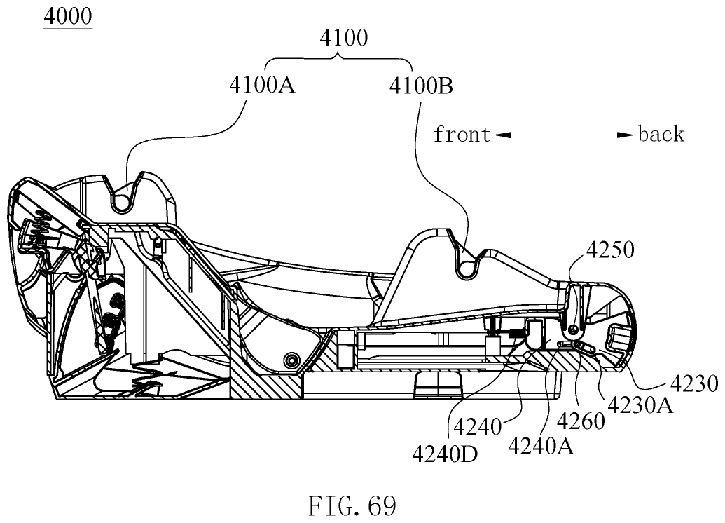

As shown in FIGS. 67 and 69, the operating member rotating part 4230 is rotatably connected to the base 4000.

The operating member rotating part 4230 is arranged capable of being operated from outside of the base 4000 to rotate it. The operating member rotating part 4230 may take a form of a block, a plate, a rod or other structures specially designed.

In an embodiment, as shown in FIG. 67, the base operating member 4200 may include an operating member rotating shaft 4250, and the operating member rotating part 4230 can rotate around the operating member rotating shaft 4250.

It should be understood, the operating member rotating shaft 4250 can be integrally formed with the operating member rotating part 4230, or it can be a separate component independent of the operating member rotating part 4230, and a shaft hole (not shown) for the operating member rotating shaft 4250 to rotate therein may be formed on the base 4000. Alternatively, the operating member rotating shaft 4250 may be integrally formed with the base 4000, and a shaft hole for the operating member rotating shaft 4250 to rotate therein may be formed on the operating member rotating part 4230.

In another embodiment, the base operating member 4200 may not include the operating member rotating shaft 4250, instead, an arc guide rail (not shown) may be formed on the base 4000, and the operating member rotating part 4230 may rotate along the arc guide rail.

The operating member rotating part 4230 rotates on the base 4000, such that the base operating member 4200 does not have to extend out of the base 4000 as in the first embodiment, which is beneficial to an application environment with small operation space.

The operating member driving part 4240 is movably connected to the base 4000, and can contact and drive the base engagement member 4100. The rotation of the operating member rotating part 4230 can directly or indirectly drive the operating member driving part 4240 to move, thereby driving the base engagement member 4100.

It should be understood, the base engagement member 4100 used in the second embodiment may be as same in structure and working principle as the base engagement member 4100 described in the first embodiment. Therefore, as shown in FIG. 67, the operating member driving part 4240 in the second embodiment may adopt a structure similar to that of the operating member extension part 4220 in the first embodiment.

For example, the operating member driving part 4240 may be provided with a long driving part driving slot 4240B (see FIG. 67). The driving part driving slot 4240B is similar to the operating member drive slot 4220A in the first embodiment, and is used for cooperating with the engaging member drive pin 4120 (see FIG. 67) on the base engagement member 4100, such that when the operating member driving part 4240 moves in respect with the base 4000, the operating member drive slot 4240B drives the engaging member drive pin 4120 to slide therein, and the sliding direction of the engaging member drive pin 4120 inside the operating member drive slot 4240B will also be inclined to the moving direction of the operating member driving part 4240, so the base engagement member 4100 will be pivoted or moved, thus realizing that the base engagement member 4100 moves toward the non-engaged position.

For another example, the operating member driving part 4240 may be provided with a driving part long slot 4240C (see FIG. 67) extending along the front-rear direction of the base 4000. the driving part long slot 4240C is similar to the operating member long slot 4210A in the first embodiment, and is used to cooperate with the base bulged post 4600 (see FIGS. 43 and 44) on the base 4000, such that the movement of the operating member driving part 4240 in respect with the base 4000 is restricted.

Hereinafter, referring to FIGS. 66 to 71, an embodiment in which the rotation of the operating member rotating part 4230 directly drives the operating member driving part 4240 to move will be describe. In this embodiment, the operating member rotating part 4230 directly acts on the operating member driving part 4240.

In order to make the operating member rotating part 4230 with the operating member driving part 4240 to be linked moving, as shown in FIG. 69, the operating member rotating part 4230 is provided with a long rotating part linked movement slot 4230A, the operating member driving part 4240 is provided with a long driving part linked movement slot 4240A, and an operating member driving shaft 4260 simultaneously passes through the rotating part linked movement slot 4230A and the driving part linked movement slot 4240A, such that the operating member rotating part 4230 can drive the operating member driving part 4240 to move by the operating member driving shaft 4260.

More specifically, when the operating member rotating part 4230 rotates under operation of the use, the rotating part linked movement slot 4230A on the operating member rotating part 4230 will rotate accordingly, thus the rotating part linked movement slot 4230A will bring the operating member driving shaft 4260 passing therethrough to move. Since the operating member driving shaft 4260 also simultaneously passes through the driving part linked movement slot 4240A on the operating member driving part 4240 in the meantime, after the operating member driving shaft 4260 in moving abuts an end of the driving part linked movement slot 4240A, the operating member driving shaft 4260 will bring the operating member driving part 4240 to move, thus realizing that the operating member rotating part 4230 drives the operating member driving part 4240 to move by the operating member driving shaft 4260.

As shown in FIG. 69, the carrier 1 may be provided with a driving part reset elastic member 4240D. The driving part reset elastic member 4240D is arranged to drive the operating member driving part 4240 to move towards the initial position, such that once the user no longer acts on the operating member rotating part 4230, the operating member driving part 4240 will return to the initial position under the elastic force of the driving part reset elastic member 4240D, and at the same time, the operating member driving part 4240 will further drive the operating member rotating part 4230 to return to the initial position by the operating member driving shaft 4260.

The driving part reset elastic member 4240D can adopt a suitable elastic member such as a spring, a torsion spring, a hydraulic rod and the like.

It should be understood, although in the embodiment shown in FIG. 69, the driving part reset elastic member 4240D is arranged to directly act on the operating member driving part 4240, however, in other embodiments, the driving part reset elastic member 4240D may also be arranged to directly act on the operating member rotating part 4230, such that the driving part reset elastic member 4240D drives the operating member rotating part 4230 to return to the initial position, and further, the operating member rotating part 4230 drives the operating member driving part 4240 to return to initial position by the operating member driving shaft 4260.

In addition, the driving part reset elastic member 4240D is not necessary, and the operating member rotating part 4230 may be arranged to return to the initial position under operation of the user, and then the operating member driving part 4240 is driven to return to the initial position by the operating member driving shaft 4260.

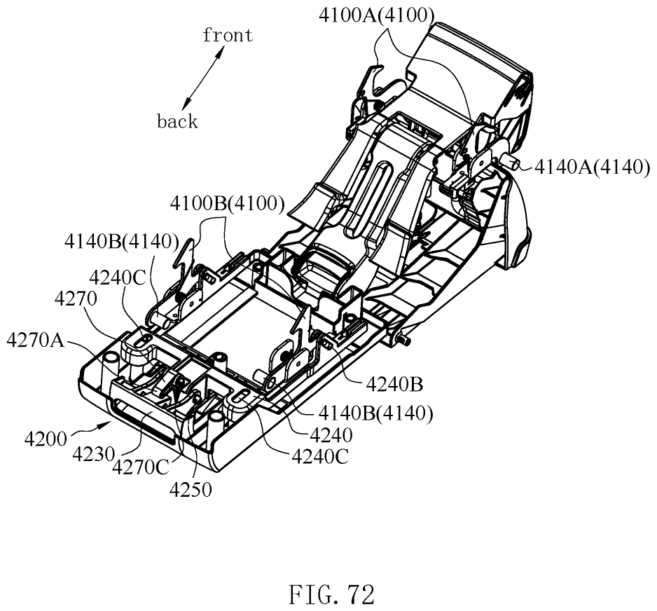

Next, an embodiment in which the operating member rotating part 4230 indirectly drives the operating member driving part 4240 to move will be described with reference to FIGS. 72 to 74. Different from the embodiment described above with reference to FIGS. 66 to 71, in this embodiment, the operating member rotating part 4230 indirectly acts on the operating member driving part 4240.

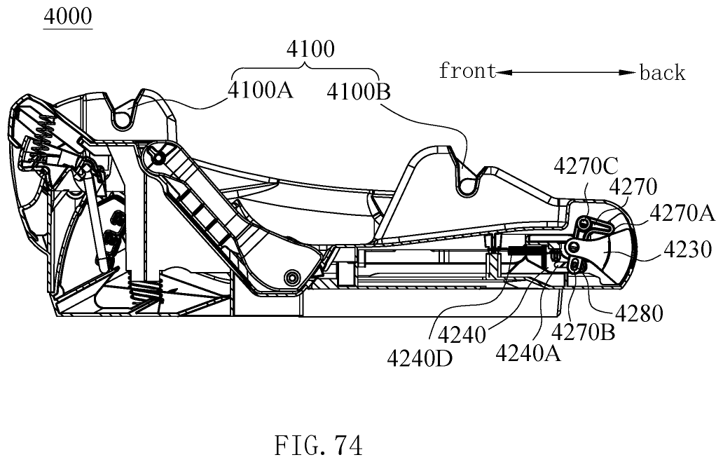

As shown in FIGS. 72 and 74, the base operating member 4200 further includes an operating member linked movement part 4270. The operating member linked movement part 4270 is arranged to transmit rotation of the operating member rotating part 4230 to the operating member driving part 4240, so as to drive the operating member driving part 4240 to move.

FIGS. 72 and 74 show an embodiment of the operating member linked movement part 4270. The operating member linked movement part 4270 is rotatably connected to the base 4000, and is provided with a linked movement part contact end 4270A. The linked movement part contact end 4270A abuts against the operating member rotating part 4230, such that rotation of the operating member rotating part 4230 can drive the operating member linked movement part 4270 to rotate.

In order to make the operating member linked movement part 4270 and the operating member driving part 4240 to be linked moving, the operating member linked movement part 4270 is also provided with a long linked movement part long slot 4270B, and a linked movement part driving shaft 4280 simultaneously passes through the linked movement part long slot 4270B and the driving part linked movement slot 4240A, such that the operating member linked movement part 4270 can drive the operating member driving part 4240 to move by the linked movement part driving shaft 4280.

More specifically, when the operating member rotating part 4230 rotates under operation of the user, the linked movement part contact end 4270A of the operating member linked movement part 4270 abutting against the operating member rotating part 4230 is pushed by the operating member rotating part 4230 to move, such that the operating member linked movement part 4270 rotates. Then, the linked movement part long slot 4270B on the operating member linked movement part 4270 will rotate accordingly, so, the linked movement part long slot 4270B will brings the linked movement part driving shaft 4280 passing therethrough to move. Since the linked movement part driving shaft 4280 also simultaneously passes through the driving part linked movement slot 4240A on the operating member driving part 4240, when the linked movement part driving shaft 4280 in moving abuts against an end of the driving part linked movement slot 4240A, the linked movement part driving shaft 4280 will bring the operating member driving part 4240 to move, thus realizing that the movement of the operating member rotating part 4230 is firstly transmitted to the operating member linked movement part 4270, and then the operating member linked movement part 4270 drives the operating member driving part 4240 to move by the linked movement part driving shaft 4280.

In order to realize the rotation of the operating member linked movement part 4270, in an embodiment, as shown in FIGS. 72 and 74, the operating member linked movement part 4270 may include a linked movement part rotating shaft 4270C, and the operating member linked movement part 4270 can rotate around the linked movement part rotating shaft 4270C.

It should be understood, the linked movement part rotating shaft 4270C may be integrally formed with the operating member linked movement part 4270, or it can be a separate component independent of the operating member linked movement part 4270, and a shaft hole (not shown) for the linked movement part rotating shaft 4270C to rotate therein can be formed on the base 4000. Alternatively, the linked movement part rotating shaft 4270C may be integrally formed with the base 4000, and a shaft hole for the linked movement part rotating shaft 4270C to rotate therein can be formed on the operating member linked movement part 4270.

In addition, in the embodiment shown in FIG. 74, the linked movement part long slot 4270B is arranged at the other end of the operating member linked movement part 4270 opposite to the linked movement part contact end 4270A. However, it should be understood, the linked movement part long slot 4270B may be provided at other positions on the operating member linked movement part 4270, as long as it can transmit the movement of the operating member rotating part 4230.

Although an embodiment of the operating member linked movement part 4270 has been described above with reference to FIGS. 72 and 74, the disclosure is not limited thereto. The operating member linked movement part 4270 may take other structures. For example, the operating member linked movement part 4270 can be a flexible member such as a thread, a wire, a rope and the like, with one end connected to the operating member rotating part 4230 and the other end connected to the operating member driving part 4240, such that the operating member linked movement part 4270 can transmit the rotation of the operating member rotating part 4230 to the operating member driving part 4240, so as to drive the operating member driving part 4240 to move.

In the embodiment shown in FIG. 74, the carrier 1 may also be provided with a driving part reset elastic member 4240. The arrangement and function of the driving part reset elastic member 4240D are as same as those mentioned above, so the details are not redundantly repeated here.

As in the first embodiment, in the second embodiment of the base 4000, as shown in FIGS. 66 to 74, the base engagement member 4100 may include a front base engagement member 4100A and a rear base engagement member 4100B separated by a certain distance along the front-rear direction of the base 4000. Among them, the front base engagement member 4100A is located at the front of the base 4000, and the rear base engagement member 4100B is located at the rear of the base 4000. Moreover, the operating member driving part 4240 may be arranged to directly drive the rear base engagement member 4100B to move toward the non-engaged position, and simultaneously indirectly drive the front base engagement member 4100A to move toward the non-engaged position through a base linked movement member (not shown).

As shown in FIGS. 67, 70, 71 and 72, in the case that the base engagement member 4100 can be pivoted around the engaging member pivot 4150 on the base 4000, in order to keep the base engagement member 4100 in the engaged position more stably, the base engagement member 4100 may be provided with an engaging member counterweight 4140. The engaging member counterweight 4140 is arranged such that the base engagement member 4100 tends to be pivoted toward the engaged position. For example, the position of the engaging member counterweight 4140 on the base engagement member 4100 may be at a certain distance from the engaging member pivot 4150 in the front-rear direction of the carrier 1, and the center of gravity of the base engagement member 4100 is located between the engaging member counterweight 4140 and the engaging member pivot 4150 in the front-rear direction of the carrier 1, thereby facilitating the generation of a moment for the base engagement member 4100 to be pivoted toward the engaged position.

In the disclosure, the engaging member counterweight 4140 may adopt various suitable counterweight components such as a post, a block and the like, as long as its size and weight can be cooperative with the base engagement member 4100.

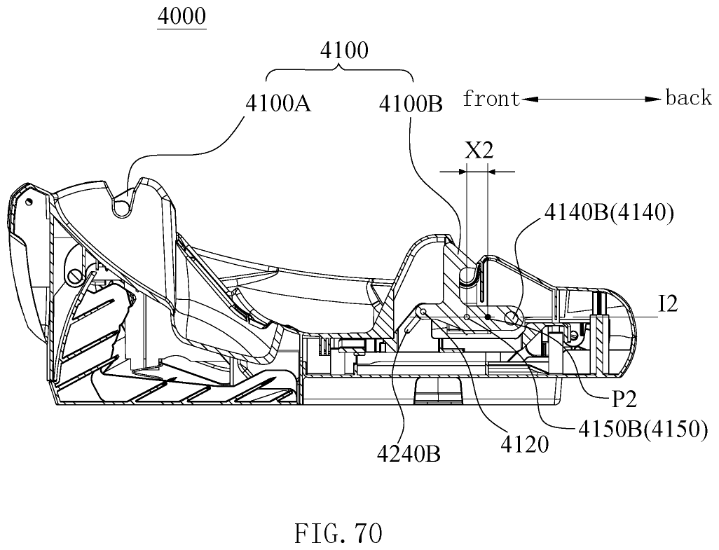

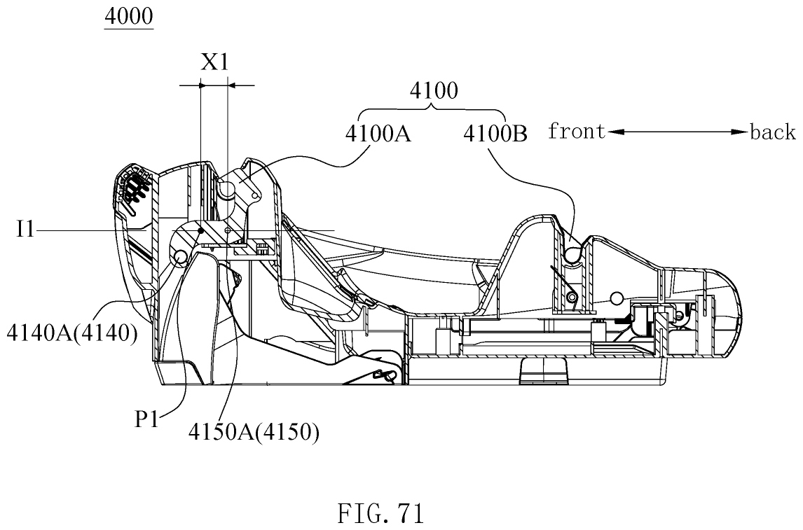

Specifically, in the embodiment shown in FIG. 70, the rear base engagement member 4100B is provided with a rear engaging member counterweight 4140B. The rear engaging member counterweight 4140B may be arranged such that the center of gravity P2 of the rear base engagement member 4100B is located between the rear engaging member counterweight 4140B and the rear engaging member pivot 4150B in the front-rear direction of the carrier 1. Thus, the center of gravity P2 of the rear base engagement member 4100B will generate a moment that makes the rear base engagement member 4100B be pivoted toward the engaged position.

In an embodiment, the distance X2 between the center of gravity P2 of the rear base engagement member 4100B and the center line of the rear engaging member pivot 4150B in the front-rear direction of the carrier 1 is equal to 4 mm.

In yet another embodiment, the center of gravity P2 of the rear base engagement member 4100B may be arranged to be substantially on a horizontal pland I2 with the rear engaging member pivot 4150B. For example, the rear engaging member counterweight 4140B may be arranged such that the center of gravity of the rear engaging member counterweight 4140B and the center line of the rear engaging member pivot 4150B are on the same horizontal pland I2. In such configuration, when the vehicle is running, if an emergency situation such as an unexpected braking, or a collision caused by acceleration occurs, the center of gravity P2 of the rear base engagement member 4100B will not generate a moment for the rear base engagement member 4100B to be pivoted toward the non-engaged position, thereby effectively preventing the rear base engagement member 4100B from being accidentally disengaged from the rear carrier engaging member 108B (i.e. one of the carrier engaging members 108, see FIG. 37B) of the carrier 1.

Optionally, in the embodiment shown in FIG. 71, the front base engagement member 4100A is provided with a front engaging member counterweight 4140A. The front engaging member counterweight 4140A may be arranged such that the center of gravity P1 of the front base engagement member 4100A is located between the front engaging member counterweight 4140A and the front engaging member pivot 4150A in the front-rear direction of the carrier 1. Thus, the center of gravity P1 of the front base engagement member 4100A will generate a moment for the front base engagement member 4100A to be pivoted toward the engaged position.

In an embodiment, the distance X1 between the center of gravity P1 of the front base engagement member 4100A and the center line of the front engaging member pivot 4150A in the front-rear direction of the carrier 1 is equal to 17 mm.

In yet another embodiment, the center of gravity P1 of the front base engagement member 4100A may be arranged to be substantially on the same horizontal plane Il with the center line of the front engaging member pivot 4150A. For example, the front engaging member counterweight 4140A may be arranged such that the center of gravity of the front engaging member counterweight 4140A and the center line of the front engaging member pivot 4150A are on the same horizontal plane I1. In such configuration, when the vehicle is running, if an emergency situation such as an unexpected braking, or a collision caused by acceleration occurs, the center of gravity P1 of the front base engagement member 4100A will not generate a moment for the front base engagement member 4100A to be pivoted toward the non-joint position, thus effectively preventing the front base engagement member 4100A from being accidentally disengaged from the front carrier engaging member 108A (i.e. one of the carrier engaging members, see FIG. 37B) of the carrier 1.

It should be understood, although in the above embodiments, the engaging member counterweight 4140 is described by combining the second embodiment of the base 4000, the engaging member counterweight 4140 can also be applied to the first embodiment of the base 4000.

### Carrier Application Device

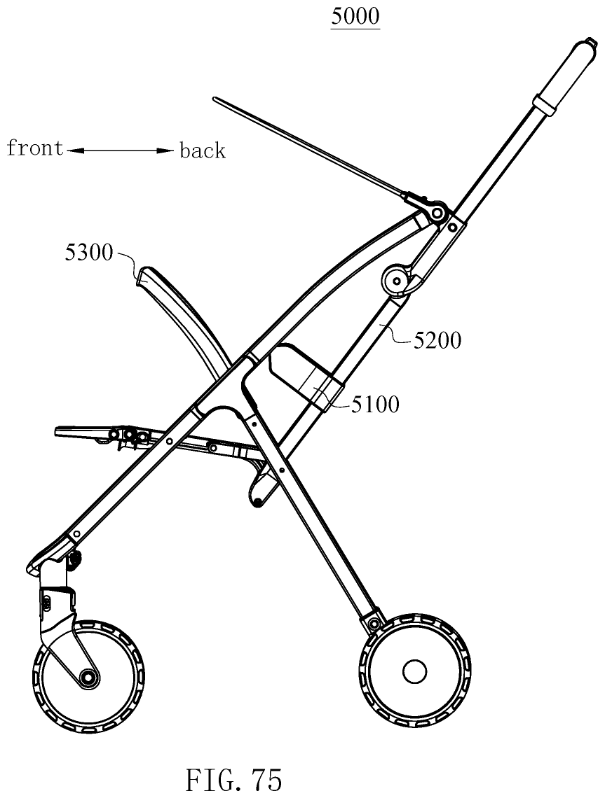

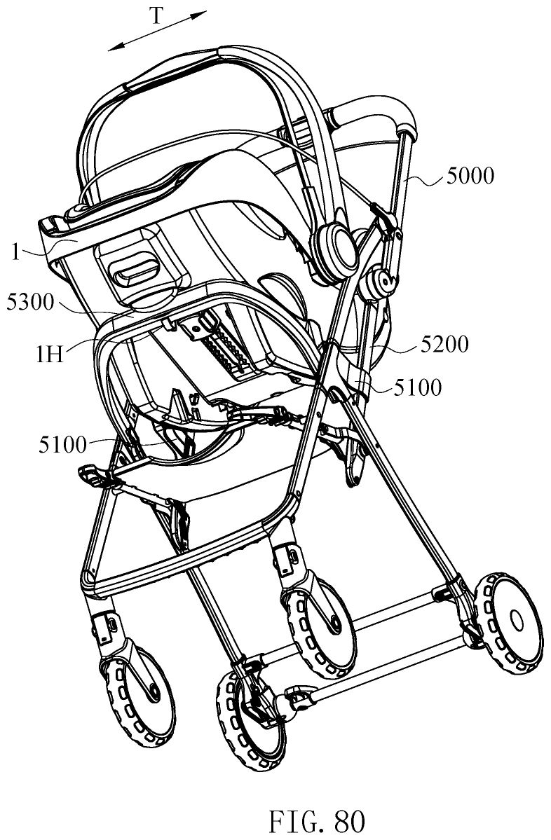

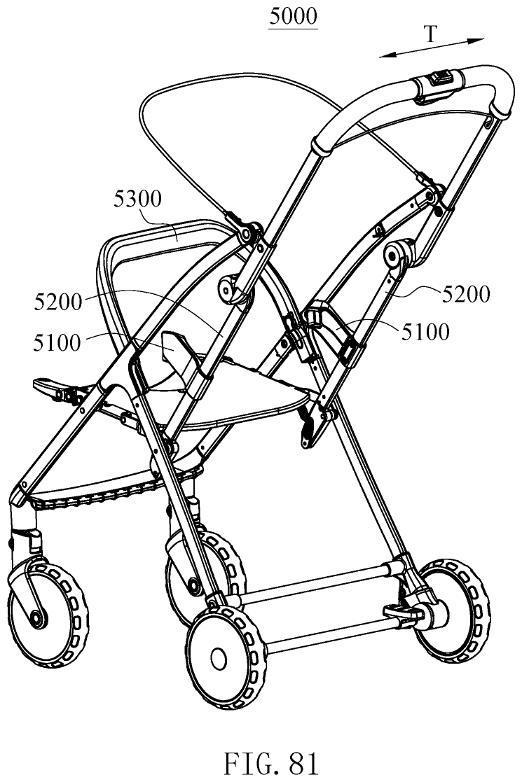

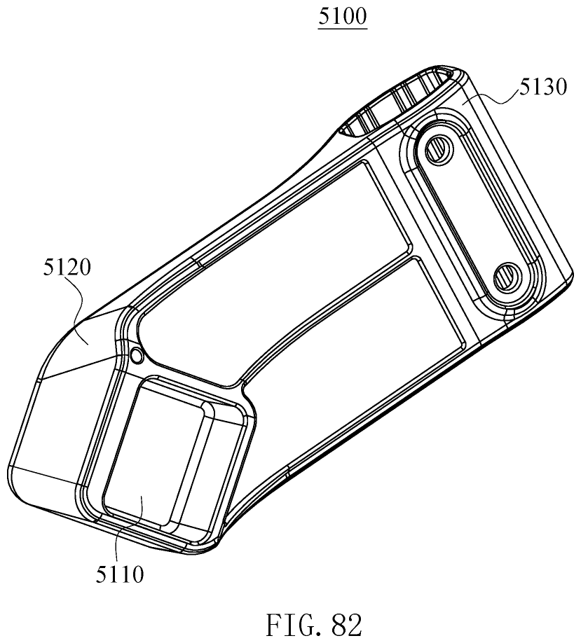

Next, an embodiment of a carrier application device 5000 according to the disclosure will be described with reference to FIGS. 75 to 83.

It should be noted, in the disclosure, the carrier application device 5000 refers to a device where the carrier 1 can be placed or applied. Although the carrier application device 5000 shown in the drawings is a baby stroller, but the disclosure is not limited thereto, the carrier application device 5000 according to the disclosure may also include, but is not limited to, a baby chair for carrying a baby, a child stroller for carrying a child, or cart for carrying articles or animals, or a base which can be connected to a vehicle seat and the like.

In addition, although the carrier 1 shown in the drawings is a baby basket, but the disclosure is not limited thereto, and the carrier 1 according to the disclosure can serve to carry people, animals or articles, including but not limited to a baby basket, a sleeping box, a safety seat, an animal carrying device or an article carrying device and the like.

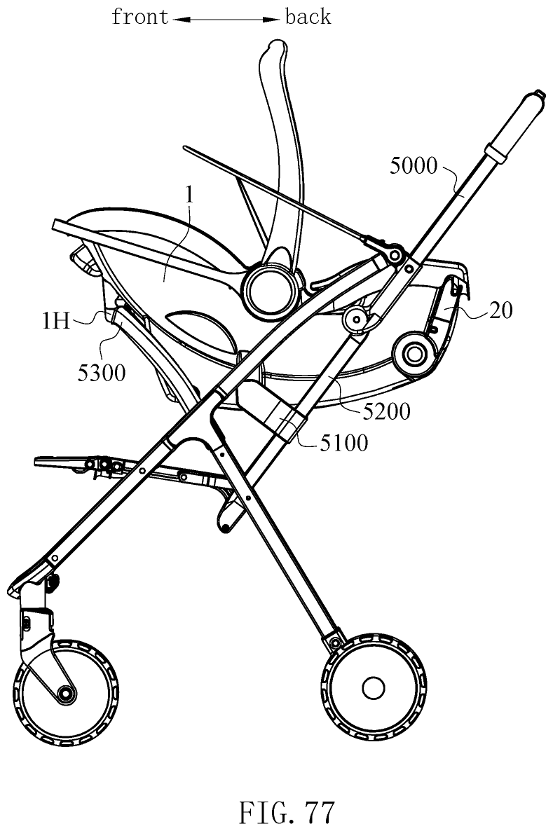

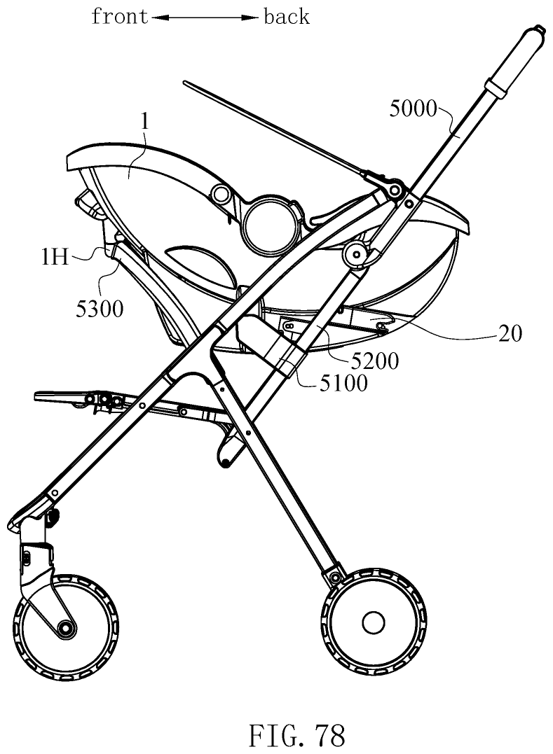

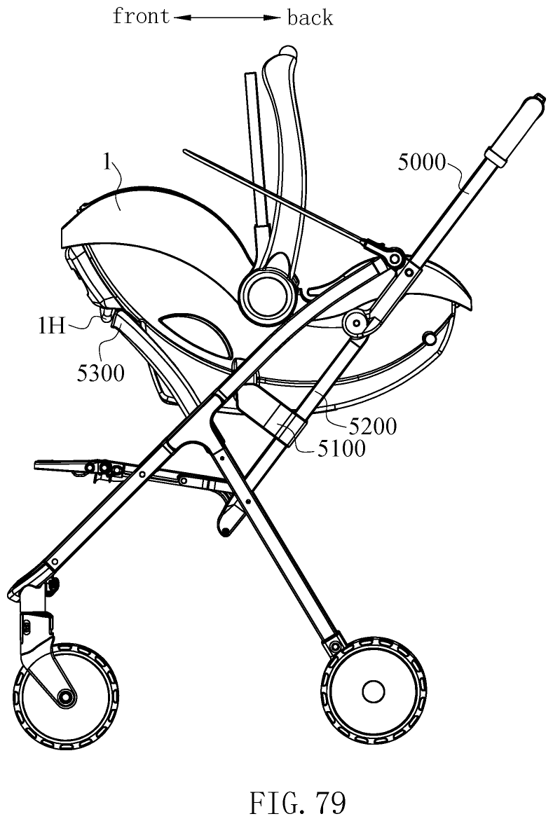

The carrier 1 may have various embodiments, for example, the first embodiment of the carrier 1 has a pivotable anchor joint 20 (see FIG. 77), the second embodiment of the carrier 1 has a retractable anchor joint 20 (see FIG. 78), and the third embodiment of the carrier 1 does not have any anchor joint 20 (see FIG. 79).

For sake of facilitating description, a baby stroller will be taken as an example of the carrier application device 5000, and a baby basket will be taken as an example of the carrier 1.

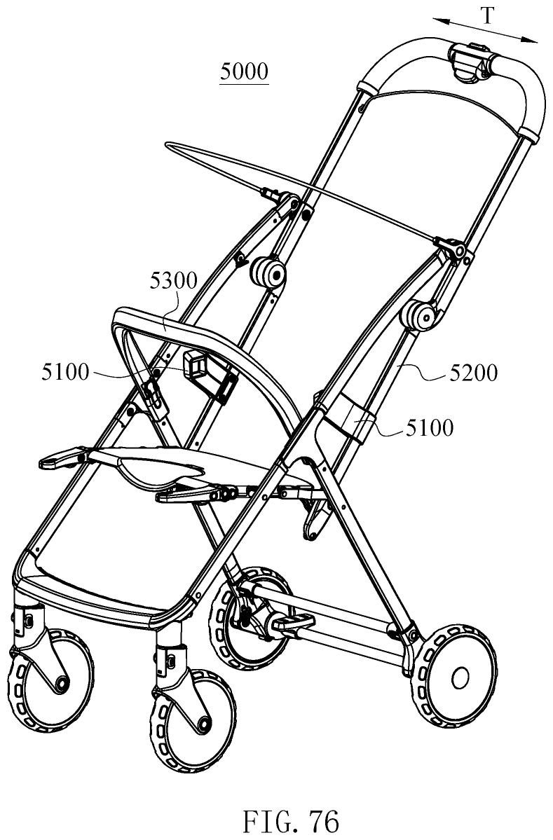

In addition, the direction for a baby in the baby stroller 5000 to face is defined as front, the direction for the baby to face back is defined as back (see FIGS. 75 and 77 to 79), and the left-right direction perpendicular to the front-rear direction is defined as the lateral direction T of the baby stroller 5000 (see FIGS. 76, 80 and 81). Other forms of the carrier application device 5000 may have structures similar to or different from that of the baby stroller.

In order to safely and reliably connect the baby basket 1 to the baby stroller 5000, the baby stroller 5000 includes an application holding part, and the application holding part can be engaged with a carrier holding part on the baby basket 1, such that the baby basket 1 is placed on the baby stroller 5000.

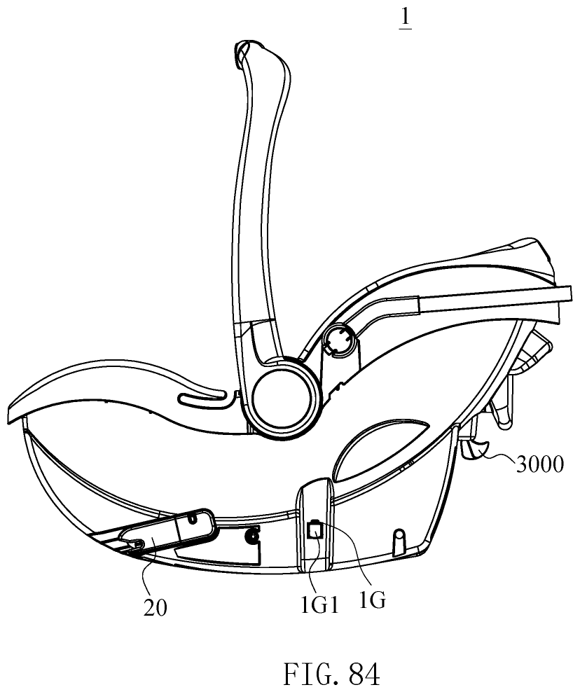

In the embodiment shown in FIGS. 75 to 81, the application holding part includes two lateral application holding parts 5100 arranged along a lateral direction T of the baby stroller 5000. Correspondingly, as shown in FIGS. 84 to 86, the carrier holding part of the baby basket 1 includes two lateral carrier holding parts 1G engaged with the two lateral application holding parts 5100.

In order to realize engagement between the application holding part and the carrier holding part, each of the lateral application holding parts 5100 is provided with a recessed part 5110 (see FIGS. 76, 81, 82), each of the lateral carrier holding parts 1G is provided with a bulged part 1G1 (see FIGS. 84 to 86), and the recessed part 5110 and the bulged part 1G1 can be engaged with each other.

In such case, since the distance between the two lateral application holding parts 5100 s very close to the distance between the two lateral carrier holding parts 1G (to ensure better engagement between the lateral application holding parts 5100 and the lateral carrier holding parts 1G), when the baby basket 1 is placed on the baby stroller 5000, it is relatively difficult for the bulged parts 1G1 of the lateral carrier holding parts 1G to enter the recessed parts 5110 of the lateral application holding parts 5100.

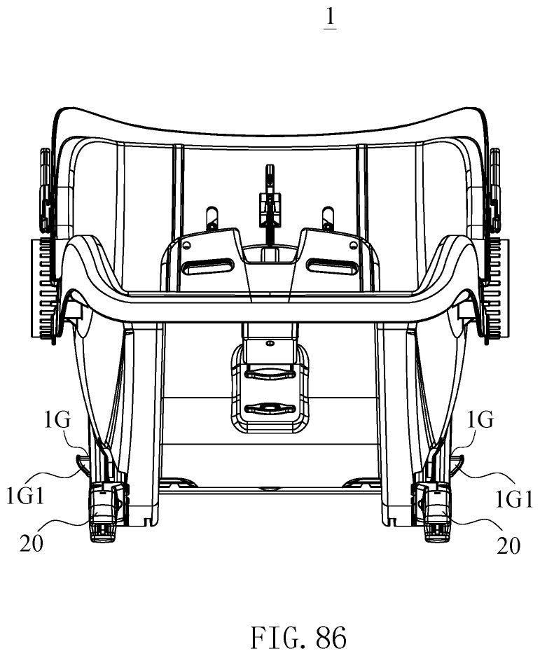

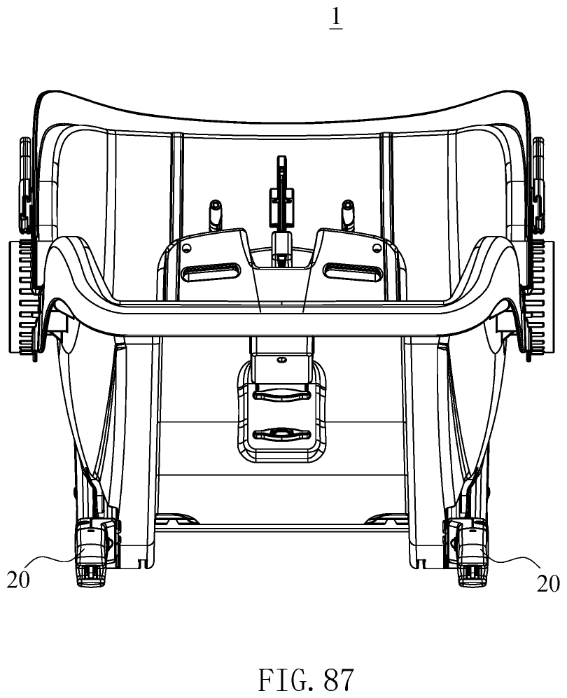

In order to facilitate the bulged parts 1G1 to enter the recessed parts 5110, in the embodiment shown in FIGS. 84 and 86, the bulged parts 1G1 are arranged operable to be extended out or retracted into the baby basket 1. As shown in FIG. 86, when the bulged parts 1G1 is extended out of the baby basket 1, i.e., in the extended position, the distance between the bulged parts 1G1 on the two sides of the baby basket 1 is greater than the distance between the recessed parts 5110 on the two sides of the baby stroller 5000, which makes it difficult for the baby basket 1 to reach a position to be connected to the baby stroller 5000. Furthermore, as shown in FIG. 87, when the bulged parts 1G1 are retracted into the baby basket 1, i.e., in the retracted position, the distance between the bulged parts 1G1 on the two sides of the baby basket 1 becomes smaller than the distance between the recessed parts 5110 on the two sides of the baby stroller 5000, which enables the baby basket 1 to easily reach the position to be connected to the baby stroller 5000. Thus, when the user places the baby basket 1 on the baby stroller 5000, he may firstly operate the bulged parts 1G1 to be retracted into the baby basket 1, such that the baby basket 1 can easily reach the position to be connected to the baby stroller 5000. Then, after the bulged parts 1G1 are aligned with the recessed parts 5110, the bulged parts 1G1 are operated to be extended out of the baby basket 1 and enter the recessed parts 5110, thereby easily completing the engagement between the lateral application holding parts 5100 and the lateral carrier holding parts 1G, so as to hold the baby basket 1 in the position to be connected to the baby stroller 5000.

In an embodiment, the bulged parts 1G1 capable of being extended out or retracted into the baby basket 1 may adopt the connecting posts.

Of course, the disclosure is not limited thereto.

The bulged parts 1G1 capable of being extended out or retracted into the baby basket 1 may take other structures to realize extending and retracting of the bulged parts 1G1. For example, a button (not shown) coupled to the bulged parts 1G1 in moving may be arranged on the baby basket 1, and the bulged parts 1G1 can be retracted into the baby basket 1 by pressing the button.

In addition, each of the lateral application holding parts 5100 of the baby stroller 5000 may be provided with a protuberance, and each of the lateral carrier holding parts 1G of the baby basket 1 may be provided with a recessed part. Moreover, each of the lateral application holding parts 5100 of the baby stroller 5000 may be provided with a protuberance which can be operated to extend out or retract into the baby stroller 5000.

Furthermore, in addition to this engagement of cooperating in concave and convex, the disclosure can also adopt other engagement as cooperating in a guide rail and a guide slot.

The two lateral application holding parts 5100 may be constituted by part of the baby stroller 5000, or may be constituted by separate components mounted on the baby stroller 5000.

In the embodiment shown in FIGS. 75 to 81, the lateral application holding parts 5100 are constituted by separate components mounted on the baby stroller 5000. In this embodiment, each of the lateral application holding parts 5100 constituted by separate components includes a holding part engaging end 5120 and a holding part connecting end 5130.

As shown in FIG. 82, the holding part engaging end 5120 is provided with the recessed part 5110 for engaging with the bulged part 1G1 arranged on the corresponding lateral carrier holding part 1G.

The holding part connecting end 5130 may be connected to a handbar 5200 of the baby stroller 5000 (see FIGS. 75 to 81).

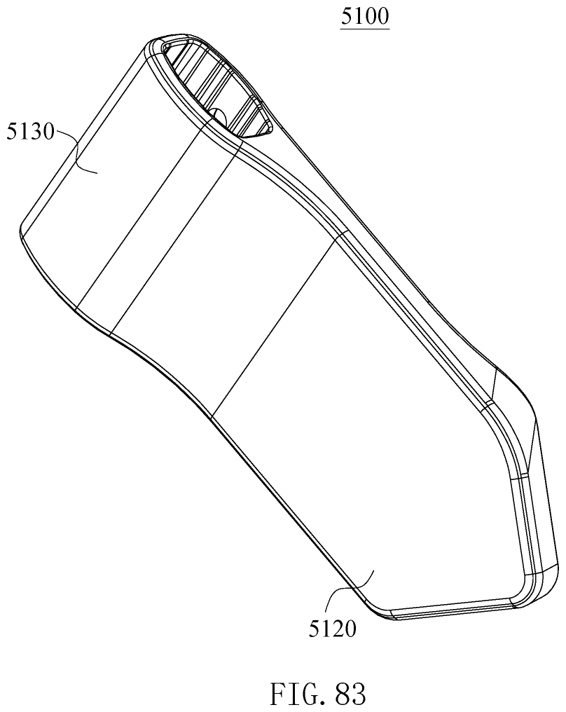

More specifically, as shown in FIGS. 82 and 83, the holding part connecting end 5130 is sleeve-shaped and is sleeved on the handbar 5200 of the baby stroller.

In order to prevent the lateral application holding parts 5100 from sliding up and down along the handbar 5200, a through hole (see FIG. 82) penetrating both the handbar 5200 and the holding part connecting end 5130 can be formed at a connecting part between the handbar 5200 and the holding part connecting end 5130 and a screw or pin can be inserted in the through hole, so as to prevent the holding part connecting end 5130 from moving in respect with the handbar 5200.

Although the handbar 5200 shown in the drawings is a lower handbar, the disclosure is not limited thereto, and the holding part connecting end 5130 may be sleeved on an upper handbar of the baby stroller. In other embodiments, the holding part connecting end 5130 may be connected to other parts of the baby stroller 5000, such as the seat and the like.

By making the recessed parts 5110 on the two sides of the baby stroller 5000 and the bulged parts 1G1 on the two sides of the baby basket 1 be engaged with each other, a two-point connection can be realized between the baby stroller 5000 and the baby basket 1.

In the case of this two-point connection, the baby basket 1 can be placed forward on the baby stroller 5000, that is, the facing direction of the baby in the baby basket 1 is consistent with the forward direction of the baby stroller 5000, such that the visual field direction of the baby is consistent with that of the caregiver. In addition, the baby basket 1 can also be placed on the baby stroller 5000 in a backward direction, that is, the facing direction of the baby in the baby basket 1 is consistent with the backward direction of the baby stroller 5000 (see FIGS. 77 to 79), such that the caregiver can observe the situation of the baby in the baby basket 1 more conveniently.

Of course, the disclosure is not limited thereto. In an embodiment, the application holding part may include two longitudinal application holding parts (not shown) arranged in the front-rear direction of the baby stroller 5000. Correspondingly, the carrier holding part of the baby basket 1 may include two longitudinal carrier holding parts (not shown) respectively engaged with the two longitudinal application holding part.

In yet another embodiment, the application holding part may be a vertical pillar (not shown) arranged on the baby stroller 5000, and the carrier holding part may be a vertical slotted hole (not shown) arranged on the baby basket 1, and by engagement between the vertical pillar and the vertical slotted hole, the baby basket 1 can be placed on the baby stroller 5000.

In the case of the above two-point connection, in order to keep balance in the front-rear direction after the baby basket 1 is placed on the baby stroller 5000, the two lateral carrier holding parts 1G on the baby basket 1 may be arranged in the middle part of the baby basket 1 in the front-rear direction of the baby basket 1. That is, the two lateral carrier holding parts 1G may be arranged as close as possible to the center of gravity of the baby basket 1 in the front-rear direction of the baby basket 1, so as to reduce the tendency of the baby basket 1 to tip over along the front-rear direction.

In order to ensure that the baby basket 1 will not tip over along the front-rear direction after being placed on the baby stroller 5000, the disclosure also provides the following schemes.

In a first scheme, the recessed part 5110 and the bulged part 1G1 are corresponding to each other in shape and size, and are arranged such that the bulged part 1G1 cannot rotate the recessed part 5110.

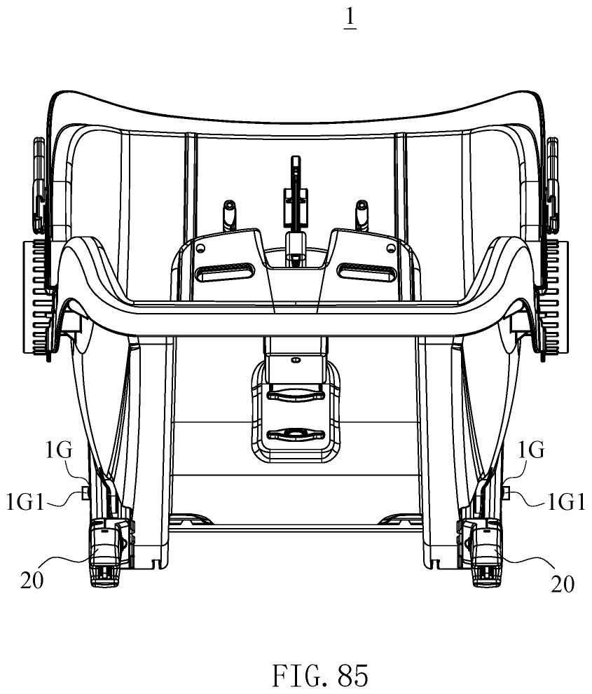

For example, the recessed part 5110 of the application holding part may have a quadrangular opening (see FIG. 82), and the bulged part 1G1 of the carrier holding part is correspondingly a post with a quadrangular bottom (see FIGS. 84 and 85). Moreover, the sizes of the recessed part 5110 and the bulged part 1G1 are also corresponding to each other, i.e., the bulged part 1G1 of the carrier holding part is slightly smaller than the recessed part 5110 of the application holding part in size. Thus, after the bulged part 1G1 is inserted into the recessed part 5110, the bulged part 1G1 cannot rotate inside the recessed part 5110, thereby preventing the baby basket 1 from tipping along the front-rear direction in respect with the baby stroller 5000.

Of course, the disclosure is not limited thereto, and the recessed part 5110 of the application holding part and the bulged part 1G1 of the carrier holding part may also be posts with various polygonal, elliptical or other shapes, as long as it is ensured that the bulged part 1G1 cannot rotate inside the recessed part 5110.

In a second scheme, the application holding part may include a longitudinal application holding part 5300, and the longitudinal application holding part 5300 is spaced apart from the lateral application holding part 5100 along a longitudinal direction of the baby stroller 5000. Correspondingly, the carrier holding part includes a longitudinal carrier holding part 1H capable of being engaged with the longitudinal application holding part 5300.

In the embodiment shown in FIGS. 77 to 80, the longitudinal application holding part 5300 may be an armrest of the baby stroller, and the longitudinal carrier holding part 1H can be engaged with the armrest 5300.

In an embodiment, the longitudinal carrier holding part 1H is arranged to be operable to move between a connected position engaged with the longitudinal application holding part 5300 and a non-connected position disengaged from the longitudinal application holding part 5300.

In yet another embodiment, the longitudinal carrier holding part 1H which can be operated to move between the connected position and the non-connected position may adopt the connecting hook 3000 (see FIG. 84).

Of course, the disclosure is not limited thereto. The longitudinal application holding part 5300 may adopt other components on the baby stroller 5000, or alternatively, a separate component may be disposed on the baby stroller 5000 as the longitudinal application holding part 5300.

Similarly, the longitudinal carrier holding part 1H may adopt other components on the baby basket 1, or alternatively, a separate component may be disposed on the baby basket 1 as the longitudinal carrier holding part 1H.

By engaging the recessed parts 5110 on the two sides of the baby stroller 5000 with the bulged parts 1G1 on the two sides of the baby basket 1, and engaging the longitudinal application holding part 5300 of the baby stroller 5000 with the longitudinal carrier holding part 1H of the baby basket 1, a three-point connection can be realized between the baby stroller 5000 and the baby basket 1, thereby ensuring a more stable connection between the baby stroller 5000 and the baby basket 1.

In the present disclosure, only one of the above first scheme and second scheme may be adopted, or both schemes may be adopted together.

### Engaging Assemblies for Carrier and Carrier Application Device

The carrier 1, e.g., a baby basket and the like, can not only be engaged to a car seat in use, but also be engaged to a child cart in use. For example, the frame of the child cart may be provided with an engagement member such as an adapter and the like, and the carrier 1 is provided with another engagement member which can be locked with the engagement member. Meanwhile, the carrier 1 needs to be provided with an unlocking component, such as an unlocking button, to unlock the two engagement members.

In an embodiment, unlocking needs requires the user to bend down and keep pressing the unlocking button with both hands, and then pull up the carrier 1, such that the carrier 1 is separated from the frame. This mode of unlocking requires the user to bend down and perform operation with both hands, furthermore, both hands of the user have to be kept pressing the unlocking button all the time, and then pull up the carrier 1, so as to unlock and separate the carrier 1 from the frame, which resulting in that the operation is complicated and inconvenient, affecting the user experience.

The disclosure provides an engaging assembly for the carrier 1 and the carrier application device, which can make the disassembly and assembly operation of the carrier 1 and the carrier application device 5000 simpler and more convenient.

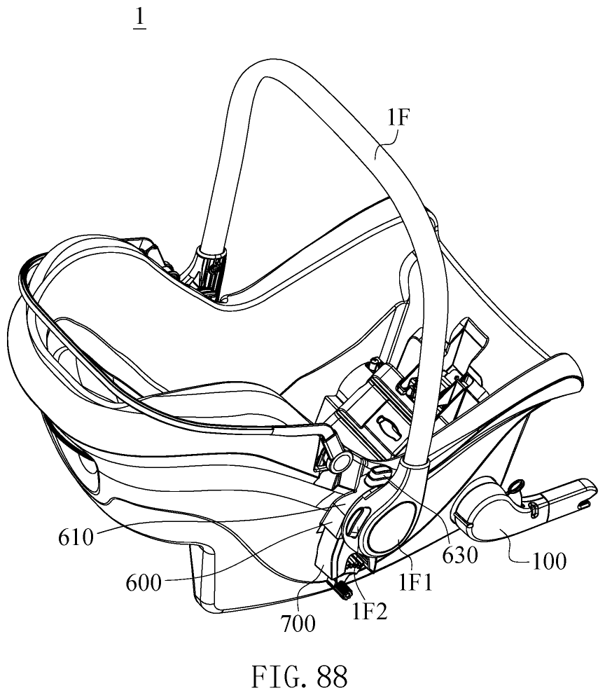

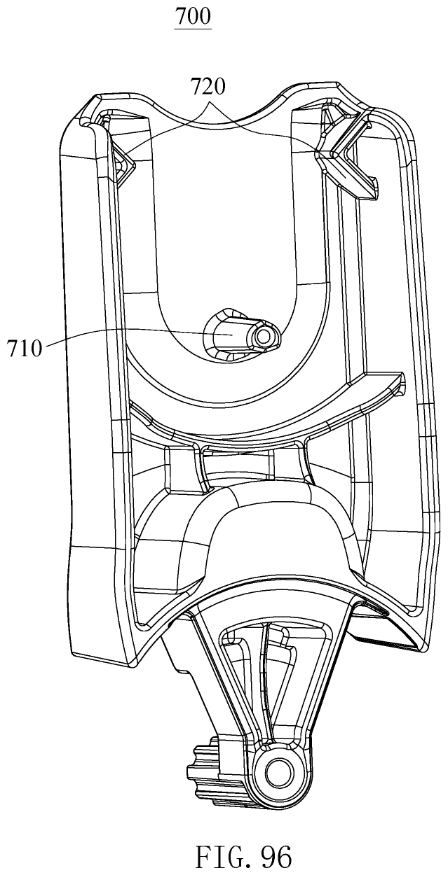

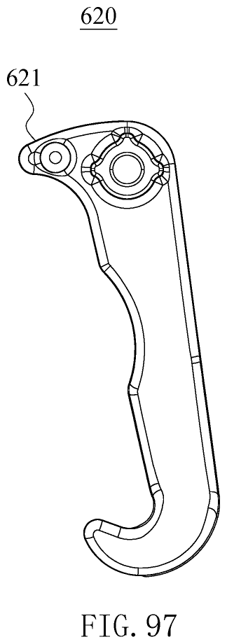

Next, referring to FIGS. 88 to 99, the engaging assembly according to the disclosure for the carrier 1 and the carrier application device will be described.

As previously described, the carrier 1 according to the disclosure can be used for carrying a person, an animal or articles, including but not limited to a baby basket, a sleeping box, a safety seat, an animal carrying device, or an article carrying device and the like. The carrier application device according to the disclosure refers to a device in which the carrier 1 can be placed or applied, including but not limited to a baby stroller for carrying a baby, a baby chair, a child stroller for carrying a child, or a cart carrying articles or animals, or a base that can be connected to a vehicle seat, etc.

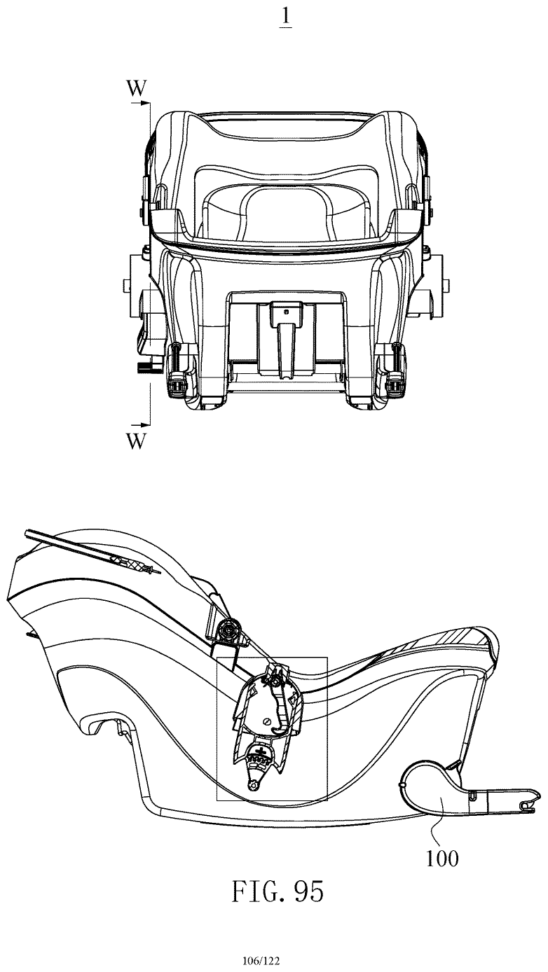

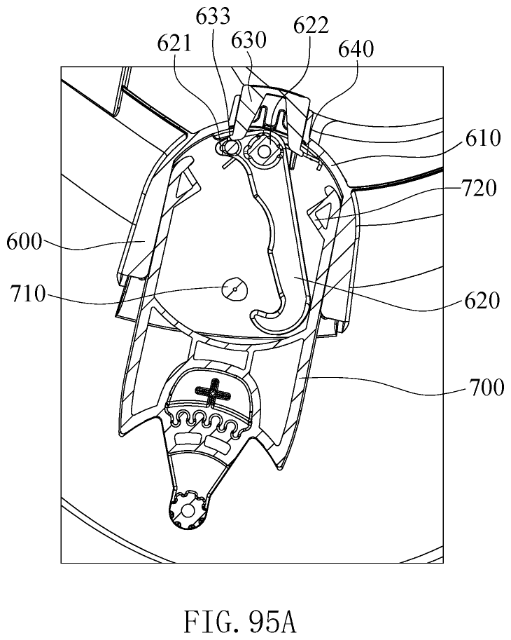

For sake of facilitating description, for the embodiment shown in FIGS. 88 and 95, a baby basket with a pivoting part 100 will be taken as an example of the carrier 1.

In addition, in order to show the engaging assembly more clearly, FIGS. 88 and 95 do not show the carrier application device, but only show the engagement member which can be arranged on the carrier application device. However, it should be understood, the carrier 1 can be detachably mounted on the carrier application device via the engaging assembly.

As shown in FIGS. 88 and 95, the engaging assembly includes a first engaging member 600 and a second engaging member 700 capable of being engaged with each other (e.g., plugged and unplugged) and capable of being locked. Among them, one of the first engaging member 600 and the second engaging member 700 is arranged on the carrier 1, and the other is arranged on the carrier application device. The engagement and separation between the carrier 1 and the carrier application device is realized by engagement and separation between the first engaging member 600 and the second engaging member 700.

In the embodiment shown in FIGS. 88 and 95, the description will be made by taking the first engaging member 600 arranged on the carrier 1 and the second engaging member 700 arranged the carrier application device as examples. However, it should be understood, the first engaging member 600 may arranged be arranged on the carrier application device, and the second engaging member 700 may arranged be arranged on the carrier, which can also realize that the carrier 1 is detachably mounted on the carrier application device.

The first engaging member 600 according to the disclosure may include a first member body 610, a first locking member 620, a first unlocking button 630, and a first holding member.

Among them, the first member body 610 is arranged capable of accommodating a part of the second engaging member 700. For example, the first member body 610 has an opened cavity structure, so as to realize engagement between the first engaging member 600 and the second engaging member 700, so as to ensure that the carrier 1 can be stably mounted on the carrier application device.

In an embodiment, as shown in FIG. 88, a handle mounting seat 1F1 of the handle 1F can be mounted on an outer side of the first member body 610, so as to facilitate the user to lift the carrier 1 through the handle 1F.

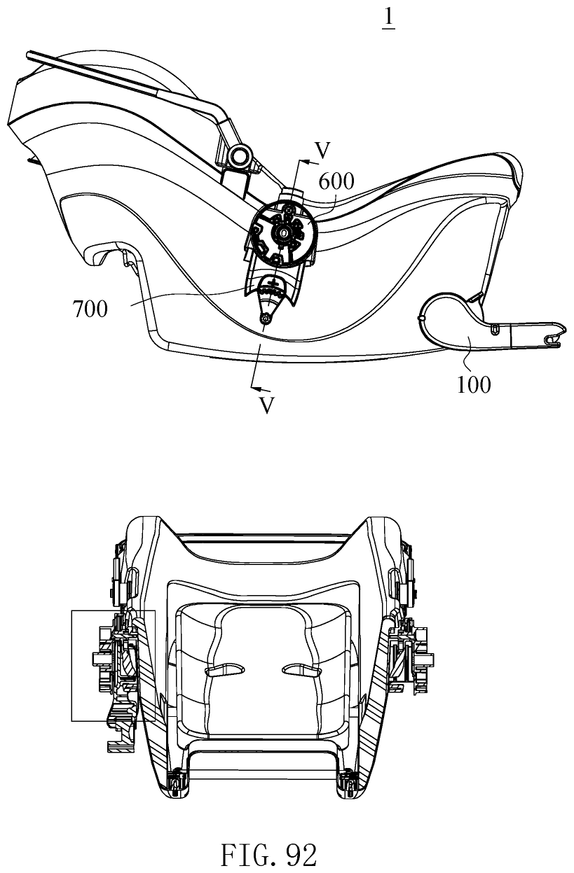

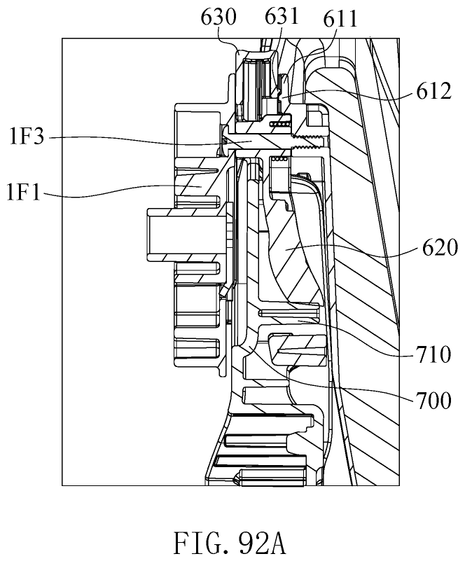

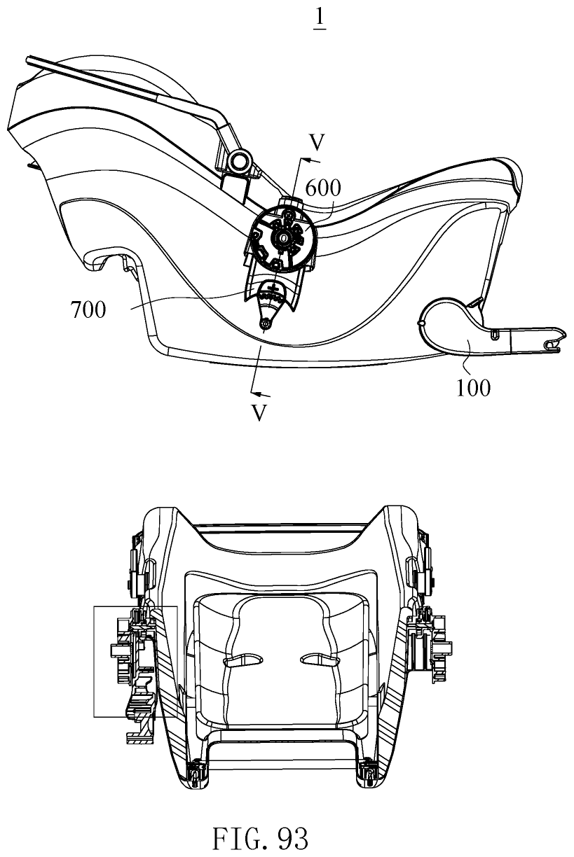

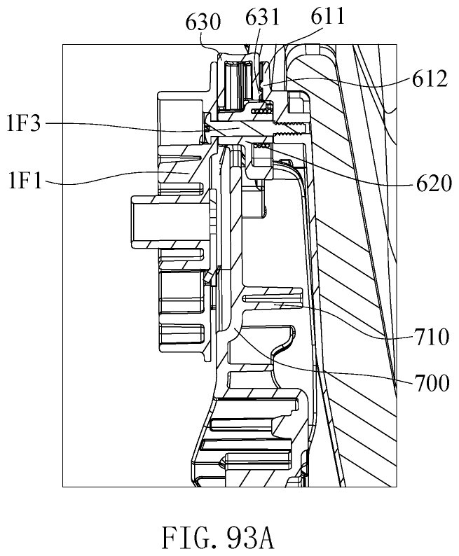

As shown in FIGS. 92A and 93A, by making the handle fixing member 1F3 such as a bolt or a rivet and the like sequentially pass through the handle mounting seat 1F1 and the first locking member 620 and be fixed to the carrier 1, the handle mounting seat 1F1 and the first engaging member 600 can be fixed to the carrier 1.

In addition, as shown in FIG. 88, the handle mounting seat 1F1 may be provided with a handle rotating button 1F2. The user can adjust rotation angle of the handle 1F in respect with the carrier 1 after pressing the handle rotating button 1F2.

The first locking member 620 serve to realize locking and unlocking between the first engaging member 600 and the second engaging member 700, such that locking and unlocking between the carrier 1 and the carrier application device can also be realized, so as to ensure that the carrier 1 can be stably placed on the carrier application device and can be conveniently removed.

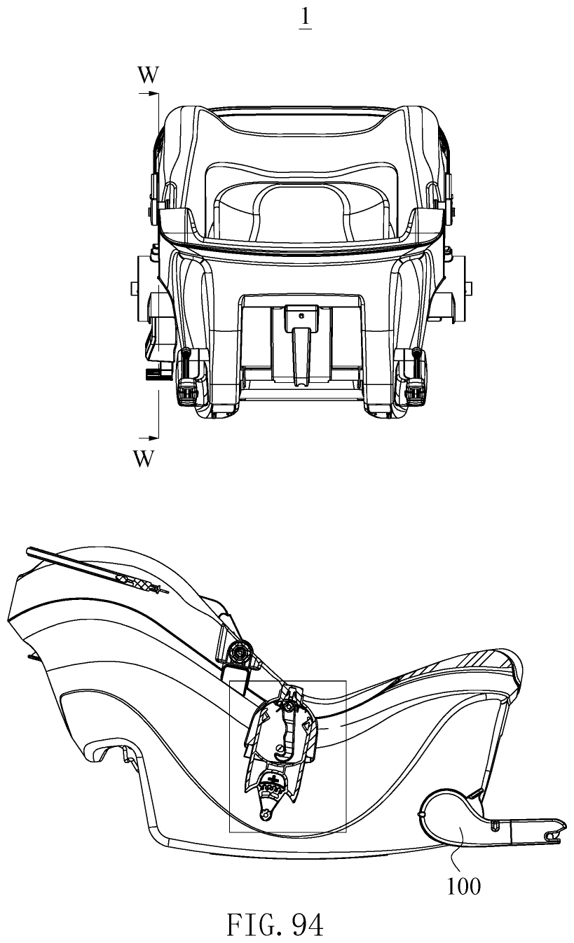

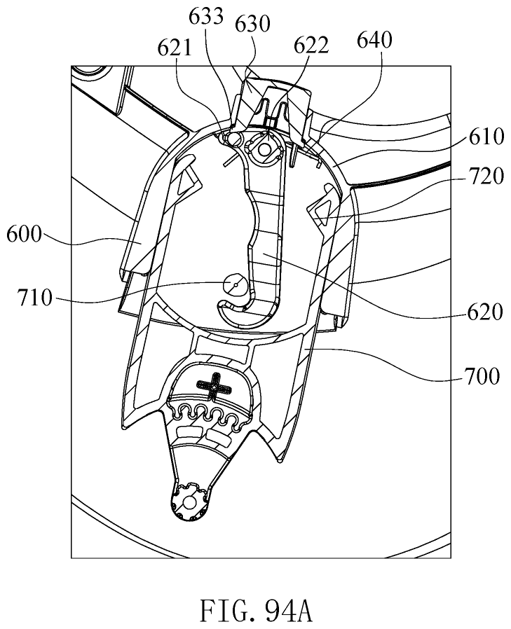

Specifically, as shown in FIGS. 94 to 95A, the first locking member 620 is movably arranged on the first member body 610. Moreover, the first locking member 620 has a locked position (see FIG. 94A) to be locked with a second locking member 710 arranged on the second engaging member 700 and an unlocked position (see FIG. 95A) to be unlocked from the second locking member 710.

As shown in FIGS. 94A and 95A, the first member body 610 may be provided with a notch communicating with the cavity structure therein, and the first locking member 6200 is arranged facing the notch.

In the embodiment shown in FIGS. 94 to 95A, the second locking member 710 is a locking post arranged on the second engaging member 700, and the first locking member 620 is a locking hook pivotably connected to the first member body 610 and capable of hooking the locking post 710. For example, the second engaging member 700 is internally provided with a connecting cavity for the locking hook 620 to be inserted therein, and the locking post 710 can be arranged in the connecting cavity. When the first engaging member 600 is engaged with the second engaging member 700, the locking hook 620 is inserted into the connecting cavity and is kept locked with the locking post 710.

As shown in FIG. 94A, when the locking hook (i.e., the first locking member) 6200 is in the locked position, it hooks the locking post (i.e., the second locking member) 710, thereby making the first engaging member 600 and the second engaging member 700 to be locked to each other.

As shown in FIG. 95A, when the locking hook (i.e., the first locking member) 620 is in the unlocked position, it is separated from the locking post (i.e., the second locking member) 710, thereby unlocking the first engaging member 600 from the second engaging member 700. At this time, the user can move the carrier 1 away from the carrier application device only by lifting the carrier 1 upward through the handle 1F, such that the first engaging member 600 is separated from the second engaging member 700.

In order to avoid risk caused by accidental unlocking between the first engaging member 600 and the second engaging member 700, and at the same time, to save the user's operation to make the first locking member 620 move toward the locked position, the first engaging member 600 may include a first locking member elastomer 640 which is arranged to drive the first locking member 620 to the locked position, that is, tend to make the first locking member 620 move toward the locked position.

Thus, under the condition that the first engaging member 600 and the second engaging member 700 are engaged with each other, the first locking member 620 will move to the locked position under acting force of the first locking member elastomer 640 and remain in the locked position, until the user exerts a force on the first locking member 620 to make it overcome the elastic force of the first locking member elastomer 640 and move to the unlocked position.

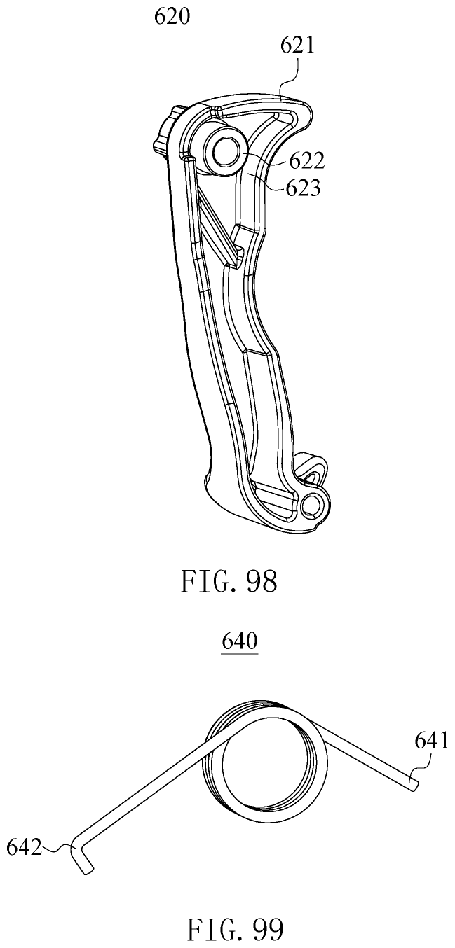

In the embodiment shown in FIGS. 94A and 95A, the first locking member 620 has a locking member mounting post 622 (see FIG. 98), and the first locking member elastomer 640 is a torsion spring arranged around the locking member mounting post 622. The torsion spring 640 has a first end 641 (see FIG. 99) abutting against an inner wall 623 (see FIG. 98) of the first locking member 620, and a second end 642 (see FIG. 99) abutting against an inner wall of the first member body 610.

As shown in FIG. 98, a through hole for the handle fixing member 1F3 to pass therethrough is arranged in the locking member mounting post 622 of the first locking member 620, such that the first locking member 620 can be pivoted around the handle fixing member 1F3.

Of course, the disclosure is not limited thereto.

In other embodiments, the first locking member elastomer 640 may be other elastic member such as a tension spring or a hydraulic post, as long as it can drive the first locking member 620 to move to the locked position.

Or alternatively, the first engaging member 600 may not be provided with the first locking member elastomer 640, but drive the first locking member 620 to move to the locked position in other ways, such as pushing the first locking member 620 by the second member pushing part 720 (to be described late) of the second engaging member 700.

In addition, the first locking member 620 and the second locking member 710 may also adopt other cooperating structures other than a locking hook and a locking post, for example, a cooperating structure of a locking hook and a locking hole may be adopted.

In addition, the movement of the first locking member 620 in respect with the first member body 610 may also be a sliding movement, or a combined movement of a pivoting movement and a sliding movement.

In order to facilitate the user to exert force to the first locking member 620 to move it to the unlocked position, the first unlocking button 630 is movably arranged on the first member body 610 and interact with the first locking member 620, such that the first unlocking button 630 can drive the first locking member 620 to move to the unlocked position. That, the first unlocking button 630 and the first locking member 620 are arranged to be linked moving. Therefore, the first unlocking button 630 has a non-working position (see FIG. 92A) allowing the first locking member 620 to be in the locked position and a working position (see FIG. 93A) allowing the first locking member 620 to be in the unlocked position. Among them, when the first unlocking button 630 is in the non-working position, it does not exert force on the first locking member 620, so the first locking member 620 can be kept in the locked position under action of the elastic force of the first locking member elastomer 640. When the first unlocking button 630 moves toward the working position, it exerts a force on the first locking member 620, such that the first locking member 620 overcome the elastic force of the first locking member elastomer 640 to move toward the locked position.

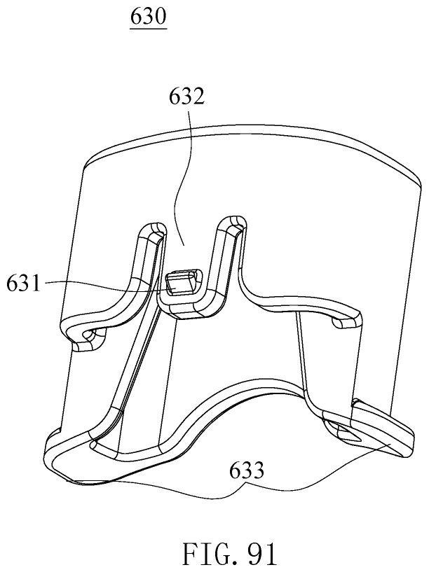

In the embodiments shown in FIGS. 91, 94A, 95A, 97 and 98, the first locking member 620 has a locking member pushing part 621, and the first unlocking button 630 has a button pushing part 633. The button pushing part 633 is arranged capable of exerting a force on the locking member pushing part 621, so as to drive the first locking member 620 to be pivoted to the unlocked position.

When the user presses down the first unlocking button 630 to move it toward the working position, the button pushing part 633 exerts a force on the locking member pushing part 621, such that the first locking member 620 is pivoted to the unlocked position (see FIG. 95A). Then, the first engaging member 600 is unlocked from the second engaging member 700.

When the user no longer presses down the first unlocking button 630, if the first engaging member 600 includes the first locking member elastomer 640, the first locking member 620 will be pivoted to the locked position under action of the elastic force of the first locking member elastomer 640. Then, the locking member pushing part 621 will exert a force on the button pushing part 633, thereby driving the first unlocking button 630 to move upward to the non-working position (see FIG. 94A).

However, once the user no longer presses down the first unlocking button 630, the first locking member 620 will be pivoted to the locked position under action of the elastic force of the first locking member elastomer 640, which will make the user have to keep pressing the first unlocking button 630 with both hands all the time, and then lift the carrier 1 upward before moving the carrier 1 away from the carrier application device, resulting in complicated and inconvenient operations, and affecting the user experience.

In order to solve such problem, the first engaging member 600 according to the disclosure further includes a first holding member. The first holding member is arranged capable of holding the first unlocking button 630 in the working position, so as to make the first locking member 620 be held in the unlocked position.

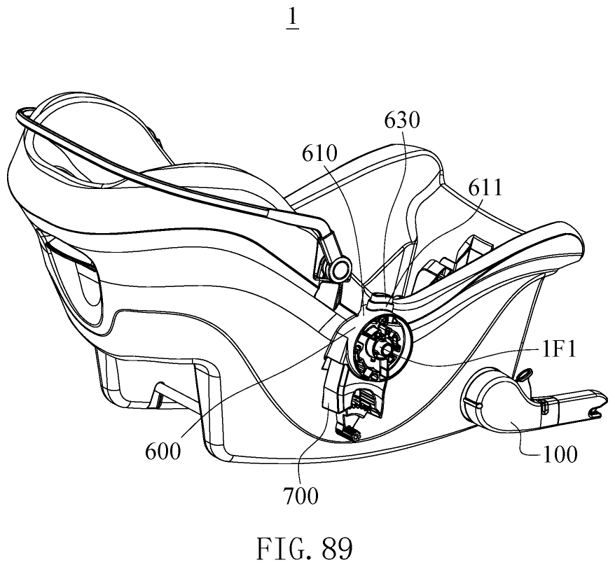

In the embodiment shown in FIGS. 89 to 93A, the first member body 610 is provided with a first button mounting slot 611 for the first unlocking button 630 to move therein. the first button mounting slot 611 penetrates through the first member body 610, such that one part of the first unlocking button 630 can be exposed outside the first member body 610 for the user to perform an operation such as pressing and the like, and the other part can be inserted into the first member body 610 to be abutting against the first locking member 620. As shown in FIGS. 91, 94A and 95A, a cross-sectional area of the part of the first unlocking button 630 inserted into the first member body 610 may be formed to be larger than a notch cross-sectional area of the first button mounting slot 611, for example, the button pushing part 633 may be formed in an enlarged bell mouth shape, so as to prevent the first unlocking button 630 from being accidentally separated from the first button mounting slot 611.

The first holding member includes a mounting slot holding part 612 arranged in the first button mounting slot 611 and a button holding part 631 arranged on the first unlocking button 630. The button holding part 631 is arranged can be elastically obstructed by the mounting slot holding part 612, such that the first unlocking button 630 is held in the working position.

In the disclosure, “being elastically obstructed” means that when the force driving the first unlocking button 630 to move in the first button mounting slot 611 increases to such an extent that at least one of the mounting slot holding part 612 and the button holding part 631 abutting against each other elastically retreats backward, the button holding part 631 can pass over the mounting slot holding part 612, thereby allowing the first unlocking button 630 to move to a desired position in the first button mounting slot 611; moreover, when the user's force to drive the first unlocking button 630 to move in the first button mounting slot 611 is not enough to make at least one of the mounting slot holding part 612 and the button holding part 631 abutting against each other retreat backward, the button holding part 631 cannot pass over the mounting slot holding part 612, such that the first unlocking button 630 can be restricted from moving to the required position in the first button mounting slot 611.

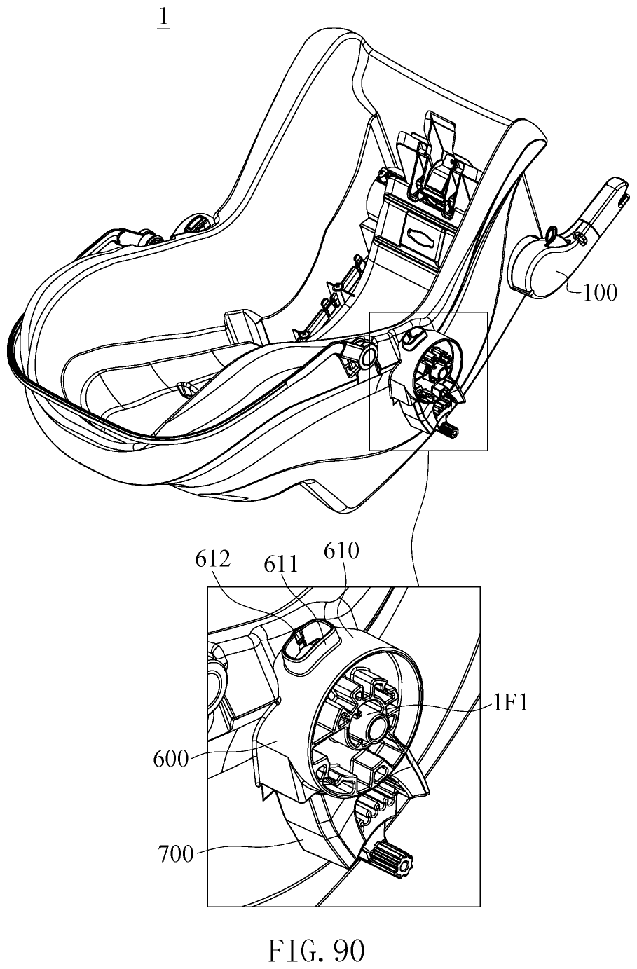

In the embodiment shown in FIGS. 90 and 91, the mounting slot holding part 612 is a limiting rib arranged on the inner wall of the first button mounting slot 611, and the button holding part 631 is a holding bulge arranged on a button elastic arm 632 of the first unlocking button 630. Among them, the button elastic arm 632 of the first unlocking button 630 enables the holding bulge 631 as the button holding part to elastically retreat backward, thereby realizing that the button holding part 631 can be elastically obstructed by the mounting slot holding part 612.

However, the disclosure is not limited thereto.

In other embodiments, the button holding part 631 may be a holding bulge arranged on an outer wall of the first unlocking button 630, and the mounting slot holding part 612 may be a spring sheet arranged on an inner wall of the first button mounting slot 611, the spring sheet and the holding bulge can abut against each other to restrict the first unlocking button 630 from moving to a desired position in the first button mounting slot 611. when the user's force to drive the first unlocking button 630 to move in the first button mounting slot 611 increases to a certain extent, the spring sheet as the mounting slot holding part 612 will retreat, such that the holding bulge will pass over the spring sheet, thereby allowing the first unlocking button 630 to move to the desired position in the first button mounting slot 611.

Next, the working process of the first engaging member 600 including the first holding member according to the disclosure will be described.

As shown in FIG. 95A, when the user prepares to move the carrier 1 away from the carrier application device, he needs to unlock the first engaging member 600 from the second engaging member 700, and exerts a downward pressing force to the first unlocking button 630 in the non-working position. Then, the first unlocking button 630 moves downward, such that the button holding part 631 and the mounting slot holding part 612 abut against each other. When the force of the user pressing the first unlocking button 630 increases to such an extent that the button holding part 631 on the button elastic arm 632 elastically retreats backward, the button holding part 631 can pass over the mounting slot holding part 612, thereby allowing the first unlocking button 630 to move to the working position in the first button mounting slot 611. In this process, the first unlocking button 630 moving downwardly will drive the first locking member 620 to overcome the elastic force of the first locking member elastomer 640 to move to the unlocked position, thereby realizing unlocking between the first engaging member 600 and the second engaging member 700.

Afterward, when the user no longer presses down the first unlocking button 630, the elastic force of the first locking member elastomer 640 will drive the first locking member 620 to move toward the locked position. Then, the first locking member 620 will in turn drive the first unlocking button 630 to move upward, such that the button holding part 631 and the mounting slot holding part 612 are abutting against each other again. However, since the elastic force of the first locking member elastomer 640 is not enough to make the button holding part 631 on the button elastic arm 632 elastically retreat backward, the button holding part 631 cannot pass over the mounting slot holding part 612, so the first unlocking button 630 can be restricted from being held in the working position in the first button mounting slot 611, and therefore the first locking member 620 is held in the unlocked position, and the first engaging member 600 is held to be unlocked from the second engaging member 700. Thus, does not need to press the first unlocking button 630 all the time, but only needs to lift the carrier 1 upward, such that the first engaging member 600 is disengaged from the second engaging member 700, and the carrier 1 can be removed from the carrier application device.

After the carrier 1 is removed from the carrier application device, the user needs to return the first locking member 620 to the locked position, so as to prepare for the next placement and locking of the carrier 1 on the carrier application device. Since the first engaging member 600 and the second engaging member 700 are disengaged at this time, the first locking member 620 of the first engaging member 600 is exposed outside, which enables the user to manually pluck the first locking member 620 and drive it to move toward the locked position. Then, the first locking member 620 will drive the first unlocking button 630 to move upward, such that the button holding part 631 and the mounting slot holding part 612 abut against each other. When the user exerts enough force on the first locking member 620 to make the button holding part 631 on the button elastic arm 632 elastically retreat backward, the button holding part 631 can pass over the mounting slot holding part 612, thereby allowing the first locking member 620 to move to the locked position. Meanwhile, the first unlocking button 630 moves to the non-working position in the first button mounting slot 611.

In order to avoid the user from forgetting to operate the first locking member 620 to return it to the locked position after removing the carrier 1 from the carrier application device, the disclosure provides an auxiliary mechanism which can urge the first locking member 620 to return to the locked position without the user's deliberate operation. In the embodiments shown in FIGS. 94A, 95A and 96, the second engaging member 700 may be provided with a second member pushing part 720. The second member pushing part 720 is arranged to be a bulged part bulged from the inner wall of the second engaging member 700 toward the first locking member 620, and can act on the first locking member 620 to make it to be pivoted to the locked position during the separation process of the first engaging member 600 and the second engaging member 700 (i.e., during the process for the carrier 1 to be removed from the carrier application device). In this process, the locking member pushing part 621 of the first locking member 620 will exert a force on the button pushing part 633 of the first unlocking button 630, such that the first locking member 620 drives the first unlocking button 630 to return to the non-working position.

### Abutting Structure and Carrying Device

In use, a carrier such as a child safety seat or a baby car safety seat and the like needs to be stably arranged in a car, for example, usually on a seat of the car. For this, some existing carriers such as child safety seats or baby car safety seats are arranged with an engagement structure such as ISOFIX (a standard fixing accessary), so as to engage the child safety seat or baby car safety seat to a vehicle seat such as a car seat. However, due to size differences of various cars, after the engagement structure is engaged to a vehicle seat, there may be a distance between the child safety seat and a backrest of the vehicle seat, or between the baby car safety seat and the backrest of the vehicle seat, which will cause the problem that the carrier such as the child safety seat or the baby car safety seat shakes or is overturned, resulting in potential safety hazards.

For this, the disclosure also provides an abutting structure and a carrying device comprising the abutting structure.

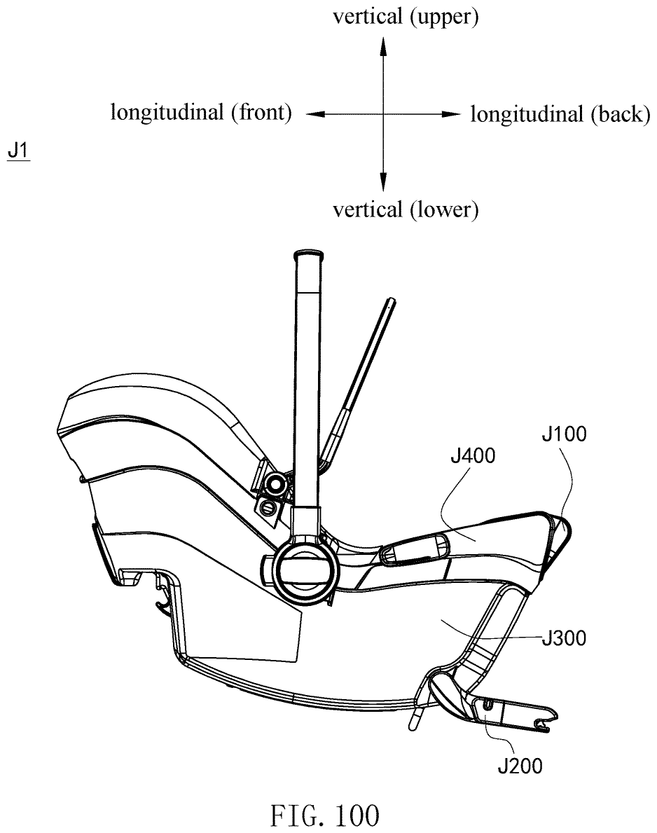

Referring to FIGS. 100 to 102, the carrying device according to the disclosure (a first object J1, e.g., a carrier) will be generally described hereinafter. In this embodiment, the first object J1 is a baby car safety seat, which can be installed in a vehicle seat such as a car seat (a second object J2), or can be used alone. In other embodiments, the first object J1 may be a child safety seat, a sleeping box or other suitable carrying device or carrier. The disclosure can also be applied to a structure with a base, in which an abutting structure J100 can be disposed on a base part or a seat part.

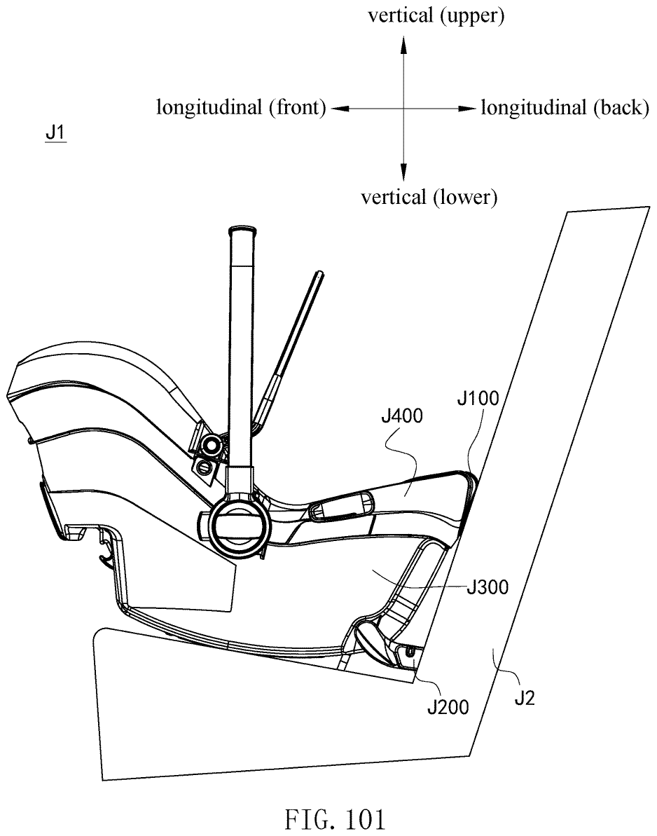

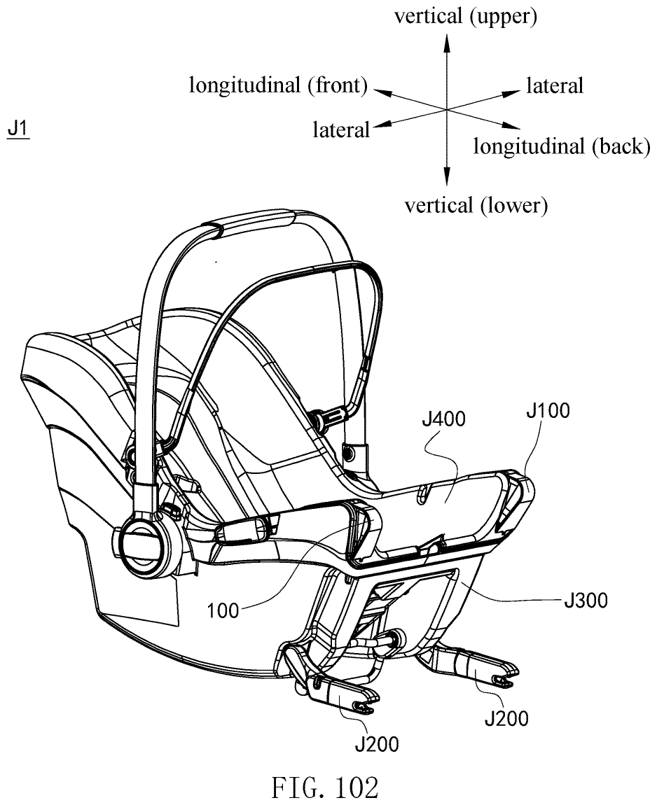

The first object J1 includes a seat body J300 and a carrying part J400 arranged above the seat body J300. The seat body J300 is made of a relative hard material, such as plastic, and the carrying part J400 is made of a relative soft material, such as foamed material. In other embodiments, the seat body J300 and the carrying part J400 may be one part. At least one engagement structure J200 is arranged on the seat body J300, so as to engage the first object J1 to the second object J2. At least one abutting structure J100 is arranged on the seat body J300 or the carrying part J400, so as to fill a gap between the seat body J300 or the carrying part J400 and the second object J2. More specifically, the abutting structure J100 is arranged at an upper end of a rear part of the first object J1, so as to be adjacent to a backrest part of the second object J2, i.e., the vertical part of the second object J2 shown in FIG. 101. Referring to FIG. 102, in this embodiment, two abutting structures J100 are respectively arranged on both lateral sides of the first object J1. In other embodiments, there may be only one abutting structure J100 or more than two abutting structures J100 provided.

As shown in FIG. 101, since the backrest part of the second object J2 may have a different angle or shape, the gap between the seat body J300 or the carrying part J400 and the second object J2 is variable. The abutting structure J100 of the disclosure can adapt to different gaps to abut the first object J1 against the backrest part of the second object J2, so as to avoid shaking or overturning between the first object J1 and the second object J2, thereby improving comfort and safety of the baby or child sitting on the first object J1.

It should be understood, although in this embodiment, both the engagement structure J200 and the abutting structure J100 are arranged in the seat body J300, the disclosure is not limited to thereto, and the abutting structure J100 can be arranged in the seat body J300 or the carrying part J400, while the engagement structure J200 can also be arranged in the seat body J300 or the carrying part J400.

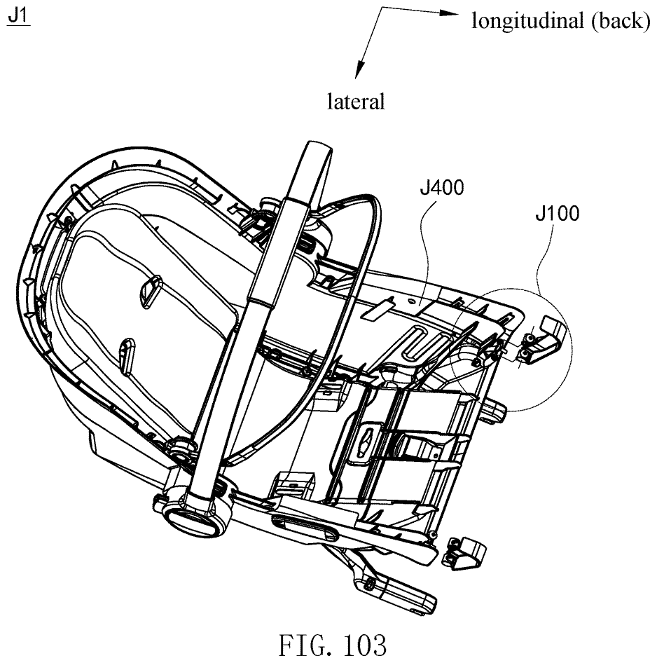

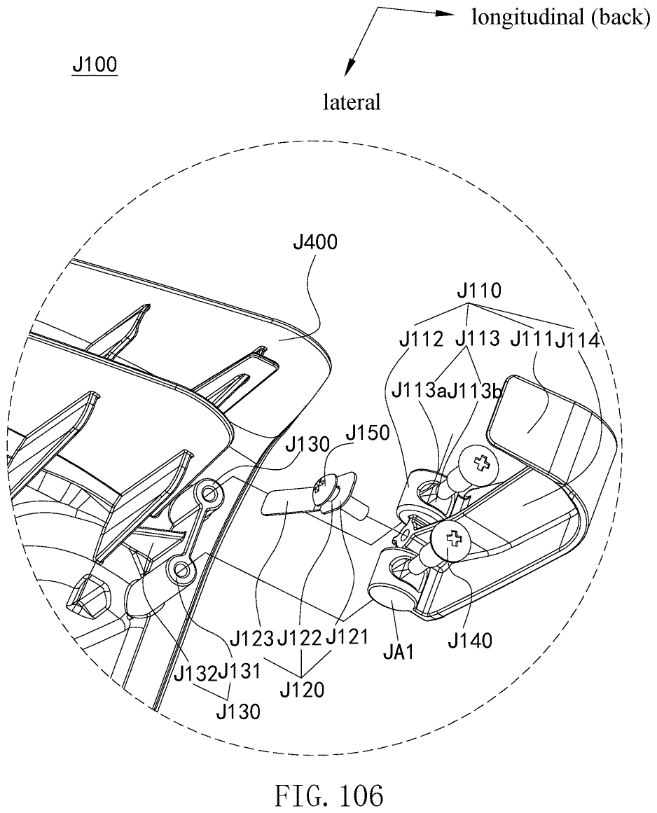

Referring to FIGS. 103 to 106, the abutting structure J100 according to the disclosure will be described. The abutting structure J100 includes a base part J130, an abutting member J110, a biasing member J120, a first engagement member J140, and a second engagement member J150.

The base part J130 is arranged to the first object J1 and integrally formed with the first object J1, that is, the base part J130 is fixed in respect to the first object J1. More specifically, in this embodiment, the base part J130 is disposed at an upper end of a rear side of the first object J1, so as to stably abut the abutting member J110 against the second object J2. It should be understood, in other embodiments, the base part J130 may also be an independent component and assembled to the first object J1.

The base part J130 includes an opened hole J131 and a ramp J132. The opened hole J131 is a part for the first engagement member J140 to be inserted and fixed, and an axial direction of the opened hole J131 extends obliquely upward. It should be understood, the axial direction of the opened hole J131 can also extend in another direction or be arranged in other appropriate forms, as long as the first engagement member J140 can be inserted and fixed. In this embodiment, two first engagement members J140 are provided, so the base part J130 is correspondingly provided with two opened holes J131. In other embodiments, number of the opened holes J131 may be changed according to number of the first engagement members J140.

The ramp J132 extends in a direction substantially perpendicular to a first pivoting axis JA1 (a pivoting axis of abutting member J110). More specifically, the ramp J132 extends from the opened hole J131 (or from a position between the two opened holes J131) toward an inner side of the carrying part J400 of the first object J1, and gradually extends downward in a direction toward the inner side of the carrying part J400, i.e., gradually extends away from the abutting member J110. It should be understood, the ramp J132 can also be arranged in other appropriate forms, as long as it can serve as an abutment surface of an abutting part J123.

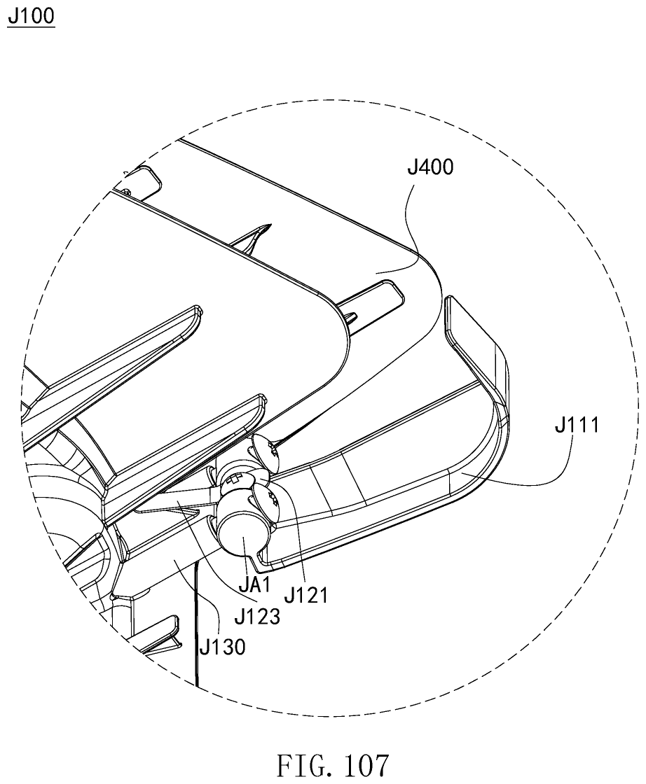

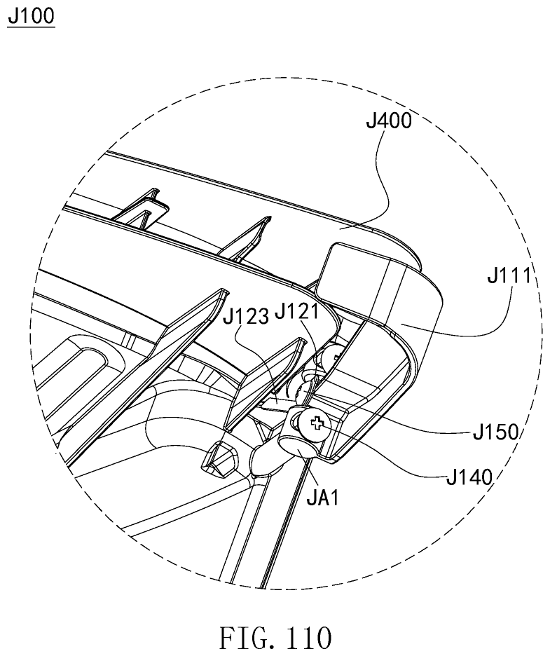

The abutting member J110 is mounted to the base part J130, and can be pivoted around the first pivoting axis JA1 in respect to the base part J130 between a folded position (FIG. 110) and an extended position (FIG. 107) and abut against the second object J2. It should be understood, the abutting member J110 may abut against the second object J2 at the folded position, the extended position, or any position between the folded position and the extended position.

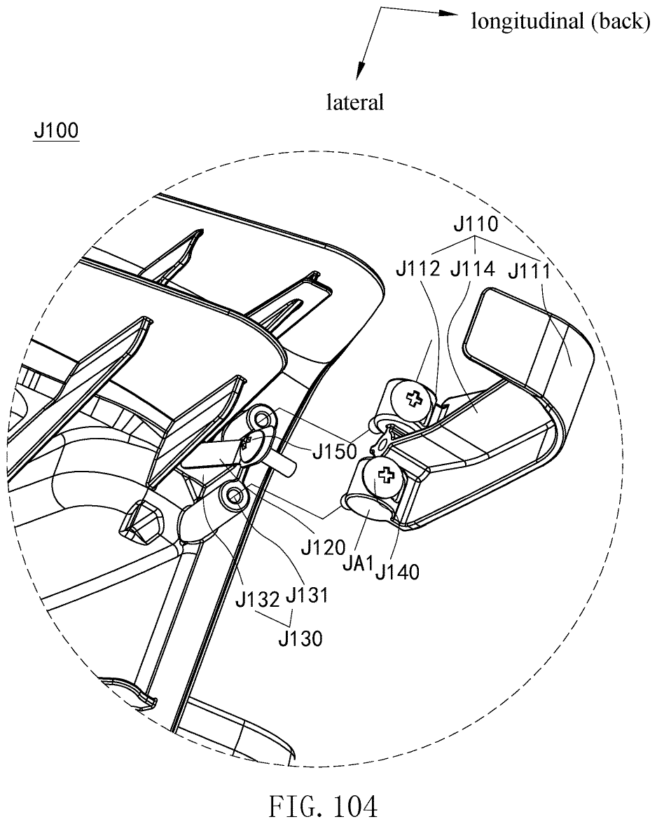

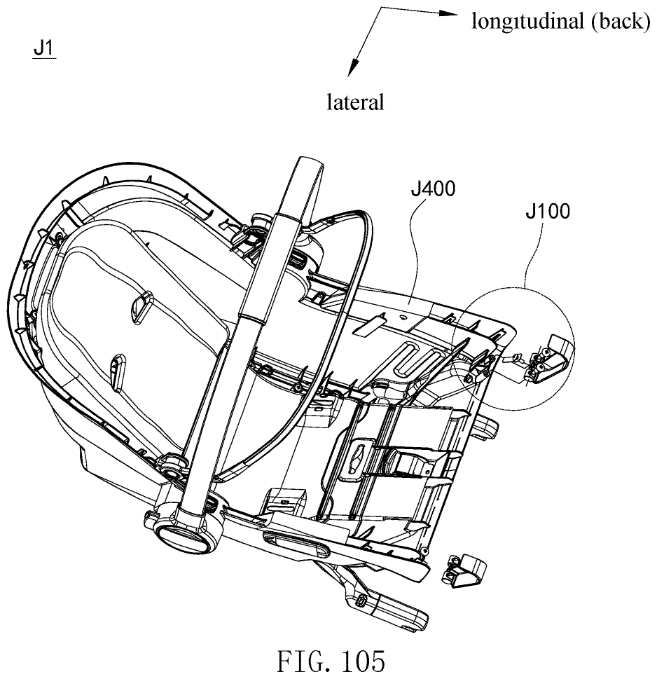

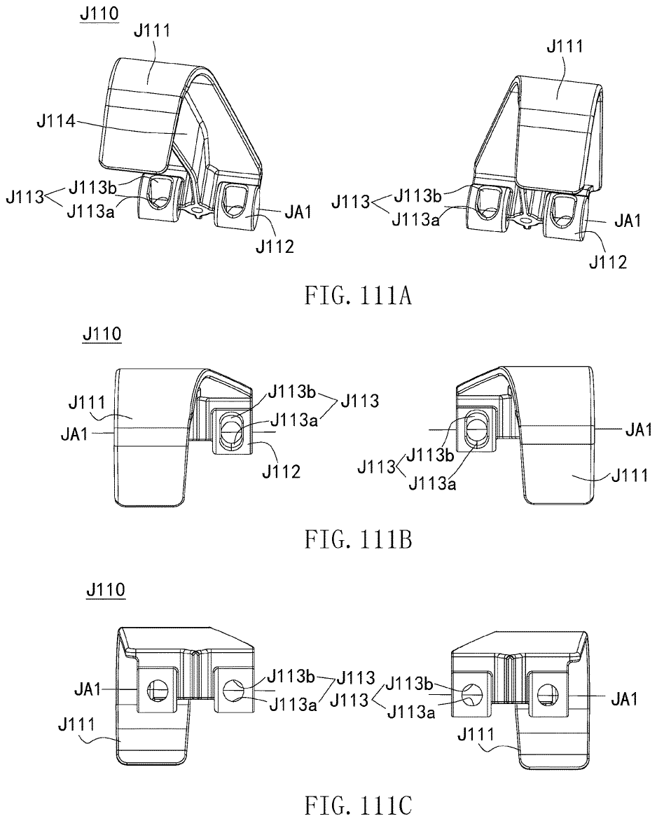

Referring to FIGS. 105-108 and 111A-111C, a specific structure of the abutting member J110 will be described. The abutting member J110 is in a shape of a plate extending substantially in a direction perpendicular to the first pivoting axis JA1, and includes an abutting part J111, a pivoting part J112, a pivoting hole J113, and a rib part J114. More specifically, the abutting member J110 extends from the base part J130 toward a direction of the second object J2. Two ends of the abutting member J110 are respectively a pivoting part J112 and an abutting part J111. The pivoting part J112 is pivotably connected to the base part J130 through the first engagement member J140, and the abutting part J111 is opposite to the pivoting part J112 and abuts against the second object J2.

In this embodiment, the abutting part J111 is arranged in a bent shape, that is, after extending to a position farthest from the carrying part J400, the abutting part J111 extends in an opposite direction toward the carrying part J400, thereby forming an arc shape. Thus, a smooth surface of the abutting part J111 is exposed to the outside, thus avoiding accidental injury to the user. It should be understood, in other embodiments, the abutting part J111 may also be arranged in any suitable shape, as long as it can abut against the second object J2.

The pivoting part J112 is provided with a pivoting hole J113 whose axial direction is substantially perpendicular to the first pivoting axis JA1, the first engagement member J140 is mounted to the base part J130 by passing through the pivoting hole J113, and the pivoting hole J113 is arranged to allow the abutting member J110 to be pivoted around the first pivoting axis JA1. The pivoting hole J113 includes a first wall J113a and a second wall J113b opposite to each other.

The first engagement member J140 is inserted in the pivoting hole J113 and fixed to the first object J1, thus allowing the abutting member J110 to be pivoted around the first pivoting axis JA1 in respect to the first engagement member J140 (i.e., in respect to the first object J1 or the base part J130 of the abutting structure J100). Thus, the pivoting function of the abutting member J110 is realized through a simple structure. It should be understood, in other embodiments, the first engagement member J140 can also be replaced by other pivoting structures, that is, the abutting member J110 can also be connected to the first object J1 through a pivoting structure such as a pivot and the like.

The first wall J113a and the second wall J113b respectively extend in a direction substantially perpendicular to the first pivoting axis JA1, and an included angle is formed between the first wall J113a and the second wall J113b around the first pivoting axis JA1. More specifically, the first wall J113a and the second wall J113b are relatively far away from each other when they are adjacent to the abutting part J111, and are relatively close to each other when they are away from the abutting part J111. The first wall J113a and the second wall J113b can respectively abut against the first engagement member J140 to define a pivoted position of the abutting member J110 in respect to the base part J130. The first wall J113a is closer to an inside of the first object J1 in respect to the second wall J113b, and the second wall J113b is closer to an outside of the first object J1 in respect to the first wall J113a. When the abutting member J110 is pivoted to the folded position and the unfolded position, the first engagement member J140 abuts respectively against the first wall J113a and the second wall J113b, so as to prevent the abutting member J110 from rotating excessively.

Referring to FIGS. 105 to 108, a specific structure of the biasing member J120 will be described. the biasing member J120 is mounted to the abutting member J110, and abuts against the base part J130 to push the abutting member J110 to the extended position. More specifically, the biasing member J120 is in a shape of a plate extending in a direction substantially perpendicular to the first pivoting axis JA1, and includes a mounting part J121 and an abutting part J123 opposite to each other. The mounting part J121 is connected to the abutting member J110 through the second engagement member J150. The mounting part J121 is provided with a mounting hole J122. The second engagement member J150 passes through the mounting hole J122 to connect the mounting part J121 to the abutting member J110. More specifically, the second engagement member J150 is mounted at the pivoting part J112 of the abutting member J110. In this embodiment, the abutting structure J100 is provided with two first engagement members J140 along the first pivoting axis JA1, and the biasing member J120 is mounted to the abutting member J110 between the two first engagement members J140.

The abutting part J123 abuts on the base part J130. More specifically, the abutting part J123 is a sheet-shaped part extending in a direction substantially perpendicular to the first pivoting axis JA1, abutting on the ramp J132 of the base part J130. The biasing member J120 can be elastically deformed to push the abutting member J110 to the extended position, for example, the mounting part J121 and the abutting part J123 can be elastically deformed respectively, and the included angle between them can also be changed.

The rib part J114 is arranged between the abutting part J111 and the pivoting part J112 along an inner surface of the abutting member J110, thereby enhancing strength of the abutting member J110.

In this embodiment, the biasing member J120 achieves an effect of pushing the abutting member J110 to the extended position by a simple structure. It should be understood, in other embodiments, the biasing member J120 may take other forms, such as a compression spring, a torsion spring or other elastic materials.

In this embodiment, the first engagement member J140 is a bolt inserted into the base part J130 along a direction substantially perpendicular to the first pivoting axis JA1. The second engagement member J150 is a bolt fixed to the abutting member J110. It should be understood, the first engagement member J140 and the second engagement member J150 may be replaced by other common engagement members.

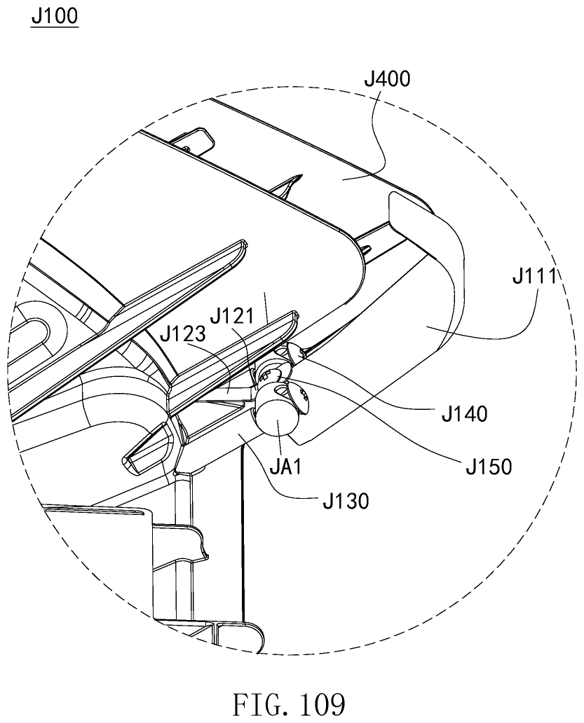

Referring to FIGS. 107 to 110, operation of the abutting structure J100 will be described hereinafter.

In FIG. 107, the abutting member J110 is adjacent to the extended position, i.e., is pivoted to a position farthest from the carrying part J400. At this time, the biasing member J120 is bent to a relatively small degree. The position of the abutting member J110 shown in FIG. 107 is suitable for the case where the gap between the first object J1 and the second object J2 is the largest.

As transition from FIG. 107 to FIG. 110, the abutting part J111 is pivoted gradually toward the carrying part J400. In FIG. 110, the abutting part J111 is closest to the folded position. At this time, the biasing member J120 is bent to a largest degree. The position of the abutting member J110 shown in FIG. 110 is suitable for the case where the gap between the first object J1 and the second object J2 is the smallest.

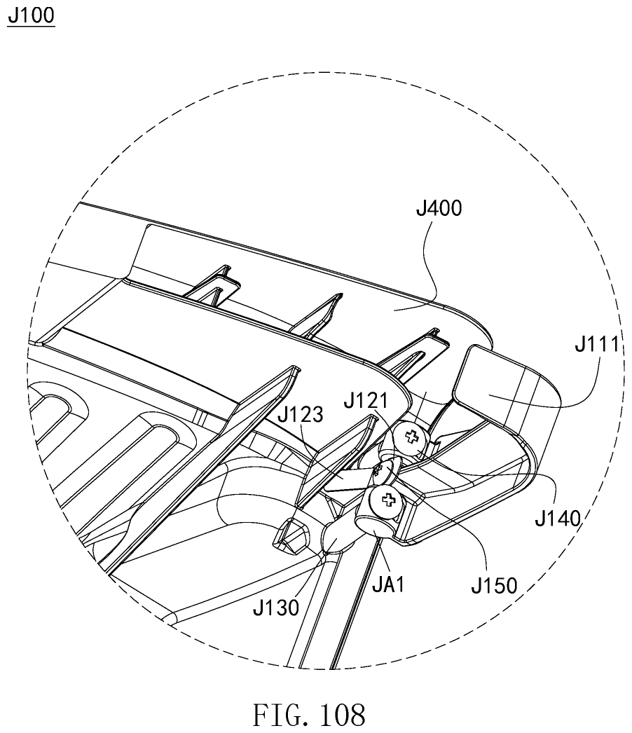

It should be understood, according to a size of the gap between the first object J1 and the second object J2, when the abutting member J110 abuts against the second object J2, the abutting member J110 may be in any position between the positions shown in FIGS. 108 and 110.

To sum up, the disclosure provides an abutting structure which can be automatically adjusted to fill the gap between the first object and the second object. The disclosure also provides a carrying device comprising the abutting structure and the engagement structure.

The abutting structure according to the disclosure can stably abut a child safety seat or a baby car safety seat against a carrier seat, so as to prevent the child safety seat from shaking or overturning. At the same time, the abutting structure according to the disclosure can depend on the gap between the child safety seat and the carrier seat, or the gap between the baby car safety seat and the carrier seat, automatically adjust the position of the abutting structure, so as to adapt to different spacing sizes, thereby adapting to different types and sizes of carrier seats, and improving the use universality of the child safety seat or the baby car safety seat.

In the above description of representative examples, directional terms (such as “up,” “down,” “left,” “right,” “front,” “back” and the like) are used for convenience of reference to the drawings. However, it should be clearly understood, the scope of the disclosure is not limited to any particular direction described herein.

Since the features of the present disclosure can be embodied in various forms without departing from the characteristics of the disclosure, it should also be understood, the above embodiments are not limited to any details described above, unless otherwise specified, but should be broadly interpreted as falling within the scope defined by the appended claims, and therefore, all modifications and variations that fall within the scope and bounds of the claims or equivalents of such ranges and bounds should be covered by the appended claims.

### LIST OF REFERENCE SIGNS

1: Carrier
   1A: Front Edge
   1F: Handle
      1F1: Handle Mounting Seat
      1F2: Handle Rotating Button
      1F3: Handle Fixing Member
   1G: Lateral Carrier Holding Part
      1G1: Bulged Part
   1H: Longitudinal Carrier Holding Part
20 Anchor joint
100: Pivoting Part
   100A: Gear Indicating Mark
   108: Carrier Engaging Members
      108A: Front Carrier Engaging Members
      108B: Rear Carrier Engaging Members
110, 110′, 110″: Driving Part
   111: Buckle Part
   112: Driving Part Pivoting Member
      112A: Pivoting Member Pushing Section
         112A1: Pushing Ramp
         112A2: Pivoting Member Pivoting Part
         112A3: Fixing Bulged Part
      112B: Pivoting Member Pressing Section
         112B1: Pressing Flange
         112B2: Fixing Recess
   113: Driving Part Pushing Member
      113A: Pushing Member Pushing End
      113B: Pushing Member Push Bar
         113B1: Push Bar Clasp
   114: Driving Part Pivoting Button
      114A: Button Pressing Part
      114B: Button Rotating Part
      114C: Button Connecting Part
   115: Driving Part Rotating Disk
      115A: Rotating Disk Pushing Inclined Body
      115B: Rotating Disk Pivoting Part
      115C: Rotating Disk Connecting Part
   116: Driving Part Moving Member
      116A: Moving Member Pushing Inclined Body
      116B: Moving Member Push Bar
         116B1: Push Bar Obstructing Hook
   117: Rotation Connecting Member
120: Outer Cover
   121: Base Part
      121A: Outer Cover Notch
   122: Extension Part
   123: Accommodation Slot
   124: Hole
   125: Outer Cover Pivoting Part
   126: Pivoting Part Obstructing Member
130: Body Member
   131: Base Part
   132: Extension Part
   133: Centre Hole
   134: Hole
   135: Locking Hook
140: Inner Cover
   141: Base Part
   142: Extension Part
   143: Centre Hole
   144: Second Engaging Slot
      144A: Second Tooth-lacking Part
      144B: Third Tooth-lacking Part
      144C: Second Engaging Slot Internal Teeth
150: Engaging Member
   151: External Teeth
      151A: Gear Adjustment External Teeth
      151B1, 151B2: Adjacent External Teeth
   152: Centre Hole
   153: Accommodation Slot
   154: Engaging Member Connecting Structure
   155: External Teeth Connection Part
160: Reset Member
170: First Engaging Slot
   171: First Tooth-lacking Part
   172: First Engaging Slot Internal Teeth
180: Connecting Shaft
   180A: Front Connecting Shaft
   180B: Rear Connecting Shaft
200: Synchronous Link Rod Assembly
210: First Link Rod
   211: Engaging Part
   212: Latch
   213: Open End
   214: Perforation
220: Second Link Rod
   221: Chute
   222: Open End
   223: Perforation
   220A: First Part
   220B: Second Part
230: Hinge Member
   231: Perforation
   232: Connecting Pin
300: Carrying body
   300A: gear marks
   310: Accommodation Slot
   320: Cavity
   330: Side Part
   340: Recess
   350: Guide Slot
400: Gear Adjustment Structure
500: Synchronous unlocking Assembly
   510: Fixed Seat
   520: Fixing Member
   530: wire Component
      530A: First wire Component
      530B: Second wire Component
      531: Outer Jacket
         531A: First Outer Jacket
         531B: Second Outer Jacket
      532: Core
         532A: First Core
         532A1, 532A2: First Exposed Part
         532A3: First Steel wire Head
         532A4: First Steel wire Head Connecting Member
         532B: Second Core
         532B1, 532B2: Second Exposed Part
         532B3: Second Steel wire Head
         532B4: Second Steel wire Head Connecting Member
   540: Hinged Structure
      541: Hinge Pin
   550: Third Link Rod
   560: Hinge Structure Placement Seat
      561: Placement Seat Fixing Member
600: First Engaging Member
   610: First Member Body
      611: First button Mounting Slot
      612: Mounting Slot Holding Part
   620: First Locking Member
      621: Locking Member Pushing Part
      622: Locking Member Mounting Post
   630: First Unlocking Button
      631: Button Holding Part
      632: Button Elastic Arm
      633: Button Pushing Part
   640: First Locking Member Elastomer
      641: First End
      642: Second End
700: Second Engaging Member
   710: Second Locking Member
   720: Second Member Pushing Part
3000: Connecting Hook
4000: Base
   4100: Base Engagement Member, Base Engaging Hook
      4100A: Front Base Engagement Member, Front Base Engaging Hook
      4100B: Rear Base Engagement Member, Rear Base Engaging Hook
      4110: Engaging Hook Fixed Seat
      4120: Engagement Member Driving Pin
      4130: Engagement Member Ramp
      4140: Engaging Member Counterweight
         4140A: Front Engaging Member Counterweight
         4140B: Rear Engaging Member Counterweight
   4200: Base Operation Member
      4210: Operation Member Body
         4210A: Operation Member Long Slot
      4220: Operation Member Extension Part
         4220A: Operation Member Drive Slot
         4220B: Operation Member Limiting Slot
      4230: Operation Member Rotating Part
         4230A: Rotating Part Linked Movement Slot
      4240: Operation Member Driving Part
         4240A: Driving Part Linked Movement Slot
         4240B: Driving Part Driving Slot
         4240C: Driving Part Long Slot
         4240D: Driving Part Reset Elastic Member
      4250: Operation Member Rotating Shaft
      4260: Operation Member Driving Shaft
      4270: Operation Member Linked Movement Part
         4270A: Linked Movement Part Contact End
         4270B: Linked Movement Part Long Slot
         4270C: Linked Movement Part Rotating Shaft
      4280: Linked Movement Part Driving Shaft
   4300: Base Bulged Part
      4310: Base Groove
   4400: Base Linked Movement Member
   4500: Base Elastic Member
   4600: Base Bulged Post
   4700: Bottom Cover
   4800: Avoidance Space
   4910: Base Limiting Post
   4920: Base Limiting Rib
5000: Carrier Application Device
   5100: Lateral Application Holding Parts
      5110: Recessed Part
      5120: Holding Part Engaging End
      5130: Holding Part Connecting End
   5200: Handbar
   5300: Longitudinal Application Holding Part
J1: First Object (Carrying Device)
J100: Abutting Structure
   J110: Abutting Member
      J111: Abutting Part
      J112: Pivoting Part
      J113: Pivoting Hole
         J113a: First Wall
         J113b: Second Wall
      J114: Rib Part
   J120: biasing Member
      J121: Mounting Part
      J122: Mounting Hole
J123: Abutting Part
   J130: base Part
      J131: Opened Hole
         J132: Ramp
   J140: First Engagement Member
   J150: Second Engagement Member
   J200: Engagement Structure
   J300: Seat body
   J400: Carrying Part
J2: Second Object (Carrier Seat)
JA1: First Pivoting Axis
I1, I2: Horizontal Plane
P1: Center of Gravity of Front Base Engagement Member
P2: Center of Gravity of Rear Base Engagement Member
R1: First Pivoting Direction
R2: Second Pivoting Direction
R3: Third Pivoting Direction
R4: Fourth Pivoting Direction
X1: Distance between Center of Gravity of Front Base Engagement Member and Front Engaging Member Pivot
X2: Distance between Center of Gravity of Rear Base Engagement Member and Rear Engaging Member Pivot

1-51. (canceled)

52. A carrier comprising:
a carrying body, and
a pivoting part pivotally connected to the carrying body, the pivoting part having a locking hook for connecting a vehicle seat,
wherein the carrier further comprises a gear adjustment structure arranged in linkage with the pivoting part, the gear adjustment structure is able to be operated to lock the pivoting part to one of a plurality of pivoted positions in respect with the carrying body.

53. The carrier according to claim 52, wherein the gear adjustment structure comprises:
a first engaging slot, formed in the carrying body,
a second engaging slot, formed in the pivoting part; and
an engaging member, movably arranged between the first engaging slot and the second engaging slot, and engaged with the first engaging slot and the second engaging slot at same time, and the engaging member being able to be actuated to be separated from being engaged with the first engaging slot or the second engaging slot.

54. The carrier according to claim 52, wherein the pivoting part comprises an ISOFIX joint.

55. The carrier according to claim 53, wherein the gear adjustment structure comprises a driving part, and the driving part is movably arranged on the pivoting part and is able to be actuated to cause the engaging member to be separated from being engaged with the first engaging slot or the second engaging slot.

56. The carrier according to claim 53, wherein each of the first engaging slot and the second engaging slot respectively comprise an internal gear, and the engaging member is formed as an external gear engaged with the internal gear.

57. The carrier according to claim 53, wherein the pivoting part comprises an outer cover, a body member, and an inner cover, the outer cover and the inner cover together enclose a space, and the body member is located in the space and comprises the locking hook.

58. The carrier according to claim 57, wherein the carrier comprises a connecting shaft, and the pivoting part is pivoted in respect with the carrying body by the connecting shaft,
wherein the engaging member has a centre hole, the inner cover has a centre hole, and
wherein the connecting shaft passes through the centre hole of the engaging member as well as the centre hole of the inner cover and is coupled to the body member.

59. The carrier according to claim 53, wherein the carrier comprises one carrying body, two pivoting parts, two gear adjustment structures, and one synchronous unlocking assembly, wherein at least one of the two gear adjustment structures comprises a driving part, each the driving part is movably arranged on a corresponding the pivoting part, wherein the synchronous unlocking assembly make the two engaging members be linked with each other, such that when the at least one driving part is actuated, the respective engaging members of the two gear adjustment structures move in opposite directions.

60. The carrier according to claim 59, wherein the two pivoting parts are pivoted synchronously in respect with the carrying body through a connecting shaft.

61. The carrier according to claim 59, wherein the synchronous unlocking assembly comprises:
a hinged structure, rotatably arranged on the carrying body;
two third link rods, one ends thereof are respectively pivotably connected to two ends of the hinged structure, and the other ends thereof are respectively pivotably connected to the two engaging members.

62. The carrier according to claim 52, wherein a front part of the carrying body is provided with a recess, and the pivoting part has a first pivoted position and a second pivoted position, wherein when the pivoting part is in a first pivoted position, the locking hook of the pivoting part is located in the recess, and when the pivoting part is in a second pivoted position, the locking hook of the pivoting part is located outside the recess.

63. The carrier according to claim 56, wherein
N+1 consecutive external teeth of the engaging member formed as the external gear constitutes N+1 gear adjustment external teeth, wherein an external teeth connection part is arranged between every two consecutive external teeth of the N+1 gear adjustment external teeth,
the internal gear of one of the first engaging slot and the second engaging slot is provided with a first tooth-lacking part, the first tooth-lacking part lacks N consecutive internal teeth,
the internal gear of the other of the first engaging slot and the second engaging slot is provided with a second tooth-lacking part and a third tooth-lacking part being separated from each other by at least one internal teeth, the second tooth-lacking part lacks N+M consecutive internal teeth, and the third tooth-lacking part lacks N consecutive internal teeth,
wherein N and M are integers greater than zero,
wherein a front part of the carrying body is provided with a recess, and
the third tooth-lacking part is arranged such that when the engaging member is engaged with the first engaging slot and the second engaging slot at same time, the N+1 gear adjustment external teeth are accommodated in the third tooth-lacking part, the pivoting part is located at the first pivoted position, the and at least a part of the pivoting part is located in the recess.

64. The carrier according to claim 63, wherein the second tooth-lacking part is arranged such that when the engaging member is engaged with the first engaging slot and the second engaging slot at same time, and the N+1 gear adjustment external teeth of the engaging member and M adjacent external teeth thereto are all accommodated in the second tooth-lacking part, the engaging member is able to be engaged with the other of the first engaging slot and the second engaging slot at M+1 different pivoted positions, such that the pivoting part is able to be at M+1 different pivoted positions.

65. The carrier according to claim 52, wherein the pivot part has a first pivoted position, a second pivoted position and a third pivoted position that can be locked, wherein a pivot angle difference between the third pivoted position and the first pivoted position is greater than that between the second pivoted position and the first pivoted position, and when the pivoting part is located at the first pivoted position, the locking hook of the pivoting part is accommodated in the carrying body; when the pivoting part is located at the second pivoted position, the locking hook of the pivoting part extends out of the carrying body to connect the vehicle seat.

66. The carrier according to claim 65, wherein the pivoting part is provided with a gear indicating mark, and gear marks corresponding to the first pivoted position, the second pivoted position and the third pivoted position are disposed at the positions on the carrying body near the pivoting part, so that when the pivoting part pivots to a pivoted position, the gear indicating mark is aligned with one of the gear marks.

67. The carrier according to claim 55, wherein the driving part comprises a driving part pivoting member and a driving part pushing member, wherein
the driving part pivoting member is pivotably arranged on the pivoting part,
the driving part pushing member is movably arranged between the driving part pivoting member and the engaging member,
wherein the driving part pivoting member is arranged to be able to drive the engaging member to be separated from being engaged with the first engaging slot or the second engaging slot via the driving part pushing member.

68. The carrier according to claim 67, wherein the driving part pushing member is provided with at least one pushing member push bar, and the pushing member push bar abuts against the engaging member,
wherein the pivoting part comprises an outer cover, a body member, and an inner cover, the outer cover and the inner cover together enclose a space, and the body member is located in the space,
wherein the pushing member push bar passes through the body member and the inner cover and abuts against the engaging member,
wherein an end of the pushing member push bar is provided with a push bar clasp, and the push bar clasp is arranged to be obstructed by a hole wall of the body member and cannot exit a hole of the body member after passing through the hole of the body member.

69. The carrier according to claim 68, wherein a circumferential wall of the base part of the outer cover is provided with an outer cover notch for the driving part pivoting member to pass therethrough,
wherein an inner end wall of the outer cover is provided with an outer cover pivoting part, and the outer cover pivoting part is cooperating with a pivoting member pivoting part of the driving part pivoting member,
wherein an end of the outer cover pivoting part is provided with a pivoting part obstructing member for preventing the driving part pivoting member from being separated from the outer cover pivoting part.

70. The carrier according to claim 55, wherein the driving part includes a driving part pivoting button, a driving part rotating disk, and a driving part moving member, wherein
the driving part pivoting button and the driving part rotating disk are arranged capable of rotating together on the pivoting part,
the driving part moving member is movably arranged between the driving part rotating disk and the engaging member,
wherein the driving part pivoting button is arranged capable of driving the engaging member to be separated from being engaged with the first engaging slot or the second engaging slot via the driving part rotating disk and the driving part moving member under action of an external force,
wherein the driving part rotating disk is provided with a rotating disk pushing inclined body, and the driving part moving member is provided with a moving member pushing inclined body, and
wherein the rotating disk pushing inclined body and the moving member pushing inclined body are arranged to be able to interact with each other, such that when the driving part rotating disk rotates, the driving part moving member moves and drives the engaging member by the rotating disk pushing inclined body pushing the moving member pushing inclined body.

71. A base for placing the carrier according to claim 52, the base being able to be connected to the vehicle seat, wherein
the carrier comprises two pivoting parts with a front connecting shaft connected between the two pivoting parts,
the base comprises:
a base engagement member, arranged on the base to be able to move between an engaged position and a non-engagement position, wherein the base engagement member is able to be engaged with the front connecting shaft when in the engaged position, and the base engagement member is able to be disengage from the front connecting shaft when in the non-engagement position; and
a base operation member, movably arranged on the base, and arranged to be able to directly or indirectly drive the base engagement member to move toward the non-engagement position;
wherein the base is provided with an avoidance space, the avoidance space is arranged such that when the carrier is placed on the base, the avoidance space is able to accommodate the two pivoting parts.
